(19) United States
(12) Patent Application Publication
(10) Pub. No.: US 2020/0308331 A1
(43) Pub. Date: Oct. 1, 2020

(54) WATER COMPATIBLE CATIONIC GRAFT COPOLYMERS AND INK COMPOSITIONS COMPRISING SAME

(71) Applicant: Penn Color, Inc., Doylestown, PA (US)

(72) Inventors: Namgoo Kang, Doylestown, PA (US); Ronald W. Schuck, Doylestown, PA (US)

(21) Appl. No.: 16/368,110

(22) Filed: Mar. 28, 2019

(51) Int. Cl. C08F 265/06; C08L 51/00; C09D 11/30; C09D 11/107

(52) U.S. Cl. CPC C08F 265/06; C08L 51/003; C08L 2201/54; C09D 11/107; C09D 11/30

(57) ABSTRACT

The present invention provides a graft copolymer comprising: (a) a hydrophobic functional polymeric backbone, wherein the backbone comprises (i) an acrylate polymer, an alkylacrylate polymer, or both an acrylate polymer and an alkylacrylate polymer, wherein the backbone has an average molecular weight (M) of from about 3,000 to about 100,000; and (b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer.

### BACKGROUND OF THE INVENTION

This invention relates to a water-based ink jet ink composition for ink jet printing. More specifically, the present invention relates to a water-compatible cationic copolymer for use as a dispersant in such compositions, as well as methods to make the water-compatible cationic copolymer.

Ink-jet technology is a contact free dot matrix printing procedure. Ink is ejected from a small aperture directly onto a specific position on a medium. Hue P. Le, Journal of Imaging Science and Technology, Volume 42, Number 1, January/February 1998. Inkjet printing is a non-impact method for producing printed images by the deposition of ink droplets in a pixel-by-pixel manner to an image-recording element in response to digital signals. There are various methods that may be utilized to control the deposition of ink droplets on the image-recording element to yield the desired printed image. In one process, known as drop-on-demand inkjet, individual droplets are projected as needed onto the image-recording element to form the desired printed image. Common methods of controlling the ejection of ink droplets in drop-on-demand printing include thermal bubble formation (thermal inkjet (TIJ)) and piezoelectric transducers. Thermal inkjet printers use resistors to create heat, which in turn vaporizes ink to form a bubble; as the bubble expands, some of the ink is pushed out of the nozzle. A vacuum is created when the bubble collapses, which pulls more ink from the cartridge into the print head. In another process known as continuous inkjet (CIJ), a continuous stream of droplets is generated and expelled in an image-wise manner onto the surface of the image-recording element, while non-imaged droplets are deflected, caught, and recycled to an ink sump. Inkjet printers have found broad applications across markets ranging from desktop document and photographic-quality imaging, to short run printing of grand format, billboard advertisements and lightfast industrial labeling.

Ink compositions containing colorants used in inkjet printers can be classified as either pigment-based, in which the colorant exists as pigment particles suspended in the ink composition, or as dye-based, in which the colorant exists as a fully solvated dye species that consists of one or more dye molecules. Pigments are highly desirable since they are far more resistant to fading than dyes. However, pigment-based inks have a number of drawbacks. Great lengths must be undertaken to reduce a pigment particle to a sufficiently small particle size and to provide sufficient colloidal stability to the particles. Pigment-based inks often require a lengthy milling operation to produce particles in the sub-micron range needed for most modern ink applications. If the pigment particles are too large light scattering can have a detrimental effect on optical density and gloss in the printed image.

Water-based pigment dispersions are well known in the art, and have been used commercially for applying films, such as paints, to various substrates. The pigment dispersion is generally stabilized by either a non-ionic or ionic technique. When using the non-ionic technique, the pigment particles are stabilized by a polymer that has a water-soluble, hydrophilic section that extends into the water and provides entropic or steric stabilization. Representative polymers useful for this purpose include polyvinyl alcohol, cellulosics, ethylene oxide modified phenols, and ethylene oxide/propylene oxide polymers. While the non-ionic technique is not sensitive to pH changes or ionic contamination, it has a major disadvantage for many applications in that the final product is water sensitive. Thus, if used in ink applications or the like, the pigment will tend to smear upon exposure to moisture.

In the ionic technique, the pigment particles are stabilized by a polymer of an ion containing monomer, such as neutralized acrylic, maleic, or vinyl sulfonic acid. The polymer provides stabilization through a charged double layer mechanism whereby ionic repulsion hinders the particles from flocculating. Since the neutralizing component tends to evaporate after application, the polymer then has reduced water solubility and the final product is not water sensitive.

U.S. Pat. No. 5,085,698 discloses a pigmented ink for ink jet printers which comprises an aqueous carrier medium, and pigment particles dispersed in an AB or BAB block copolymer having a hydrophilic segment and a segment that links to the pigment. The A block is a hydrophobic polymer of an acrylic monomer, whereas the B block(s) is a hydrophobic polymer of an acrylic monomer.

Graft co-polymeric stabilizers comprising various acrylate derivatives is disclosed in U.S. Pat. No. 6,103,781. The incorporation of organosols having crystallizable polymeric moieties into the ink compositions provided improved blocking resistance and improved erasure resistance when used in ink transfer, ionographic, electrographic and electrophotographic color printing or proofing processes.

Cationic water-based ink jet polymers with high durability and excellent adhesion to metal and plastic substrates are disclosed in U.S. patent application publication No. 2014/0051798, which became U.S. Pat. No. 9,441,123. The polymers disclosed therein were graft random copolymers synthesized by a “grafting” approach to achieve a polymer structure comprising a hydrophobic functional polymer(s) as a backbone and a variety of copolymers as a side chain attached to the backbone. Among different hydrophobic functional polymeric backbones, it is described that particularly suitable polyvinyl polymers are random copolymers consisting of mainly polyvinyl chloride, polyvinyl acetate, and/or polyvinyl alcohol such as a terpolymer of polyvinyl chloride-r-polyvinyl acetate-r-polyvinyl alcohol with weight ratio of 90/4/6 (wt/wt/wt). In addition, the inks employing the polymers disclosed therein are able to improve efficiently printing performance criteria of 1) print head open time; 2) ink stability under various conditions; and 3) resistance to typical water-based cleaners. However, it has been found that the major repeating units of PVC in the polymer backbones can be sensitive to heat and UV-light and, upon such exposure, can become yellow and generate hydrogen chloride gas as a result of decomposition thus leading to a deterioration of color purity in use.

Accordingly there is a need in the art for a polymer sufficient for use in aqueous ink compositions that does not suffer from the aforementioned drawbacks.

### SUMMARY OF THE DISCLOSURE

In response to the need in the art, the present disclosure provides a durable, external surfactant free, cationic, water based jet ink polymer which when formulated into an ink jet ink provides printing that has excellent adhesion to metal or plastic substrates. Such jet ink polymer is suitable performance replacement of solvent soluble polymers currently in commercial use. The use of the inks of the present invention enhances performance criteria such as print-head open time, ink stability under varying conditions, and resistance to typical water based cleaners.

The disclosure provides a graft copolymer comprising: (a) a hydrophobic functional polymeric backbone, wherein the backbone comprises (i) an acrylate polymer, an alkylacrylate polymer, or both an acrylate polymer and an alkylacrylate polymer, wherein the backbone has an average molecular weight (M_{N}) of from about 3,000 to about 100,000; and (b) a plurality of hydrophilic polymeric side chains attached to the hydrophobic functional polymeric backbone, wherein the hydrophilic polymeric side chains comprise a polymerization product of at least one polymerizable unsaturated monomer and apolymerizable amine-containing unsaturated monomer.

The disclosure also provides a process for making a graft cationic copolymer, the process comprising: a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups; b) separately reacting in the presence of a solvent (i) at least one unsaturated monomer having a structure represented by Formula I:

CH₂═C(R²)—X—Y—R¹ (Formula 1)

wherein

—R² is H, halogen, or C₁ to C₃ alkyl group;

—X— is a bond, —CO—O—, or —O—CO—;

—Y— is a bond, or a C₁ to C₂₂ bridging alkyl group optionally substituted with one or more C₁ to C₆ alkyl groups; and

—R¹ is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe;
(8) —CZ═CH₂, wherein Z is H or halogen; and

### (9) —CO—OH,

with (ii) a polymerizable amine-containing unsaturated monomer having a structure represented by Formula 2:

CH₂═C(Rⁿ²)—Xⁿ—Yⁿ—Rⁿ¹ (Formula 2)

wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and

### —Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
polyethylene glycol, polypropylene glycol, or a copolymer thereof, terminated with —OH or —OMe; wherein —Xⁿ— or —Rⁿ¹ or both comprise nitrogen, and wherein the at least one unsaturated monomer having a structure represented by Formula I and the polymerizable amine-containing unsaturated monomer having a structure represented by Formula 2 are reacted in the presence of a hybridizing compound to form a second polymer composition, wherein the hybridizing compound comprises a functional group selected from the group consisting of an isocyanate group, an amino group, an epoxy group, a carboxylic acid group, and an acyl halide group; c) reacting the first polymer composition and the second polymer composition in the presence of a solvent such that the functional group of the second polymer composition reacts with the hydroxyl groups of the first polymer composition to form randomly grafted side chains on the first polymer composition to form a graft coploymer; and d) adding an acid to the graft coploymer in the presence of water to form a cationic graft coploymer.

The disclosure also provides a graft cationic copolymer prepared by a process comprising: a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups; b) separately reacting in the presence of a solvent (i) at least one unsaturated monomer having a structure represented by Formula I:

CH₂═C(R²)—X—Y—R¹ (Formula 1)

wherein

—R² is H, halogen, or C₁ to C₃ alkyl group;

—X— is a bond, —CO—O—, or —O—CO—;

—Y— is a bond, or a C₁ to C₂₂ bridging alkyl group optionally substituted with one or more C₁ to C₆ alkyl groups; and

—R is

(10) H, halide, —OH, or —CN;
(11) a C₃ to C₈ cycloalkyl group that is optionally substituted with one or more linear or branched C₁ to C₆ alkyl group;
(12) a C₃ to C₈ heterocycloalkyl group comprising one or more heteroatoms, wherein the heteroatom is a chalcogen;
(13) a C₇ to C₁₅ bicycloalkyl group that is optionally substituted with one or more halogens, or linear or branched C₁ to C₆ alkanes;
(14) a C₆ to C₁₄ aryl group that is optionally substituted with one or more groups selected from the group consisting of a halogen, a linear or branched C₁ to C₆ alkane, and C₁ to C₃ alkyloxy;
(15) SiR³₃, wherein R³ is C₁ to C₃ alkyl group;
(16) polyethylene glycol, polypropylene glycol, or a copolymer thereof, terminated with —OH or —OMe;
(17) —CZ═CH₂, wherein Z is H or halogen; and

### (18) —CO—OH,

with (ii) a polymerizable amine-containing unsaturated monomer having a structure represented by Formula 2:

CH₂═C(Rⁿ²)—Xⁿ—Yⁿ—Rⁿ¹ (Formula 2)

wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and

### —Rⁿ¹ is

### (7) H;

(8) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(9) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(10) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(11) a C₆ to C₁₄ aryl group further substituted with an amine-containing group;
(12) a C₁ to C₈ alkyl group substituted with a plurality of aryl groups; or polyethylene glycol, polypropylene glycol, or a copolymer thereof, terminated with —OH or —OMe; and wherein —Xⁿ— or —Rⁿ¹ or both comprise nitrogen, wherein the at least one unsaturated monomer having a structure represented by Formula I and the polymerizable amine-containing unsaturated monomer having a structure represented by Formula 2 are reacted in the presence of a hybridizing compound to form a second polymer composition, wherein the hybridizing compound comprises a functional group selected from the group consisting of an isocyanate group, an amino group, an epoxy group, a carboxylic acid group, and an acyl halide group; c) reacting the first polymer composition and the second polymer composition in the presence of a solvent such that the functional group of the second polymer composition reacts with the hydroxyl groups of the first polymer composition to form randomly graft side chains on the first polymer composition to form a graft coploymer; and d) adding an acid to the graft coploymer in the presence of water to form a cationic graft coploymer.

The (meth)acrylic polymers-based aqueous cationic resins disclosed herein are designed to comprise a flexible back bone of polybutylacrylate-r-poly(2-hydroxyethyl acrylate) (PBA-r-PHEA) and functional side chains of methacrylic polymers with amine, ureido, isobornyl, and methyl groups. (Meth)acrylic grafting polymers should be an alternative to PVC based polymers to improve thermal stability of aqueous cationic resins.

### BRIEF DESCRIPTION OF THE DRAWINGS

FIG. 1 is a schematic showing the synthesis of random copolymers of poly butyl acrylate-co-poly(2-hydroxy ethyl acrylate) in methyl ethyl ketone under N₂ at 80° C.;

FIG. 2 is an ATR-FTIR spectra of (A) butyl acrylate (BA) monomer, (B) 2-hydroxy ethyl acrylate (HEA) monomer, and (C) resulting random copolymer of PBA-co-PHEA (NK73-17) synthesized via free radical polymerization;

FIG. 3 is a schematic showing (A) Synthesis of TMI-end capping random copolymers containing four different repeating units of DMAEMA, IBOMA, MMA, and MEEU via random copolymerization at 80° C. under N₂ purging; and (B) Synthesis of grafting random copolymers with main chains of PBA-co-PHEA and side chains of PDMAEMA-co-PIBOMA-co-PMMA-co-PMEEU by a reaction of isocyanate units in TMI with hydroxyl units in HEA at 78° C. under N₂ purging;

FIG. 4 is an ATR-FTIR spectra of each aliquot of reaction mixtures from Aliquot-2 to Aliquot-8 of Table 2;

FIG. 5 is an ATR-FTIR spectra of (A) butyl acrylate (BA) monomer, (B) 2-hydroxy ethyl acrylate (HEA) monomer, (C) polybutyl acrylate (PBA) homopolymers, (D) poly(2-hydroxy ethyl acrylate) (PHEA) homopolymers, and (E) resulting random copolymers of PBA-r-PHEA synthesized via free radical polymerization;

FIG. 6 is a GPC graph of PBA-co-PHEA random copolymers; M=4200 g/mol, M_{W}=13700 g/mol, and PDI=3.29;

FIG. 7 is an ATR-FTIR spectra of each aliquot of reaction mixtures from Aliquot-2 to Aliquot-7;

FIG. 8 is a graph illustrating particle size distribution of aqueous cationic acrylic resins in DI water prepared from NK05-18;

FIG. 9 is a graph showing the TGA decomposition temperature (T_{d}: 178° C.) of films of cationic resins produced by the NK05-18 batch;

FIG. 10 is a graph showing the DSC glass transition temperature (T_{g}: 0.7° C.) of films of cationic resins produced by the NK05-18 batch;

FIG. 11 is a graph illustrating the particle size distribution of aqueous cationic acrylic resins in DI water prepared from NK04-18 (sample concentration: 2-3 drops dispersion in 15 g of DI water);

FIG. 12 is an ATR-FTIR spectra of each aliquot of reaction mixtures from Aliquot-1 to Aliquot-9;

FIG. 13 is GC/Mass spectra of residual monomers from Aliquot-9;

FIG. 14 is a TGA analysis of the decomposition temperature (T_{d}: 202° C.) of a film of cationic resin produced by batch NK58-17;

FIG. 15 is DSC analysis of the glass transition temperature (T_{g}: 48° C.) of a film of cationic resin produced by batch NK58-17;

FIG. 16 is a graph illustrating the particle size distribution of aqueous cationic acrylic resins in DI water prepared from NK58-17 (sample concentration: 2-3 drops dispersion in 15 g of DI water);

FIG. 17 shows a series of varied synthetic approaches to prepare the polymers of the present disclosure: (A) depicts a typical approach for water-soluble cationic resins based on polyvinylchlorides with total reaction time of 13-16 hours, (B) the first modified approach of batch NK63-17 with a total reaction time of 12 hours, 10 minutes, (C) the second modified approach of batch NK64-17 with a total reaction time of 11 hours, 40 minutes, (D) the third modified approach of batch NK65-17 with total reaction time of 9 hours 20 minutes, and (E) the forth modified approach of batch NK69-17 with a total reaction time of 8 hours, 40 minutes;

FIG. 18 is an ATR-FTIR spectra of each aliquot of reaction mixtures from Aliquot-1 to Aliquot-8 (showing isocyanate group (NCO) of TMI: 2260 cm-1 wavelength and vinyl group (C═C) of (meth)acrylic monomers: 1619-1637 cm⁻¹);

FIG. 19 is a graph illustrating the particle size distribution of aqueous cationic acrylic resins in DI water prepared from batch NK65-17 (sample concentration: 2-3 drops dispersion in 15 g of DI water);

FIG. 20 is a graph illustrating the particle size distribution of aqueous cationic acrylic resins in DI water prepared from (A) batch NK82-18, (B) NK84-18, and (C) NK02-19 (sample concentration: 2-3 drops dispersion in 15 g of DI water);

FIG. 21 is DSC analysis of the glass transition temperature (T_{g}: 30° C.) of a film of cationic resin produced by batch NK84-18;

FIG. 22 is DSC analysis of the glass transition temperature (T_{g}: 31° C.) of a film of cationic resin produced by batch NK02-19;

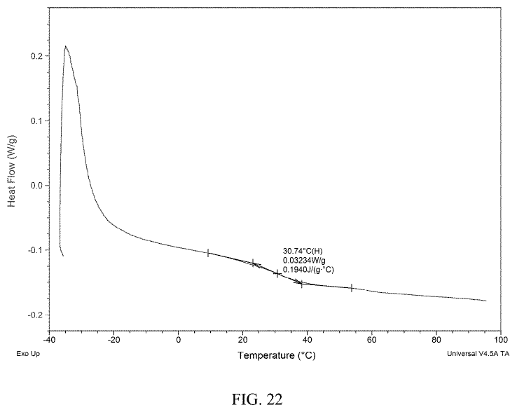

FIG. 23 is a graph illustrating particle size distribution of aqueous cationic acrylic resins in DI water prepared from batch NK59-18 (sample concentration: 2-3 drops dispersion in 15 g of DI water);

FIG. 24 is a graph illustrating particle size distribution of aqueous cationic acrylic resins in DI water prepared from batch NK03-19 (sample concentration: 2-3 drops dispersion in 15 g of DI water); and

FIG. 25 is DSC analysis of the glass transition temperature (T_{g}: 49° C.) of a film of cationic resin produced by batch NK03-19.

### DETAILED DESCRIPTION OF THE INVENTION

The present disclosure provides a durable, external surfactant free, cationic, water based jet ink polymer which when formulated into an ink jet ink provides printing that has an excellent adhesion to metal or plastic substrates. Such jet ink polymer is suitable performance replacement of solvent soluble polymers currently in commercial use. The use of the inks of the present invention enhances performance criteria such as print-head open time, ink stability under varying conditions, and resistance to typical water based cleaners.

Known conventional water based latex polymers contain small suspended insoluble organic polymers within a micellular structure the size of which can vary with changes in temperature or the addition of water miscible solvents or organic amines. The solubility characteristics of the new polymer eliminates such problems.

The practice of the present invention employs, unless otherwise indicated, conventional techniques of polymer chemistry, organic chemistry, and related fields, which are within the skill of art. See, for example, Paul C. Hiemenz, POLYMER CHEMISTRY: THE BASIC CONCEPTS, Marcel Dekker (1984); Sandler, Karo, Bonesteel and Pearce, POLYMER SYNTHESIS AND CHARACTERIZATION, Academic Press (1998).

As used in the specification and claims, the singular form “a”, “an” and “the” include plural references unless the context clearly dictates otherwise. For example, the term “a monomer” includes a plurality of monomers, including mixtures of monomers.

As used herein, the term “comprising” is intended to mean that the defined compositions and methods include the recited elements, but not exclude others. “Consisting essentially of” when used to define compositions and methods, shall mean to exclude other elements of any essential significance to the combination. Thus, a composition consisting essentially of the elements as defined herein would not exclude trace contaminants from the isolation and purification methods. “Consisting of” shall mean to exclude more than trace elements of other ingredients. Embodiments defined by each of these transition terms are within the scope of this invention.

All numerical designations, such as, weight, pH, temperature, time, concentration, and molecular weight, including ranges, are approximations which are varied by 10%. It is to be understood, although not always explicitly stated, that all numerical designations are preceded by the term “about.” It also is to be understood, although not always explicitly stated, that the reagents described herein are merely exemplary and that equivalents of such are known in the art.

The term “functional” when referring to a polymeric portion of a molecule means that the polymer portion of the molecule has covalent bonds to other portions of the molecule.

The phrase “functionalized polymer” refers to a polymer that contains functional groups. Such functional groups are typically reactive towards other reactants, which may be useful in synthesis of further polymers. Examples of such functional groups includes hydroxide.

The phrase “hydrophobic polymer” refers to apolar polymers which contain a relatively small proportion of oxygen or nitrogen atoms.

The term “low surface energy surface” refers to a hydrophobic surface exhibiting an average surface energy of about 40 dynes/cm or less.

The phrase “molecular weight” when referring to a polymer means average molecular weight. This phrase also refers not only to the weight of a molecule, but also to the weight of a portion of a molecule, thus, for example, the phrase “molecular weight of the polymeric backbone” refers to the average molecular weight of the polymeric backbone portion of the molecule, and not to the average molecular weight of the molecule that contains the polymeric backbone portion of the molecule.

The term “polymer” refers to a large molecule composed of repeating structural units. Such repeating units are building blocks provided by polymerized monomers.

Unless specifically excluded, the term “polymer” also refers to copolymers.

The term “substrate” refers to any material onto which a liquid ink is applied.

The term “mixture” refers to any composition that comprises more than one substance. The term refers to both a homogeneous and heterogeneous mixture. The term refers to any composition that comprises more than one substance, regardless of the morphology of the substances or the phase thereof. Thus, the term includes a solution, a suspension, a dispersion, a sol, a foam, a gel, an amalgam, an alloy, and like.

The name of an element when used to refer to a substituent or to a portion of a molecule or a polymer means that one of more atoms of that element are incorporated within the structure of that molecule, regardless whether the atom is found in the molecule as defined by the class the molecule or not. For example, the nitrogen in the phrase “a nitrogen-containing acrylamide” refers to both the nitrogen which is a part of the amide group, and to any nitrogen-containing groups that may be a substituent on the acrylamide.

The name of an element, or a group of elements, when used to refer to a substituent or to a portion of a molecule or a polymer, is used regardless of the oxidation state of that atom. For example, the term “a halogen” includes within its definition a halide.

The term “number average molecular weight” or “M” in reference to a particular component (e.g., a high molecular weight polymer binder) of a solid-state composition refers to the statistical average molecular weight of all molecules of the component expressed in units of g/mol. The number average molecular weight may be determined by techniques known in the art such as, for example, gel permeation chromatography (wherein Mₙ can be calculated based on known standards based on an online detection system such as a refractive index, ultraviolet, light scattering, viscosity, or other detector), viscometry, mass spectrometry, or colligative methods (e.g., vapor pressure osmometry, end-group determination, or proton NMR). The number average molecular weight is defined by the equation below,

Mₙ=ΣNᵢMᵢ/ΣNᵢ

wherein Mᵢ is the molecular weight of a molecule and Nᵢ is the number of molecules of that molecular weight. Unless specified otherwise, all molecular weights referred to herein are number average molecular weights.

The Polymer

In one aspect, the present disclosure provides a graft copolymer comprising: (a) a hydrophobic functional polymeric backbone, wherein the backbone comprises (i) an acrylate polymer, an alkylacrylate polymer, or both an acrylate polymer and an alkylacrylate polymer, wherein the backbone has an average molecular weight (Mₙ) of from about 3,000 to about 100,000; and (b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer.

The graft copolymer may have many uses within the coating and film applications, but it is especially useful as a binder component in ink jet inks.

A graft copolymer is branched co-polymer wherein the side chains are structurally distinct from the backbone. In preferred embodiments, the side chains are randomly grafted onto the backbone according to the methods disclosed herein. In the polymers disclosed herein, the backbone of the graft copolymer is the hydrophobic functional polymeric backbone, and the side chains are copolymeric side chains attached to the backbone.

The Backbone Chemistry

Preferably, the hydrophobic backbone of the polymers disclosed herein are prepared by polymerizing unsaturated monomers comprising an acrylate monomer, an alkylacrylatealkyl acrylate monomer (e.g., methacrylate monomer), or a combination of acrylate monomers and alkylacrylates.

The polymerizable unsaturated monomer which is the basis of one or more repeating units comprising the hydrophobic backbone comprises at least one acrylate monomer, at least one alkylacrylatealkyl acrylate monomer, or at least one of each. The acrylate monomer is represented by Formula (A)

CH₂═C(R²)—X—Y—R¹ (A)

wherein

### —R² is H;

### —X— is —CO—O—;

—Y— is a bond, or a C₁ to C₂₂ bridging alkyl group optionally substituted with one or more C₁ to C₆ alkyl groups; and

### —R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or
(6) polyethylene glycol, polypropylene glycol, or a copolymer thereof, terminated with —OH or —OMe.

In another embodiment, the acrylate monomer is represented by the structure of Formula (B):

CH₂═CH—CO—O—Y—R¹ (B)

wherein
—Y— is a bond, or a C₁ to C₂₂ bridging alkyl group optionally substituted with one or more C₁ to C₆ alkyl groups; and

### —R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or
(6) polyethylene glycol, polypropylene glycol, or a copolymer thereof, terminated with —OH or —OMe.

Examples of suitable acrylate monomers include 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof. In one embodiment of the invention the acrylate monomers that are the basis of the hydrophobic backbone is 2-hydroxylethyl acrylate, ethyl acrylate, or a mixture thereof.

In another embodiment, the polymerizable monomer is an alkylacrylatealkyl acrylate monomer represented by the structure of Formula (C):

CH₂═C(R²)—X—Y—R¹ (C)

wherein
—R² is C₁ to C₃ alkyl;

### —X— is —CO—O—;

—Y— is a bond, or a C₁ to C₂₂ bridging alkyl group optionally substituted with one or more C₁ to C₆ alkyl groups; and

### —R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ═CH₂, wherein Z is H or halogen.

One example of an alkylacrylate monomer is a methacrylate. Methacrylate has the structure represented by Formula (D):

CH₂═C(R²)—X—Y—R¹ (D)

wherein
—R² is C₁ alkyl;

### —X— is —CO—O—;

—Y— is a bond, or a C₁ to C₂₂ bridging alkyl group optionally substituted with one or more C₁ to C₆ alkyl groups; and

### —R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ═CH₂, wherein Z is H or halogen.

Examples of suitable methacrylates include methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof. In one embodiment, the methacrylate monomers that are the basis of the hydrophobic backbone comprises methyl 2-methacrylate, behenyl methacrylate, or a mixture thereof.

In one embodiment, the hydrophobic backbone comprises a co-polymer of polybutylacrylate and poly(2-hydroxyethyl acrylate) as is detailed in the examples below.

The molecular weight of the polymeric backbone portion of the copolymer is chosen to be such that the molecule that is the synthetic precursor to the copolymer is soluble in organic solvents used in the reaction, and the resulting copolymer is soluble in water in the jet ink. The preferred number average molecular weight (Mₙ) of the backbone is from about 3,000 to about 100,000 g/mol, more preferably, from about 15,000 to about 50,000 g/mol, and in other embodiments from about 15,000 to about 25,000 g/mol.

To react with grafts that will become side chains, the polymer backbone preferably should contain acrylate or alkyl acrylate-containing functional groups of hydroxyl, primary amine, and secondary amine. Therefore, the preferred backbone could be determined depending on % ratio of the acrylate or alkyl acrylate containing hydroxyl and (primary and secondary amine groups in polymer backbone. Accordingly, a preferred backbone may contain the molar ratio (%) of the acrylate or alkyl acrylate containing hydroxyl and (primary and secondary amine groups between about 5 and about 30 mol % and the non-functional acrylate or alkyl acrylate between about 95 and about 70%.

The Functional Side Chains

In addition to a hydrophobic polymeric backbone, the graft copolymer of the present invention also comprises a plurality of copolymeric side chains attached to the backbone, wherein one or more side chains comprises a reaction product of at least (i) a polymerizable unsaturated monomer and (ii) a polymerizable tertiary amine-containing unsaturated monomer. Both polymerizable unsaturated and polymerizable tertiary amine-containing unsaturated monomers are needed in construction of a plurality of side chains, but additional material may be incorporated within any of the side chains.

The polymerizable unsaturated monomer which is the basis for one type of a building unit of the side chains is selected from a group consisting of an acrylate monomer, an alkyl acrylate monomer, an aromatic vinyl monomer, an aliphatic vinyl monomer, a vinyl ester monomer, a vinyl cyanogen-containing monomer, a halogenoid monomer, an olefin monomer, and a diene monomer. Although only one kind of a polymerizable unsaturated monomer may be used in preparation of any of the side chains, typically a several kinds of polymerizable unsaturated monomers are used.

In its broadest form, the polymerizable unsaturated monomer which is the basis of one type of repeating units within the side chain of the graft copolymer has the structure represented by Formula 1:

CH₂═C(R²)—X—Y—R¹ (Formula 1)

wherein
—R² is H, halogen, or C₁ to C₃ alkyl group;
—X— is a bond, —CO—O—, or —O—CO—;
—Y— is a bond, or a C₁ to C₂₂ bridging alkyl group optionally substituted with one or more C₁ to C₆ alkyl groups; and

### —R is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe;
(8) —CZ═CH₂, wherein Z is H or halogen; and

### (9) —CO—OH.

Halogen is an atom of the 17th Group of the period table, which includes fluorine, chlorine, bromine and iodine.

C₁ to C₃ alkyl group is a methyl group, ethyl group, n-propyl group, or a i-propyl group.

C₁ to C₂₂ bridging alkyl group is a saturated bridging group of formula —(CH₂)ₙ— wherein n is an integer 1 to 22. The term “alkyl” as used to refer to a bridging group, a divalent group, is referred under current IUPAC rules as “alkdiyl” group. This bridging group may be further substituted anywhere along the chain by a small terminal alkyl group such as methyl, ethyl, propyl, butyl, pentyl, hexyl, or an isomer any of the foregoing.

In cases when —X— is a bond, the formula CH₂═C(R²)—X—Y—R¹, is reduced to formula CH₂═C(R²)—Y—R¹. Likewise, when —Y— is a bond, the formula CH₂═C(R²)—X—Y—R¹, is reduced to formula CH₂═C(R²)—Y—R. Furthermore, when both —X— and —Y— are bonds, the formula CH₂═C(R²)—X—Y—R¹, is reduced to CH₂═C(R²)—R¹.

The symbol —CN refers to a cyanyl group. The cyanyl group should be chemically inert vis-à-vis conditions in which the copolymer may be exposed in order to avoid hydrolysis of the cyanyl group.

In another embodiment, the polymerizable unsaturated monomer which is the basis for the side chains is an acrylate monomer, an alkyl acrylate monomer, or both. The acrylate monomer also has a structure represented by Formula 1:

CH₂═C(R²)—X—Y—R¹ (Formula 1)

wherein

### —R² is H;

### —X— is —CO—O—;

—Y— is a bond, or a C₁ to C₂₂ bridging alkyl group optionally substituted with one or more C₁ to C₆ alkyl groups; and

### —R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or
(6) polyethylene glycol, polypropylene glycol, or a copolymer thereof, terminated with —OH or —OMe.

The acrylate monomer also has a structure represented by Formula I, CH₂═CH—CO—O—Y—R¹, wherein

—Y— is a bond, or a C₁ to C₂₂ bridging alkyl group optionally substituted with one or more C₁ to C₆ alkyl groups; and

### —R¹ is

### (1) H or —OH;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy; or
(6) polyethylene glycol, polypropylene glycol, or a copolymer thereof, terminated with —OH or —OMe.

Examples of suitable acrylates of Formula 1 include 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof. Under one embodiment of the invention the acrylate monomers that are the basis of the copolymeric side chain is 2-hydroxylethyl acrylate, ethyl acrylate, or a mixture thereof.

The alkyl acrylates monomer is of formula CH₂═C(R²)—X—Y—R¹, wherein

—R² is C₁ to C₃ alkyl;

### —X— is —CO—O—;

—Y— is a bond, or a C₁ to C₂₂ bridging alkyl group optionally substituted with one or more C₁ to C₆ alkyl groups; and

### —R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ═CH₂, wherein Z is H or halogen.

An example of an alkylacrylate monomer according to Formula 1, CH₂═C(R²)—X—Y—R¹, is a methacrylate, wherein

—R² is C₁ alkyl;

### —X— is —CO—O—;

—Y— is a bond, or a C₁ to C₂₂ bridging alkyl group optionally substituted with one or more C₁ to C₆ alkyl groups; and

### —R¹ is

### (1) H;

(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with OH or OMe; or
(8) —CZ═CH₂, wherein Z is H or halogen.

C₁ alkyl is a methyl group.

Examples of suitable methacrylates of Formula I include methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof. Under one embodiment of the invention the methacrylate monomers that are the basis of the copolymeric side chain is methyl 2-methacrylate, behenyl methacrylate, or a mixture thereof.

The aromatic vinyl monomer(s) is represented by the formula CH₂═C(R²)—R¹, wherein

—R² is H or C₁ to C₃ alkyl group;
—R¹ is a C₆ to C₁₄ aryl group that is optionally substituted with one or more groups selected from the group consisting of a halogen, a linear or branched C₁ to C₆ alkane, and C₁ to C₃ alkyloxy.

Aryl groups are any hydrocarbon cyclic groups that follow the Hickel Rule. Such aryl groups may be single aromatic ring group, bicyclic aromatic ring group, or tricyclic aromatic ring group. An example of a single aromatic ring group is the phenyl group. An example of a bicyclic aromatic ring group is naphthalene. An example of a tricyclic aromatic ring group is anthracene. Any of the aromatic groups may be optionally substituted with one or more of any of the following: fluorine, chlorine, bromine, iodine, methyl, ethyl, propyl, butyl, pentyl, hexyl, methoxy, ethoxy, propyloxy, including any isomers thereof.

Examples of suitable aromatic vinyl monomer include styrene, alpha-methylstyrene, vinyl toluene, 4-t-butylstyrene, chlorostyrene, vinylanisole, vinyl naphthalene, and mixtures thereof.

The vinyl ester monomer(s) is represented by the formula

CH₂═CH—O—CO—Y—R¹,

wherein
—Y— is a bond, or a C₁ to C₂₂ bridging alkyl group optionally substituted with one or more C₁ to C₆ alkyl groups; and

### —R¹ is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe; or
(8) —CZ═CH₂, wherein Z is H or halogen.

An example of a suitable vinyl ester is vinyl acetate.

The vinyl cyanogen-containing monomer is an unsaturated monomer of Formula 1 that comprises a —CN group. Examples of cyanogen-containing monomer include acrylonitrile and methacrylonitrile.

The halogenoid monomer is an unsaturated monomer of Formula 1 that comprises one or more halogens. An example of a halogen includes fluorine, chlorine, bromine and iodine. An example of a halogenoid comprising one halogen is vinyl chloride. An example of a halogenoid comprising two halogens is vinylidene chloride.

The olefin monomer(s) has a structure represented by the formula

CH₂═C(R²)—Y—R¹,

wherein
—R² is H, or C to C₃ alkyl group;
—Y— is a bond, or a C₁ to C₂₂ bridging alkyl group optionally substituted with one or more C₁ to C₆ alkyl groups; and

### —R¹ is H.

Examples of an olefin monomer include ethylene, propylene, and mixtures thereof.

The diene monomer(s) is represented by the formula

CH₂═CH—Y—R¹,

wherein
—Y— is a bond, or a C₁ to C₂₂ bridging alkyl group optionally substituted with one or more C₁ to C₆ alkyl groups; and
—R is —CZ═CH₂, wherein Z is H or halogen.

An example of a diene monomer when Z═H is butadiene. An example of a diene monomer when Z is a halogen is chloroprene.

The polymerizable amine-containing unsaturated monomer which is the basis for one type of a building unit of the side chains is selected from the group consisting of an amine-containing acrylate, an amine-containing acrylate, an amine-containing methacrylate, an acrylamide, a methacrylamide, an amine-containing vinyl monomer, and mixtures thereof. Although only one kind of a polymerizable unsaturated monomer may be used in preparation of any of the side chains, typically a several kinds of polymerizable unsaturated monomers are used.

The polymerizable amine-containing unsaturated monomer which is the basis of one type of repeating units within the side chain of graft copolymer has a structure represented by Formula 2:

CH₂═C(Rⁿ²)—Xⁿ—Yⁿ—Rⁿ¹ (Formula 2)

wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and

### —Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and
wherein —Xⁿ— or —Rⁿ¹ or both comprise nitrogen.

Pnicogen is an atom of the 15th Group of the periodic table, which includes nitrogen, phosphorus, arsenic and antimony.

Chalcogen is an atom of the 16th Group of the periodic table, which includes oxygen, sulfur, selenium, and tellurium.

Halogen is an atom of the 17th Group of the period table, which includes fluorine, chlorine, bromine and iodine.

C₁ to C₃ alkyl group is a methyl group, ethyl group, n-propyl group, or an i-propyl group.

C₁ to C₂₂ bridging alkyl group is a saturated bridging group of formula —(CH₂)ₙ— wherein n is an integer 1 to 22. The term “alkyl” as used to refer to a bridging group, a divalent group, is referred under current IUPAC rules as “alkdiyl” group. This bridging group may be further substituted anywhere along the chain by a small terminal alkyl group such as methyl, ethyl, propyl, butyl, pentyl, hexyl, or an isomer any of the foregoing.

In cases when —Xⁿ— is a bond, the formula CH₂═C(Rⁿ²)—Xⁿ—Yⁿ—Rⁿ¹, is reduced to formula CH₂═C(Rⁿ²)—Yⁿ—Rⁿ¹. Likewise, when —Yⁿ— is a bond, the formula CH₂═C(Rⁿ²)—Xⁿ—Yⁿ—Rⁿ¹, is reduced to formula CH₂═C(Rⁿ²)—Yⁿ—Rⁿ¹. Furthermore, when both —Xⁿ— and —Yⁿ— are bonds, the formula CH₂═C(Rⁿ²)—Xⁿ—Yⁿ—Rⁿ¹, is reduced to CH₂═C(Rⁿ²)—Rⁿ¹.

The definition of amine containing unsaturated monomer also includes adducts of such monomers, such as salts, quaternary amine salts, and hydrates.

Under one embodiment of the present invention, the polymerizable amine-containing unsaturated monomer which is the basis for the side chains is an amine-containing acrylate monomer. The amine-containing acrylate monomer(s) has a structure represented by the formula

CH₂═CH—CO—O—Yⁿ—Rⁿ¹

wherein
—Yⁿ— is a bond, or a C₁ to C₁₈ bridging alkyl group optionally substituted with one or more C₁ to C₆ alkyl groups; and

### —Rⁿ¹ is

(1) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(2) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(3) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
(4) a C₆ to C₁₄ aryl group further substituted with an amine-containing group.

When the polymerizable amine-containing unsaturated monomer which is the basis for the side chains is an amine-containing acrylate monomer of formula CH₂═CH—CO—O—Yⁿ—Rⁿ¹, then moiety —Rⁿ¹ comprises nitrogen.

Examples of suitable polymerizable amine-containing acrylate include t-butylaminoethyl acrylate, dimethylaminomethyl acrylate, diethylaminoethyl acrylate, oxazolidinyl ethyl acrylate, aminoethyl acrylate, 4-(beta-acryloxyethyl)-pyridine, 2-(4-pyridyl)-ethyl acrylate, and mixtures thereof.

In another embodiment, the polymerizable amine-containing unsaturated monomer which is the basis for the side chains is an amine-containing methacrylate monomer. The amine-containing methacrylate monomer has a structure represented by the formula

CH₂═C(CH₃)—CO—O—Yⁿ¹—Rⁿ¹,

wherein
—Yⁿ— is a bond, or a C₁ to C₁₈ bridging alkyl group optionally substituted with one or more C₁ to C₆ alkyl groups; and

### —Rⁿ¹ is

(5) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(6) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(7) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
(8) a C₆ to C₁₄ aryl group further substituted with an amine-containing group.

When the polymerizable amine-containing unsaturated monomer which is the basis for the side chains is an amine-containing acrylate monomer of formula CH₂═C(CH₃)—CO—O—Yⁿ—Rⁿ¹, then moiety —Rⁿ¹ comprises nitrogen.

Examples of suitable polymerizable amine-containing methacrylate include 2-aminoethyl methacrylate, t-butylaminoethyl methacrylate, 2-(diethylamino)ethyl methacrylate, dimethylaminomethyl methacrylate, diethylaminoethyl methacrylate, 2-dimethylaminoethyl methacrylate, DMAEMA, oxazolidinyl ethylmethacrylate, aminoethyl methacrylate, diethylaminohexyl methacrylate, 3-dimethylamino-2,2-dimethyl-propyl methacrylate, methacrylate of N-hydroxyethyl-2,4,4-trimethylpyrrolidine, 1-dimethylamino-2-propyl methacrylate, beta-morpholinoethyl methacrylate, 3-(4-pyridyl)-propyl methacrylate, 1-(4-pyridyl)-ethyl methacrylate, 1-(2-methacryloyloxyethyl)-2-imidazolidinone, Norsocryl 102, 3-(beta-methacryloxyethyl)-pyridine, 3-methacryloxypyridine, oxazolidinyl ethyl methacrylate, and mixtures thereof.

Under one embodiment of the present invention the amine-containing methacrylate is selected from the group consisting of t-butylaminoethyl methacrylate, 2-dimethylaminoethyl methacrylate, DMAEMA, and 1-(2-methacryloyloxyethyl)-2-imidazolidinone.

The acrylamide has a structure represented by the formula

CH₂═CH—Xⁿ—Yⁿ—Rⁿ¹,

wherein

### —Xⁿ— is —CO—NH—, or —CO—;

—Yⁿ— is a bond, or a C₁ to C₁₈ bridging alkyl group optionally substituted with one or more C₁ to C₆ alkyl groups; and

### —Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and
provided that when —Xⁿ— is —CO—, then —X— is a bond and —Rⁿ¹ is NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups.

Acrylamide that is a suitable polymerizable amine-containing unsaturated monomer which is the basis for the side chain of the copolymer of the present invention has a nitrogen as a part of the acrylamide group CH₂═CH—CO—NH— or CH₂═CH—CO—NRⁿ³Rⁿ⁴. Further, in addition to the nitrogen which is a part of the acrylamide group, acrylamide that is a suitable polymerizable amine-containing unsaturated monomer may have one or more additional nitrogen atoms on the Rⁿ¹ group, making each repeating unit have at least two nitrogens.

Examples of suitable acrylamides include N,N-dimethylacrylamide, NNDMA, N-acryloylamido-ethoxyethanol, N-t-butylacrylamide, N-diphenylmethyl acrylamide, and N-(beta-dimethylamino)ethyl acrylamide. Of these acrylkamides, N,N-dimethylacrylamide, NNDMA, and N-(beta-dimethylamino)ethyl acrylamide have two nitrogen atoms.

In another embodiment the acrylamide is N,N-dimethylacrylamide, or NNDMA.

A methacrylamide has a structure represented by the formula

CH₂═C(CH₃)—Xⁿ—Yⁿ—Rⁿ¹

wherein

### —Xⁿ— is —CO—NH—, or —CO—;

—Yⁿ— is a bond, or a C₁ to C₁₈ bridging alkyl group optionally substituted with one or more C₁ to C₆ alkyl groups; and

### —Rⁿ¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and
provided that when —Xⁿ— is —CO—, then —X— is a bond and —Rⁿ¹ is (2).

Methacrylamide that is a suitable polymerizable amine-containing unsaturated monomer which is the basis for the side chain of the copolymer of the present invention has a nitrogen as a part of the methacrylamide group CH₂═C(CH₃)—CO—NH— or CH₂═C(CH₃)—CO—NRⁿ³Rⁿ⁴. Further, in addition to the nitrogen which is a part of the acrylamide group, acrylamide that is a suitable polymerizable amine-containing unsaturated monomer may have one or more additional nitrogen atoms on the Rⁿ¹ group, making each repeating unit have at least two nitrogens.

Examples of suitable methacrylamides include N-(3-dimethylaminopropyl) methacrylamide and N-(beta-dimethylamino)ethyl methacrylamide. Both of these exemplary compounds contain two nitrogen atoms.

An amine-containing vinyl monomer has a structure represented by the formula

CH₂═CH—Xⁿ—Yⁿ—Rⁿ¹,

wherein
—Xⁿ— is a bond, —O—, or —S—;
—Yⁿ— is a bond, or a C₁ to C₁₈ bridging alkyl group optionally substituted with one or more C₁ to C₆ alkyl groups; and

### —Rⁿ¹ is

(1) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(2) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(3) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; and
(4) a C₆ to C₁₄ aryl group further substituted with an amine-containing group.

The copolymeric side chains that are attached to the hydrophobic functional polymeric backbone may optionally comprise additional components. Such components may be added within the structure of side chains, and may be used to improve the physical or chemical properties of the graft copolymer, such as the stability of the ink. One such component is a structural unit that acts as a UV absorber. Such a UV absorber will dissipate the energy that is absorbed by the printed ink thus mitigating the aging process of the printed ink. Such a UV absorber will absorb the UV radiation and prevent the formation of free radicals. Examples of UV absorbers that may be incorporated into the side chains include benzophenones, hindered amine light stabilizers, benzotriazoles, nickel quenchers, 2-(2′-hydroxy-5′-methacryloyloxy ethylphenyl)-2-H-benzotriazole, Ruva 93, bis(1,2,2,6,6-pentamethyl-4-piperidinyl)sebacate and methyl(1,2,2,6,6-pentamethyl-4-piperidinyl)sebacate, and bis(2,2,6,6-tetramethyl-4-piperidyl) sebacate.

Cationic functional groups of grafting polymers make very high polar characteristics by cationic charge and can help polymers to mix easily with water and other polar solvents such as methanol, ethanol, dimethylamide (DMF), dimethylsulfoxide (DMSO), and n-methyl-2-pyrrolidone (NMP). Accordingly, cationic-containing resins are very efficient and valuable to form stable and non-sufactant water-based resins and then to provide water-based jet ink that when printed yields excellent adsorption properties on many different surfaces and stability against common cleaners. To make this kind of versatile cationic group, all types of amine-containing units should be contained in grafts of side chains, such as amine-containg acrylate, an amine-containing methacrylate, acrylamide, methacrylamide, and other amine-containing vinyl monomers. Also, acids as a chemical reagent are required to generate cationic on amine-based units, such as acetic acid, formic acid, lactic acid, and all kind of acids as well as halide-based acid of hydrochrolic acid, hydrobromic acid, etc.

The weight ratio of the polymeric backbone in the graft copolymer of the present invention to the plurality of copolymeric side chains is selected so that the graft copolymer of the present invention provides for excellent water disperability. The preferred weight ratio of the polymeric backbone in the graft copolymer of the present invention to the plurality of copolymeric side chains is between 10:90 and 60:40. However, the weight ratio of acrylate and hydroxyl containing acrylate is meaningful. The number of hydroxyl units in the polymer backbone determine the number of grafts containing hydrophilic groups of amines. Too many hydrophilic units of grafts may negatively impact the stability of the graft graft copolymers, so that the molar ratio of hydrophilic and hydrophobic units is determinative of the water disperability/compatability of the copolymers.

The copolymeric side chains attached to the hydrophobic functional polymeric backbone may optionally comprise additional components. Such components may be added within the structure of side chains, and may be used to improve the physical or chemical properties of the graft copolymer, such as the stability of the ink. One such component is a structural unit that acts as a UV absorber. Such a UV absorber will dissipate the energy that is absorbed by the printed ink thus mitigating the aging process of the printed ink. Such a UV absorber will absorb the UV radiation and prevent the formation of free radicals. Examples of UV absorbers that may be incorporated into the side chains include benzophenones, hindered amine light stabilizers, benzotriazoles, nickel quenchers, 2-(2′-hydroxy-5′-methacryloyloxy ethylphenyl)-2-H-benzotriazole, Ruva 93, bis(1,2,2,6,6-pentamethyl-4-piperidinyl)sebacate and methyl(1,2,2,6,6-pentamethyl-4-piperidinyl)sebacate, and bis(2,2,6,6-tetramethyl-4-piperidyl) sebacate.

The graft copolymer as described herein may have many uses within the coating and film applications, but it is especially useful as a binder in inks, particularly water based jet inks.

The advantage of the graft copolymer is to provide water based jet ink which when printed yields excellent adhesion properties on low energy surfaces and provides stability against common cleaners.

The graft copolymer may be easily mixed with water, to yield a homogenous mixture. Such an aqueous mixture may be characterized as a manufacturing use product, which may then further used in the process of preparing of an ink. The definition of phrase “aqueous mixture” as referring to the aqueous mixture of graft copolymer also includes any aqueous mixture comprising the graft copolymer which may be conveyed to the same or another manufacturer of ink products, including a manufacturing intermediate, a partially formulated ink, or a fully formulated ink. The ink is preferably a jet ink.

The aqueous mixture of the graft copolymer may comprise a colloidal dispersion suitable for use in preparation of a water based jet ink vehicle, wherein the particle size of more than 60% of particles of the dispersion is less than 1000 nanometers. Preferably, the particle size of more than 80% of particles in the dispersion is less than 750 nanometers.

More preferably, the particle size of more than 90% of particles in the dispersion is less than 500 nanometers. The particle size refers to the median size of particles of the graft polymer.

Stability testing of an aqueous mixture, or a dispersion, of the graft polymer shows that the aqueous mixture is stable with respect to several physical characteristics, including viscosity and particle size distribution. Viscosity as measured via Brookfield viscometer, showed that viscosity of the aqueous mixture did not change within 10% after being exposed for 14 days at 60° C. (Spindle Size: LV spindle #2, Viscosity Speed: 30 RPM, Temperature: 25° C., Viscosity UOM: Centipoise (cps)). Particle-size distribution, as measured by static light scattering showed that the particle size distribution did not change within 10% after being exposed for 14 days at 60° C.

Binders in jet inks are traditionally difficult to dissolve or disperse in an aqueous solution. To aide with the mixing, homogenization, dispersement or dissolution, a surfactant or a mixture of surfactants is typically added to the mixture. It is thus unexpected and not predictable that the graft copolymer of the present invention mixes well with water without the need to resort to a surfactant.

The graft copolymers as described herein are particularly suitable for use in formulating of a liquid ink. The liquid ink so formulated with the graft copolymer may be any type of a liquid ink, but the graft copolymers are particularly suitable for jet ink. Jet ink, otherwise known as inkjet ink, is used in inkjet printers that create an image by propelling droplets of such ink onto a substrate. The jet ink as herein may be used within the continuous inkjet technology, thermal drop-on-demand technology, or piezoelectric drop-on-demand technology.

A liquid ink formulation of the present invention comprises about 4 to about 9 weight percent graft copolymer, about 1 to about 5 weight percent pigment or dye, 0 to about 25 weight percent of additives required for performance such as antimicrobial agents, co-solvents or UV stabilizers and balance is water.

The liquid ink may further comprise a co-solvent. Under one embodiment of the present invention the co-solvent is miscible with water. Examples of a water-miscible co-solvent include propylene glycol, 2-propanol, 1,2-hexanediol, propylene glycol methyl ether, dipropylene glycol methyl ether, diethylene glycol, diethylene dimethyl ether, diethylene glycol diethyl ether, Texanol™, 2,2,4-trimethyl-1,3-pentanediol monoisobutyrate, and methyl pyrrolidone.

When co-solvents are used, the liquid inks of the present invention are formulated to comprise about 4 to about 9 weight percent graft copolymer, about 1 to about 5 weight percent pigment or dye, up to about 15% co-solvent, up to about 10% of other specific additives required for performance such as antimicrobial agents, UV stabilizers, defoamers and balance is water.

Under another embodiment of the present invention, the co-solvent is not fully miscible with water. Such a co-solvent may act on the interface of water and the hydrophobic portion of the copolymer. Such a co-solvent is adsorbed into the hydrophobic portion of the graft co-polymer.

The pigment as used in the liquid ink is not particularly limited, and any of an inorganic pigment and an organic pigment may be used. Examples of the inorganic pigment include titanium oxide and iron oxide. Further, a carbon black produced by a known method such as a contact method, a furnace method, or a thermal method can be used.

Examples of the organic pigment include an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, Aniline Black or the like can be used.

Specific examples of the carbon black which is used as the black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black 5150, Color Black S160, Color Black S170, Printex 35, Printex U, Printex V, Printex 1400, Special Black 6, Special Black 5, Special Black 4A, and Special Black 4 (all of which are manufactured by Degussa AG).

Specific examples of the pigment which is used in the yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in the magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in the cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

The liquid ink of the present invention may be applied to any substrate on which inkjet inks are typically applied, including porous materials. Upon application of ink droplets onto a porous substrate, the ink wets the substrate, the ink penetrates into the substrate, volatile components of the ink evaporate, leaving a dry mark on the substrate. Examples of porous substrates include paper, paperboard, cardboard, woven fabrics, and non-woven fabrics.

It is an unexpected result that the liquid ink of the present invention may be also successfully applied to non-porous substrates. Examples of non-porous substrates include glossy coated paper, glass, ceramics, polymeric substrate, and metal.

The liquid ink of the present invention is particularly suitable for use on polymeric substrates. Examples of polymeric substrates include polyolefin, polystyrene, polyvinyl chloride, nylon, polyethylene terephthalate, high-density polyethylene, low-density polyethylene, polypropylene, polyester, polyvinylidene chloride, urea-formaldehyde, polyamides, high impact polystyrene, polycarbonate, polyurethane, phenol formaldehyde, melamine formaldehyde, polyetheretherketone, polyetherimide, polylactic acid, polymethyl methacrylate, and polytetrafluoroethylene.

The liquid ink of the present invention is also suitable for use on metal substrates. Examples of metal substrates include base metals, ferrous metals, precious metals, noble metals, copper, aluminum, steel, zinc, tin, lead, and any alloys thereof.

The liquid ink of the present invention is also suitable for use of high surface energy substrates. Examples of high surface energy substrates include phenolic, Nylon, alkyd enamel, polyester, epoxy, polyurethane, acrylonitrile butadiene styrene copolymer, polycarbonate, rigid polyvinyl chloride, and acrylic.

The liquid ink of the present invention is also suitable for use of low surface energy substrates. Examples of low surface energy substrates include polyvinyl alcohol, polystyrene, acetal, ethylene-vinyl acetate, polyethylene, polypropylene, polyvinyl fluoride, and polytetrafluoroethylene. Upon application to a low energy substrate, the volatizable components of the ink evaporate to yield a coating on the substrate. Such a coating is resistant to water or cleaning solvents.

Upon application of the liquid ink to the substrate, the volatile portions of the ink evaporate, leaving behind a residue or a coating on the substrate. The coating on the non-porous substrate is found on the surface of the substrate. The adhesion of the coating to the non-porous substrate is a crucial characteristic of the liquid ink. It surprising that the liquid ink of the present invention, wherein upon application to a polymeric, fabric or metal substrate and evaporation of the volatizable components of the ink to yield a coating on the substrate, that the resulting coating is resistant to water or a cleaning solvent.

Process for Making Graft Cationic Copolymers

In another aspect, the present disclosure provides a process for preparing the graft copolymers disclosed herein. In the synthesis process for preparing the graft copolymer the backbone polymer/copolymer and the side chain polymer/copolymer are typically prepared separately before they are reacted together.

Accordingly, in one embodiment, there is provided a process for making a graft cationic copolymer, the process comprising:

a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups;

b) separately reacting in the presence of a solvent (i) at least one polymerizable unsaturated monomer and (ii) at least one polymerizable amine-containing unsaturated monomer in the presence of a hybridizing compound to form a second polymer composition, wherein the hybridizing compound comprises a functional group selected from the group consisting of an isocyanate group, an amino group, an epoxy group, a carboxylic acid group, and an acyl halide group;

c) reacting the first polymer composition and the second polymer composition in the presence of a solvent such that the functional group of the second polymer composition reacts with the hydroxyl groups of the first polymer composition to form randomly graft side chains on the first polymer composition to form a graft coploymer; and

d) adding an acid to the graft coploymer in the presence of water to form a cationic graft coploymer.

In another embodiment, there is provided a process for making a graft cationic copolymer, the process comprising:

a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups;

b) separately reacting in the presence of a solvent (i) at least one unsaturated monomer having a structure represented by Formula I:

CH₂═C(R²)—X—Y—R¹ (Formula 1)

wherein

—R² is H, halogen, or C₁ to C₃ alkyl group;

—X— is a bond, —CO—O—, or —O—CO—;

—Y— is a bond, or a C₁ to C₂₂ bridging alkyl group optionally substituted with one or more C₁ to C₆ alkyl groups; and

—R¹ is

(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe;
(8) —CZ═CH₂, wherein Z is H or halogen; and

### (9) —CO—OH,

with (ii) a polymerizable amine-containing unsaturated monomer having a structure represented by Formula 2:

CH₂═C(Rⁿ²)—Xⁿ—Yⁿ—Rⁿ¹ (Formula 2)

wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and

### —R¹ is

### (1) H;

(2) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(3) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(4) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(5) a C₆ to C₁₄ aryl group further substituted with an amine-containing group;
(6) a C₁ to C₈ alkyl group substituted with a plurality of aryl groups; or
(7) polyethylene glycol, polypropylene glycol, or a copolymer thereof, terminated with —OH or —OMe; and
wherein —Xⁿ— or —Rⁿ¹ or both comprise nitrogen,

wherein the at least one unsaturated monomer having a structure represented by Formula I and the polymerizable amine-containing unsaturated monomer having a structure represented by Formula 2 are reacted in the presence of a hybridizing compound to form a second polymer composition, wherein the hybridizing compound comprises a functional group selected from the group consisting of an isocyanate group, an amino group, an epoxy group, a carboxylic acid group, and an acyl halide group;

c) reacting the first polymer composition and the second polymer composition in the presence of a solvent such that the functional group of the second polymer composition reacts with the hydroxyl groups of the first polymer composition to form randomly graft side chains on the first polymer composition to form a graft coploymer; and

d) adding an acid to the graft coploymer in the presence of water to form a cationic graft coploymer.

The preparation of the graft copolymer may add one or more additional steps before steps a), b), c), and d). The preparation of the graft copolymer may add one or more additional steps after steps a), b), c), and d). The preparation of the graft copolymer may add one or more additional steps between any of the steps a), b), c), and d). Such additional steps may include adding further reactants, adding a third or fourth or additional monomer components to the reaction mixture, changing the reaction conditions, working up the reaction mixture, and purifying any of reactants.

Further, any of the individual steps a), b), c), and d) may comprise additional necessary components or sub-steps in order to prepare the graft copolymer and/or cationic graft copolymer.

Step a)

The process disclosed herein includes the step of reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups. The at least one unsaturated monomer selected from the group consisting of an acrylate monomer, an alkyl acrylate monomer, and a mixture thereof is at least one unsaturated monomer represented by Formulas A, B, C, and D as detailed above. The use of acrylate and/or alkyl acrylate monomers to make up the hydrophobic backbone allows one to tailor the glass transition temperature (T_{g}) of the final graft cationic polymer based on needs of a particular application (e.g., flexibility, adhesive properties, heat resistance, etc.). By using the unsaturated monomers of Formulas A, B, C, and D to form the polymeric backbone, a T_{g} can be achieved in the range of from about −10° C. to about 90° C. by varying the composition of the backbone. The decomposition temperature of T_{d} is also important because this temperature will determine the thermal degradation of the polymers. This T_{d} can present an upper limit to the service temperature of polymers including plastics, rubbers, thermoplastic elastomers as much as the possibility of mechanical property loss. By the mechanism of thermal degradation, molecular weight of polymers and other typical properties are changed. Therefore, the decomposition temperature should be investigated and indicated to understand the optimal properties of the polymers. In the present invention, most of the graft polymers demonstrate the range of decomposition temperate between about 100° C. and about 400° C.

Different unsaturated monomers may be added at different times or the same unsaturated monomer may be added in an alternating fashion or otherwise during the reaction process to control the chemical makeup of the backbone and, hence, the T_{g} of the graft cationic polymer. As noted above, at least one of the unsaturated monomers employed in step a) of the synthesis disclosed herein comprises hydroxyl groups. The presence of the hydroxyl groups provides a functionality to what will be the backbone polymer such that the side chains can be graft onto the backbone via reaction with the hydroxyl groups. Accordingly, the amount of hydroxyl groups on the backbone and amine groups of side chains will ultimately dictate the functional properties of the final graft cationic polymer.

The monomers are randomly reacted by a free radical polymerization process in the presence of a solvent. The solvent can any organic solvent that dissolves the unsaturated monomers. Preferably, the solvent employed will not react with the unsaturated monomers. Examples of suitable solvents for use in step a) include mineral oil; straight and branched-chain hydrocarbons, such as pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof; halogenated hydrocarbons such as dichloromethane, chloroform, carbon tetrachloride, perfluorinated C₅ to C₁₀ alkanes; chlorobenzenes; aromatic and alkylsubstituted aromatic compounds, such as benzene, toluene, mesitylene, and xylene; ethers, such as diethyl ether, tetrahydrofuran, 1,4-dioxane; ketones, such as acetone, methyl ethyl ketone (MEK); dimethyl sulfoxide (DMSO); acetonitrile; amides, such as dimethylformamide (DMF), dimethylacetamide (DMA), N-methyl-2-pyrrolidone (NMP); amine, such as pyridine, 2-methylpyridine, 4-methylpyridine, triethylamine (TEA), tripropylamine (TPA), tributylamine (TBA).

Preferably, the polymerization reaction of step a) is performed at a reflux temperature based on the solvent employed. For example, if MEK is the solvent, the reaction may proceed at about 80° C., i.e., the boiling point of MEK, or slightly higher.

Preferably, the polymerization reaction of step a) is performed under an inert atmosphere such as, for example, nitrogen.

The polymerization of step a) can be terminated when the desired melecular weight is achieved. A target number average molecular weight is typically from 3,000 g/mol to 200,000 g/mol, preferably, from 15,000 g/mol to 100,000 g/mol, and more preferably from 15,000 g/mol to 50,000 g/mol. In other embodiments, a target number average molecular weight is from 3,000 g/mol to 100,000 g/mol, and more preferably from 3,000 g/mol to 50,000 g/mol.

Step b)

The process disclosed herein comprises the step of separately reacting in the presence of a solvent (i) at least one polymerizable unsaturated monomer and (ii) at least one polymerizable amine-containing unsaturated monomer in the presence of a hybridizing compound to form a second polymer composition, wherein the hybridizing compound comprises a functional group selected from the group consisting of an isocyanate group, an amino group, an epoxy group, a carboxylic acid group, and an acyl halide group.

In a preferred embodiment, the (i) at least one unsaturated monomer has a structure represented by Formula I:

CH₂═C(R²)—X—Y—R¹ (Formula 1)

wherein

—R² is H, halogen, or C₁ to C₃ alkyl group;

—X— is a bond, —CO—O—, or —O—CO—;

—Y— is a bond, or a C₁ to C₂₂ bridging alkyl group optionally substituted with one or more C₁ to C₆ alkyl groups; and

—R is

(10) H, halide, —OH, or —CN;
(11) a C₃ to C₈ cycloalkyl group that is optionally substituted with one or more linear or branched C₁ to C₆ alkyl group;
(12) a C₃ to C₈ heterocycloalkyl group comprising one or more heteroatoms, wherein the heteroatom is a chalcogen;
(13) a C₇ to C₁₅ bicycloalkyl group that is optionally substituted with one or more halogens, or linear or branched C₁ to C₆ alkanes;
(14) a C₆ to C₁₄ aryl group that is optionally substituted with one or more groups selected from the group consisting of a halogen, a linear or branched C₁ to C₆ alkane, and C₁ to C₃ alkyloxy;
(15) SiR³₃, wherein R³ is C₁ to C₃ alkyl group;
(16) polyethylene glycol, polypropylene glycol, or a copolymer thereof, terminated with —OH or —OMe;
(17) —CZ═CH₂, wherein Z is H or halogen; and
(18) —CO—OH, and the polymerizable amine-containing unsaturated monomer has a structure represented by Formula 2:

CH₂═C(Rⁿ²)—Xⁿ—Yⁿ—Rⁿ¹ (Formula 2)

wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and

### —R¹ is

### (8) H;

(9) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(10) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(11) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(12) a C₆ to C₁₄ aryl group further substituted with an amine-containing group;
(13) a C₁ to C₈ alkyl group substituted with a plurality of aryl groups; or
(14) polyethylene glycol, polypropylene glycol, or a copolymer thereof, terminated with —OH or —OMe; and
wherein —Xⁿ— or —Rⁿ¹ or both comprise nitrogen.

The term “separately” as used in step b) means that the polymerization described in the step is performed in a different reactor separate from the polymerization described in step a) of the process. The first polymer composition formed in step a) is intended to be the precursor to the hydrophobic polymer backbone and the second polymeric composition produced by step b) is the precursor of the hydrophillic polymeric side chains which will then be graft onto the backbone polymers in step c).

The reaction of the (i) at least one polymerizable unsaturated monomer and (ii) at least one polymerizable amine-containing unsaturated monomer in the presence of a hybridizing compound forms a second polymer composition. The reaction mixture at the end of step b) comprises the reaction product of the reaction of the (i) at least one polymerizable unsaturated monomer and (ii) the at least one polymerizable amine-containing unsaturated monomer with a hybridizing compound, any compound that was added in excess, and other compounds, such as a solvent, or a catalyst.

Included in the reaction mixture of the at least one polymerizable unsaturated monomer and the at least one polymerizable amine-containing unsaturated monomer in step b) is a hybridizing compound. The hybridizing compound is a compound that will serve as an end cap on the polymerization product between the at least one polymerizable unsaturated monomer and the at least one polymerizable amine-containing unsaturated monomer such that the functional end cap (from the hybridizing compound) will later function to react with the hydroxyl groups on the backbone precursor. Thus, after addition of the hybridizing compound and reaction therewith, the precursor side chain polymers preferably have a functional end cap (from the hybridizing compound) at one end and an amine group at the other end of each polymer chain.

The hybridizing compound comprises (1) a first functional group that is an alkene or is easily converted into an alkene, (2) a second functional group that is capable of reacting readily to the hydroxyl groups of the hydrophobic polymer (i.e., the backbone precursor) to generate a bond between the hydrophobic polymer and the hydrophillic side chain polymer, and (3) a divalent bridging group connecting the first functional group and the second functional group.

The hybridizing compound has a formula

R^{h1}—B¹-B²—B³—R^{h2},

wherein R^{h1}— is the first functional group on the hybridizing compound, —R^{h2} is the second functional group on the hybridizing compound. The assembly —B¹-B²-B³— represents the divalent bridging group connecting the first functional group to the second functional group, wherein any of —B1-, -B2-, and —B3-, are each independently a bond, an alkyl bridging group, a cycloalkyl bridging group or an aryl bridging group.

The alkyl bridging group may be further substituted with one or more of the following: a terminal alkyl, a terminal cycloalkyl or a terminal aryl group. The cycloalkyl bridging group may be further substituted with one or more of the following: a terminal alkyl, a terminal cycloalkyl or a terminal aryl group. The aryl bridging group may be further substituted with one or more of the following: a terminal alkyl, a terminal cycloalkyl or a terminal aryl group.

The first functional group on the hybridizing compound can be any alkene group that is capable of further polymerization with a polymerizable unsaturated monomer and a polymerizable amine-containing unsaturated monomer. Examples of such alkene groups include vinyl, allyl, isopropenyl, 1-methylvinyl, —CH═CH₂, —CH₂—CH═CH₂, —CH₂—CMe=CH₂, and —CH═CH—CH₃. The first functional group on the hybridizing compound can also be an alkene precursor that may be reacted to yield an alkene group. Alkenes may be prepared by any known method, as long as the alkene preparative reaction does not react with other portions of the polymer. Examples of preparation of alkenes includes alkyne reduction and beta-elimination reactions such as dehydration of alcohols, dehydrohalogenation of alkyl halides, and vicinal dihalide dehaloganation.

The second functional group on the hybridizing compound is a group that is reactive towards the hydroxyl groups on the hydrophobic polymer to react with and covalently bond the hydrophillic side chain polymers to the hydrophobic polymer backbone prepared in step a). Examples of suitable second functional groups include an isocyanate, an amino, an epoxy, a hydroxy, a carboxylic acid, an acyl halide.

When the second functional group on the hybridizing compound is a carboxylic acid, then under appropriate reaction conditions the ester linkage is formed via reaction with the hydroxyl groups.

When the second functional group on the hybridizing compound is an acyl halide group, then under appropriate reaction conditions the ester linkage is formed via reaction with the hydroxyl groups.

When the second functional group on the hybridizing compound is a second hydroxy group, then under appropriate reaction conditions the ester linkage is formed via reaction with the hydroxyl groups. Such conditions may include dehydration under acidic conditions.

When the second functional group on the hybridizing compound is an isocyanate group, then under appropriate reaction conditions the carbamate linkage is formed via reaction with the hydroxyl groups.

Example of hybridizing compounds include 3-isopropenyl-α,α-dimethylbenzyl isocyanate, CH₂═CMe-C₆H₄—CMe₂-NCO, and isocyanatoethyl methacrylate.

The number of hydrophillic polymeric side chains on the backbone is largely controlled by the number of hydroxyl groups on the hydrophobic polymer backbone precursor; because each of the hydroxyl groups is an attachment point for a side chain, the higher the number of functional groups on the hydrophobic polymer backbone precursor, the higher the number of side chains per molecule of hydrophobic polymer that may be potentially be bound to the backbone. In order to take an advantage of a hydroxyl group on the hydrophobic polymer to act as an attachment site for a side chain, the hydroxyl group must react with a hybridizing compound.

In order to achieve full substitution, wherein essentially all of the hydroxyl groups that can be readily reacted are to act as an attachment site for a side chain, a molar ratio of the hybridizing compound to the hydroxyl group on the functionalized hydrophobic polymer is preferably between 24.5:1 and 25.5:1 or slightly higher. This ratio may be in the range 24.5:1 to 5.3:1.

In cases where it is desirable to have a lower number of hydrophillic polymeric side chains on the backbone, a lower amount of hydroxyl groups should be built into the hydrophobic polymer. In cases where it is desirable to have a high number of hydrophillic polymeric side chains on the backbone, a higher amount of hydoxyl groups should be built into the hydrophobic backbone. This can be achieved, for example, by using less or more of a hydroxyl-containing acrylate monomer during the reaction of step a).

Alternatively, it is possible regulate the number of hydrophillic polymeric side chains for any given backbone by adjusting the molar ratio of the hybridizing compound to the hydroxyl group on the hydrophobic polymer. The molar ratio in the range from more than 0:1 to less than 1:1 yields a graft copolymer wherein only a portion of the hydroxyl groups have been replaced with a side chain. For example, if the molar ratio of a first monomer component to the hydroxyl groups on the hydrophobic polymer is 0.5:1, then only about half the hydroxyl groups will be replaced with a side chain.

The reaction of the at least one polymerizable unsaturated monomer and the at least one polymerizable amine-containing unsaturated monomer in step b) preferably occurs in presence of additional components such as a solvent, a catalyst, and an initiator.

The solvent for step b) of the synthesis of the graft copolymer is preferably a solvent which dissolves or disperses the at least one polymerizable unsaturated monomer, the at least one polymerizable amine-containing unsaturated monomer, and the hybridizing compound. Suitable solvents include mineral oil; straight and branched-chain hydrocarbons, such as pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof; halogenated hydrocarbons such as dichloromethane, chloroform, carbon tetrachloride, perfluorinated C₅ to C₁₀ alkanes; chlorobenzenes; aromatic and alkylsubstituted aromatic compounds, such as benzene, toluene, mesitylene, and xylene; ethers, such as diethyl ether, tetrahydrofuran; ketones, such as acetone, methyl ethyl ketone; dimethyl sulfoxide; and acetonitrile. During the reaction, the propogationg polymer will typically achieve a molecular weight where the polymer will precipitate out of the solvent.

The catalyst added to the mixture in step b) of the preparation of the graft cationic copolymer is any compound which helps with controlling or advancing the reaction of the hybridizing compound with the at least one polymerizable unsaturated monomer and/or the at least one polymerizable amine-containing unsaturated monomer. Suitable catalysts includes those catalysts which are known to accelerate the reaction between hydroxyl groups and isocyanate groups, for example. Such catalysts include tertiary amines, including, for example triethylamine, tripropylamine, tributylamine, N-methylmorpholine, N-ethylmorpholine, N-cocomorpholine, N,N,N′,N′-tetramethylethylenediamine, 1,4-diazabicyclo [2.2.2]octane, N-methyl-N′-dimethylaminoethylpiperazine, N,N-dimethylcyclohexylamine, N,N,N′,N′-tetramethyl-1,3-butanediamine, N,N-dimethylimidazole-beta-phenylethylamine, 1,2-dimethylimidazole and 2-methylimidazole. Other suitable catalysts include organic metal catalysts, especially organic bismuth catalysts such as, for example, bismuth(III) neodecanoate, or organic tin catalysts such as, for example, tin(II) salts of carboxylic acids, such as tin(II)acetate, tin(II) octoate, tin(II) ethylhexanoate and tin(II) laurate, and the dialkyltin salts of carboxylic acids, such as dibutyltin diacetate, dibutyltin dilaurate, dibutyltin maleate or dioctyltin diacetate. These catalysts can also be used alone or in combination with other catalysts. It is preferable to use from 0 to 5 weight percent, more preferably from 0.3 to 2.0 weight percent of a catalyst or a catalyst combination, based on the total weight of the reactants. In another embodiment, the catalyst added to the mixture in step b) of the preparation of the graft copolymer is an additive that catalyzes further reaction of the resulting compound with a polymerizable unsaturated monomer, or a polymerizable amine-containing unsaturated monomer, or both.

Preferably, the polymerization reaction of step b) is performed at a reflux temperature based on the solvent employed. For example, if MEK is the solvent, the reaction may proceed at about 80° C., i.e., the boiling point of MEK, or slightly higher.

Preferably, the polymerization reaction of step b) is performed under an inert atmosphere such as, for example, nitrogen.

Step c)

The process disclosed herein includes the step of reacting the first polymer composition (i.e., the hydrophobic backbone precursor) and the second polymer composition (i.e., the hydrophillic side chain precursor) in the presence of a solvent such that the functional group of the second polymer composition (originating from the hybridizing compound) reacts with the hydroxyl groups of the first polymer composition to form randomly graft side chains on the first polymer composition to form a graft coploymer.

The step of reacting the first polymer composition (i.e., the hydrophobic backbone precursor) and the second polymer composition (i.e., the hydrophillic side chain precursor) in the presence of a solvent can occur either when the first polymer composition is added to the second polymer composition or when the second polymer composition is added to the first polymer composition. Here again, the reaction takes place in the presence of a solvent, which can be the same solvent as described above for the preparation of each respective polymer composition.

The reaction of the polymers of the second polymer composition with polymers of the first poolymer composition occurs between the functional group on the polymers of the second polymer composition and the hydroxyl groups on the polymers of the first polymer composition to produce a graft copolymer intermediate having a backbone and a plurality of side chains.

Preferably, the reaction of step c) is performed at a reflux temperature based on the solvent employed. For example, if MEK is the solvent, the reaction may proceed at about 80° C., i.e., the boiling point of MEK, or slightly higher.

Preferably, the reaction of step c) is performed under an inert atmosphere such as, for example, nitrogen.

In some embodiments, initiators and/or chain transfer agents may be employed for the reaction of hydroxyl units in the polymer backbones and isocyanate units in the side chains.

Thus, to synthesize the graft copolymers disclosed herein, three steps are taken. The first step is synthesis of polymer backbones containing hydroxyl groups with 5-30%. The second step is synthesis of grafts of side chains end-capping with isocyanate groups in TMI (3-isopropenyl-α,α′-dimethylbenzyl isocyanate). The third step is the coupling reaction of hydroxyl group in the polymer backbone and isocyanate groups in side chains. By this method, the length of the copolymeric side chains is determined by concentration of initiators and monomers used for synthesis of grafts of side chains at the second step.

Step d)

The reaction of the first polymer composition with the second polymer composition results in the pre-neutralized graft copolymer. Although the neutralization step d) may follow step (c) immediately, there may be one or more intermediate steps that follow step c) and precede step d). Such steps may include one or more additions of a polymerization initiator, a solvent, an antioxidant, a catalyst, or any mixture thereof. Such steps may also include partial evaporation of the solvent.

In step (d), the pre-neutralized graft copolymer in MEK (solvent) is then neutralized with an acid or, preferably, a solution of an acid in DI water.

The neutralization of the pre-neutralized graft copolymer completes the formation of the graft copolymer. The graft copolymer may then be precipitated, or washed, or isolated, or further used in the preparation of a liquid ink. In general, the neutralized cationic graft copolymer in a mixture solvent of MEK and DI water typically does not require further purification for the next step of phase inversion.

The acid which is used to neutralize the pre-neutralized graft copolymer should strong enough to cause neutralization to occur, but it should not be strong enough to degrade the pre-neutralized graft copolymer. Preferably, the acid is a weak acid. Examples of suitable weak acid includes acetic acid, lactic acid, formic acid, propionic acid, carbonic acid, formic acid, hydrofluoric acid, mineral acid, caprylic acid, gluconic acid, and mixtures thereof.

Following step d) of the synthesis of the graft copolymer of the present invention, additional steps may be needed to obtain the graft copolymer. Such steps may include an addition of a solvent, a diluent, a polymerization initiator, a catalyst, or any mixture thereof. Such steps may also include partial evaporation of the solvent.

To prepare a phase-inverted graft polymer, after neutralization, a large amount of DI water is typically charged into the solution of neutralized graft copolymers in MEK. Then, MEK is stripped of at about 65-70° C. under reduced pressure (1.0 mmHg). During this stripping process, phase inversion occurs and the result is a dispersion of cationic resin of graft copolymers in DI water with a particle size typically below about 100 nm (residual MEK is typically below 0.1%). The performance characteristics of the graft copolymer of the present invention are in large part determined by the chemical and physical characteristics of the hydrophobic functional polymeric backbone and of the copolymeric side chains attached to the backbone, as well as the ratios of the polymeric units comprising the graft copolymer. There are several characteristics that appear to be important in order to obtain an ink that would have desirable characteristics. These include the following: (1) the molar ratio of polymerizable amine-containing unsaturated monomer to the hydroxyl groups of on the hydrophobic polymer backbone precursor; and (2) the molar ratio of polymerizable unsaturated monomer as a hydrophobic unit to the polymerizable amine-containing unsaturated monomer as a hydrophilic unit.

The molar ratio of polymerizable amine-containing unsaturated monomer to the hydroxyl groups of the hydrophobic polymer backbone precursor, is the ratio of the total number of moles of the amine-containing unsaturated monomer that is added to the reaction mixture, to the number of moles of hydroxyl groups of the hydrophobic polymer backbone precursor. It has been found that many different ratios may yield acceptable results; however, it is unexpected and surprising that the graft copolymer exhibits improved properties when the molar ratio of polymerizable amine-containing unsaturated monomer to the hydroxyl groups of the hydrophobic polymer backbone precursor is between 3:1 and 12:1.

The molar ratio of the polymerizable unsaturated monomer to the polymerizable amine-containing unsaturated monomer, is the ratio of the total number of moles of the polymerizable unsaturated monomer that is added to the reaction mixture, to the total number of moles of the polymerizable amine-containing unsaturated monomer that is added to the reaction mixture. For these calculations the number of moles of polymerizable unsaturated monomer from all sources are added together, and compared to the number of moles of polymerizable amine-containing unsaturated monomer added together from all sources. It has been found that various ratios may yield acceptable results, however, it is unexpected and surprising that the graft copolymer exhibits improved properties when the molar ratio of the polymerizable unsaturated monomer to the polymerizable amine-containing unsaturated monomer is between 1:1 and 1:5. Preferably, the molar ratio is 1:2.

The copolymeric side chains that are attached to the hydrophobic functional polymeric backbone may optionally comprise additional components. Such components may be added within the structure of side chains, and may be used to improve the physical or chemical properties of the graft copolymer, such as the stability of the ink. One such component is a structural unit that acts as a UV absorber. Such a UV absorber will dissipate the energy that is absorbed by the printed ink thus mitigating the aging process of the printed ink. Examples of UV absorbers that may be incorporated into the side chains include Ruva 93.

The following examples are provided for the purpose of further illustrating the present invention but are by no means intended to limit the same.

### EXAMPLES

Raw Materials and Suppliers.
Poly(vinyl chloride-co-vinyl acetate-co-vinyl alcohol) terpolymer (available as UMOH from Wuxi Honghui Chemical Co. Ltd.).
Polyvinyl butyral (available as Mowital from Kuraray).
2,2′-Azobis-(2-methylbutyronitrile) (AMBN, Vazo™ 67, purity 99.92%, Chemours company FC LLC, CAS No. 13472-08-7).
Methyl ethyl ketone (MEK, purity 99.5%, Sasol Chemicals North America LLC, CAS No. 78-93-3).
Butyl acrylate (BA, purity 99.5%, 15 ppm MEHQ, The Dow Chemical Company, CAS No. 141-32-2).
2-Hydroxyethyl acrylate (HEA, purity 97.9%, DOW Chemical, CAS No. 818-61-1).
3-Isopropenyl-α,α′-dimethylbenzyl isocyanate (TMI, purity 95%, allnex, CAS No. 2094-99-7).
Ureidomethacrylate (MEEU, Evonik, CAS No. 86261-90-7).
Methyl methacrylate (MMA, purity>99.9%, VISIOMER MMA, Evonik CAS No. 80-62-6).
Dimethyl aminoethyl methacrylate (DMAEMA, purity min. 99.0%, VISIOMER MADAME, 800±80 ppm HQME, Evonik Company, CAS No. 2867-47-2).
Isobornyl methmethacrylate (IBOMA, VISIOMER IBOMA, purity 98%, 150±30 ppm HQME, Evonik Company, CAS No. 7534-94-3).

Characterization and Instruments.
Solid content (or nonvolatile materials) is measured using a SMART System 5 CEM (CEM Corporation) with 2-3 grams of aqueous cationic resin on square sample pads at 100° C. for 10 min.
Potential hydrogen (pH) is measured 2-3 times using pH meter (Thermo Scientific, ORION STAR A111) and average of pH is recorded.
Viscosity is estimated using Brookfield method with LV spindle #2 at 25° C. with spinning at 30 rpm (BROOKFIELD ENGINEERING LABS. INC).
To measure particle size, a sample is prepared by adding two drops of aqueous cationic resin into 15 grams of DIO water and particle size is measured using a Nanotrac Flex, Microtrac.
Residue of MEK and monomers are measured using an Agilent Technologies 7890B GC system.
Spectra of Attenuated Total Reflectance-Fourier Transform Infrared (ATR-FTIR, BRUKER, TENSOR27) are run using a by dropping of aqueous cationic resin on diamond crystal plate in order to investigate conversion of isocyanate in TMI and monomers.
The molecular weights (MWs) of the polymers were estimated using size exclusion chromatography (SEC, PerkinElmer, Series 200) with three columns (Mixed bed, 500 Å, Styragel columns) and a refractive index detector at a flow rate of 1 ml/min using THF as the elution solvent at 40° C. and calibrated with styrene standards (American Polymer Standards Corporation).
Thermal properties of decomposition temperature (T_{d}) and glass transition temperature (T_{g}) were characterized with thermogravimetric analysis (TGA, TA Instruments, Q5000) and differential scanning calorimetry (DSC, TA Instruments, Q2000) at 10° C./min.

Preparation of Aqueous Cationic Methacrylic/Acrylic Resins.

The typical procedure for synthesis of grafting random copolymers and aqueous cationic resins includes five steps: 1) synthesis of acrylic backbones with functional groups of hydroxyl (OH), 2) synthesis of methacrylic side chains containing functional groups of isocyanate (NCO), 3) synthesis of grafting random copolymers by reaction of NCO with OH using tin catalyst of T-12 DBTDL, 4) neutralization with a solution of acetic acid and lactic acid in DI water, and 5) phase inversion via stripping out MEK from mixture solution after addition of a large amount of DIO water. The detail synthesis of each step is described below.

Synthesis of Acrylic Backbones of Polybutyl Acrylate-co-poly(2-Hydroxyethyl Aacrylate) (PBA-co-PHEA).

A four-neck round bottom flask was cleaned with methyl ethyl ketone (MEK) solvent and dried by blowing air and N₂ gas. After a condenser was equipped for reflux of MEK solvent at 80° C. by flowing cold water and temperature controller was set, nitrogen (N₂) gas was purged during the entire reaction. MEK solvent (14.88 wt %) was charged under N₂ purge and heated to 80° C. A solution of AMBN (0.02 wt %) in MEK (0.35 wt %) was charged into the flask at 80° C. with stirring at 110 rpm and the AMBN solution container was further rinsed with MEK (0.20 wt %). Next, a monomer mixture of HEA (0.46 wt %) and BA (4.03 wt %) was added dropwise for 30 min at temperature between 80 and 83° C. The monomers solution container was further rinsed with MEK (0.83 wt %). Reaction was held for 6 h at 80° C. under N₂ purging with stirring at 130 rpm. The first aliquot was taken 6 h later for measurement of Attenuated Total Reflectance-Fourier Transform Infrared (ATR-FTIR) and Gas Chromatography (GC). The extra solution of AMBN (0.004 wt %) in MEK (0.15 wt %) was charged into the flask at 80° C. with stirring at 130 rpm and the AMBN solution container was further rinsed with MEK (0.10 wt %). The second aliquot was taken 2 hours later from the first for ATR-FTIR and GC.

Synthesis of Grafting Random Copolymers Using PBA-co-PHEA.

Methacrylic side chains were prepared. A four-neck round bottom flask was cleaned with methyl ethyl ketone (MEK) solvent and dried by blowing air and N₂ gas. A condenser was equipped for reflux of MEK solvent at 80° C. by flowing cold water and the temperature controller was set and nitrogen (N₂) gas was purged during the entire reaction. MEK (17.34 wt %) was charged under N₂ purge and heated to 80° C. with stirring at 110 rpm. 3-isopropenyl-α,α′-dimethylbenzyl isocyanate (TMI, 0.59 wt %) was charged at once and rinsed with MEK (1.24 wt %). A solution of AMBN (0.62 wt %) in MEK (0.99 wt %) was charged at 80° C. with stirring at 120 rpm and rinsed with MEK (0.25 wt %). The reaction was held to initiate isopropenyl of TMI and generate active radicals for 60 mins. The third Aliquot-3 was taken with about 1.0 ml and ATR-FTIR and GC were measured. A monomer mixture of ureidomethacrylate (MEEU, 0.62 wt %), methyl methacrylate (MMA, 1.81 wt %), dimethyl aminoethyl methacrylate (DMAEMA, 4.83 wt %), and isobornyl methmethacrylate (IBOMA, 2.02 wt %) was added dropwise for 15-30 mins and reaction temperature maintained between 80 and 83° C. After charging monomer mixtures, it was rinsed with MEK (1.24 wt %) and the reaction was held for 3 hours at 80° C. under N₂ purging with stirring at 150 rpm. The forth Aliquot-4 was taken with about 1.0 ml and ATR-FTIR and GC were measured. The prepared solution of side chain methacrylic copolymers in MEK remained in the flask at 80° C. under N₂ purge with stirring at 150 rpm without termination for next step of synthesis of grafting polymers.

In order to synthesize grafting random copolymers by a reaction between isocyanate and hydroxyl groups, a solution of acrylic backbones of PBA-co-PHEA in MEK (21.01 wt %) prepared above was charged sequentially to the solution of methacrylic side chains mixture in MEK quickly at 80° C. under N₂ purge with stirring at 180 rpm and rinsed with MEK (5.38 wt %). The fifth Aliquot-5 was taken with about 1.0 ml and ATR-FTIR and GC were measured. Temperature set to 78° C. and was held to reach 78° C. again. DBTDL (T-12 catalyst, 0.03 wt %) was added and the DBTDL container was rinsed with MEK (0.61 wt %). A reaction was held for 60 mins under N₂ purging with stirring at 180 rpm and the sixth Aliquot-6 was taken with about 1.0 ml and ATR-FTIR and GC were measured. Next, a solution of AMBN (0.25 wt %) in MEK (0.99 wt %) was charged at 78° C. with stirring at 180 rpm and AMBN container was rinsed with MEK (0.25 wt %). A reaction was held for 2 hours at 78° C. under N₂ purging with stirring at 180 rpm and the seventh Aliquot-7 was taken with about 1.0 ml and ATR-FTIR and GC were measured. DBTDL (T-12 catalyst, 0.03 wt %) was added and rinsed with MEK (0.31 wt %). A reaction was held for 30 min under N₂ purging with stirring at 180 rpm and then a solution of AMBN (0.25 wt %) in MEK (0.99 wt %) was charged again at 80° C. with stirring at 180 rpm and rinsed with MEK (0.25 wt %). A reaction was held for 90 min under N₂ purging with stirring at 180 rpm and the eighth Aliquot-8 was taken with about 1.0 ml and ATR-FTIR and GC were measured. The reaction was held at 25° C. under N₂ purge without stirring and the ninth Aliquot-9 was taken with about 1.0 ml and ATR-FTIR and GC were measured before conducting neutralization.

Neutralization and Phase Inversion of Resulting Grafting Random Copolymers Using Acetic Acid and/or Lactic Acid with Deionized Water.

The above solution of grafting copolymers in MEK was cooled down to 65° C. A mixture solution of acetic acid (1.66 wt %) and lactic acid (0.20 wt %) in deionized water (DI, 5.44 wt %) was prepared and heated to 65° C. The hot acidic aqueous solution was poured into the polymeric mixture solution at 65° C. with stirring at 200 rpm. The mixture solution became viscous and slightly opaque and then held for 30 min at 65° C. with stirring at 200 rpm. DI water (30.67 wt %) was heated to 65° C. and poured into the neutralized mixture solution at 65° C. while adjusting the speed of stirring from 360-400 rpm. After adding large amount of DI water, the mixture solution became slightly more transparent and much higher in viscosity. It was held for 30 min with stirring at 360-400 rpm. Keeping on reaction temperature at 65° C., large quantity of MEK was stripped out from the neutralized mixture solutions by adjusting pressure around 10-1 mmHg until the residue of MEK remained less than 0.1% in the resulting aqueous solution of cationic resin in DI water. During stripping the MEK, the remaining MEK was measured by GC. After pulling out MEK completely, the aqueous cationic resin was cooled to 25° C. and then the biocide acticide GA (0.11 wt %) was added. The solid content was 30.0-32.0%, acidity pH 5.0-6.0, viscosity less than 300 cps, particle size less than 100 nm, residue of MMA monomer less than 1000 ppm, residue of IBOMA monomer less than 1000 ppm, residue of DMAEMA monomer less than 500 ppm, and residue of MEEU monomer less than 500 ppm.

Sequential Process for Preparation of All (Meth)acrylic Cationic Resins (NK05-18).

A four-neck round bottom flask was cleaned with methyl ethyl ketone (MEK) solvent and dried by blowing air and N₂ gas. After a condenser was equipped for reflux of MEK solvent at 80° C. by flowing cold water and temperature controller was set, nitrogen (N₂) gas was purged during the entire reaction. MEK solvent (189.96 g) was charged under N₂ purge and heated to 80° C. AMBN (0.2 g) was introduced into the flask at 80° C. with stirring at 110 rpm. Next, a monomer mixture of HEA (5.53 g) and BA (48.81 g) was added dropwise for 30 min at temperature between 80 and 83° C. and the monomer mixture container rinsed with MEK (10.0 g). Reaction was held for 5 h at 80° C. under N₂ purging with stirring at 100 rpm. The first Aliquot-1 was taken 5 h later for measurement of Attenuated Total Reflectance-Fourier Transform Infrared (ATR-FTIR) and Gas Chromatography (GC/Mass). Extra AMBN (0.05 g) was charged and the reaction was held for 2 h. The second Aliquot-2 was taken for ATR-FTIR and GC. The polymerization was stopped without termination of reaction using chemical agents and the resulting solution of PBA-co-PHEA in MEK was introduced as it is without further treatment. The third Aliquot-3 was taken for ATR-FTIR and GC/Mass. Yield was over 96%.

Methacrylic side chains were synthesized sequentially. Another four-neck round bottom flask was cleaned with methyl ethyl ketone (MEK) solvent and dried by blowing air and N₂ gas. After a condenser was equipped for reflux of MEK solvent at 80° C. by flowing cold water and temperature controller is set, nitrogen (N₂) gas was purged during the entire reaction. MEK (210.24 g) was charged under N₂ purge and heated to 80° C. with stirring at 110 rpm. 3-isopropenyl-α,α′-dimethylbenzyl isocyanate (TMI, 7.20 g) was charged at once and rinsed with MEK (15.05 g). A solution of AMBN (7.5 g) in MEK (12.0 g) was charged at 80° C. with stirring at 120 rpm and rinsed with MEK (3.05 g). The reaction was held to initiate isopropenyl of TMI and generate active radicals for 60 mins. The forth Aliquot-4 was taken with about 1.0 ml and ATR-FTIR and GC were measured. A monomer mixture of ureidomethacrylate (MEEU, 7.54 g), methyl methacrylate (MMA, 21.91 g), dimethyl aminoethyl methacrylate (DMAEMA, 58.57 g), and isobornyl methmethacrylate (IBOMA, 24.54 g) was added dropwise for 15-30 mins and the reaction temperature was maintained between 80 and 83° C. After charging monomer mixtures, it was rinsed with MEK (15.02 g) and the reaction was held for 3 hours at 80° C. under N₂ purging with stirring at 150 rpm. The fifth Aliquot-5 was taken with about 1.0 ml and ATR-FTIR and GC were measured. The prepared solution of side chain methacrylic copolymers in MEK was held in the flask at 80° C. under N₂ purge with stirring at 150 rpm without termination for next step of synthesis of grafting polymers.

In order to synthesize grafting random copolymers by a reaction between the isocyanate and the hydroxyl groups, a solution of acrylic backbones of PBAco-PHEA in MEK (242.5 g) prepared above was charged sequentially to the solution of methacrylic side chains mixture in MEK quickly at 80° C. under N₂ purge with stirring at 180 rpm and the polymeric solution was rinsed with MEK (65.19 g). The sixth Aliquot-6 was taken with about 1.0 ml and ATR-FTIR and GC were measured. The temperature was set to 78° C. and was held to reach 78° C. again. DBTDL (T-12 catalyst, 0.37 g) was added and rinsed with MEK (7.37 g). The reaction was held for 60 mins under N₂ purging with stirring at 180 rpm and the seventh Aliquot-7 was taken and ATR-FTIR and GC were measured. Next, a solution of AMBN (3.0 g) in MEK (12.0 g) was charged at 78° C. with stirring at 180 rpm and rinsed with MEK (3.05 g). A reaction was held for 2 hours at 78° C. under N₂ purging with stirring at 180 rpm and the eighth Aliquot-8 was taken and ATR-FTIR and GC were measured. DBTDL (T-12 catalyst, 0.2 g) was added and rinsed with MEK (3.97 g). A reaction was held for 30 min under N₂ purging with stirring at 180 rpm and then a solution of AMBN (3.0 g) in MEK (12.0 g) was charged at 80° C. with stirring at 180 rpm and the AMBN container was rinsed with MEK (3.05 g). A reaction was held for 90 min under N₂ purging with stirring at 180 rpm and the ninth Aliquot-9 was taken with about 1.0 ml and ATR-FTIR and GC were measured. The reaction was held at 25° C. under N₂ purge without stirring and the tenth Aliquot-10 was taken with about 1.0 ml and ATR-FTIR and GC were measured before conducting neutralization.

The above solution of grafting copolymers in MEK was cooling down to 65° C. A mixture solution of acetic acid (20.12 g) and lactic acid (2.42 g) in deionized water (DI, 65.28 g) was prepared and heated to 65° C. The hot acidic aqueous solution was poured into the polymeric mixture solution at 65° C. with stirring at 200 rpm. The solution became viscous and slightly opaque and then held for 30 min at 65° C. with stirring at 200 rpm. DI water (372.48 g) was heated to 65° C. and poured into the neutralized mixture solution at 65° C. by adjusting speed of stirring from 360-400 rpm. After adding a large amount of DI water, the solution became slightly more transparent and much higher in viscosity. It was held for 30 min with stirring at 360-400 rpm. Holding the reaction temperature at 65° C., a large quantity of MEK was stripped off of the neutralized solutions by adjusting pressure around 10-1 mmHg until the residue of MEK remained less than 0.1% in the resulting aqueous solution of cationic resin in DI water. The remaining MEK was measured by GC. After pulling out MEK completely, the aqueous cationic resin was cooled down until 25° C. and then the biocide acticide GA (1.38 g) was added and the aqueous cationic resins were produced. Solid content was 30.0-32.0%, acidity pH 5.0-6.0, viscosity less than 300 cps, particle size less than 100 nm, residue of MMA monomer less than 1000 ppm, residue of IBOMA monomer less than 1000 ppm, residue of DMAEMA monomer less than 500 ppm, and residue of MEEU monomer less than 500 ppm.

Preparation of Aqueous Cationic Acrylic Resins Using Dried PBA-co-PHEA by Azeotropic Distillation (NK06-18).).

Azeotropic distillation is a preferred method of purification. A typical azeotropic distillation is performed as described herein. A 500 mL 2-neck round bottom flask was equipped with a magnetic stirrer, a nitrogen inlet, and Dean-Stark trap. Acrylic copolymer of PBA-co-PHEA (52.54 g) with molar ratio of PBA/PHEA=8.76 mol/1.0 mol and toluene (200 g) were charged into the reactor. The reaction mixture was heated to 140° C. and the reaction held for 8 h to ensure complete dehydration. Toluene was refluxed and gathered into the Dean-Stark trap. After removing most of the toluene through the outlet of the Dean-Stark trap, MEK (189.96 g) was charged to the reactor. The resulting solution of dried PBA-co-PHEA in MEK was stored under N₂ purging until used. All next synthesizing and characterizing procedures were followed exactly as described above in the batch of NK05-18.

Synthesis of Hydroxyl-Containing Acrylic Random Copolymers Used as Polymer Backbones for Preparation of Grafting Copolymers.

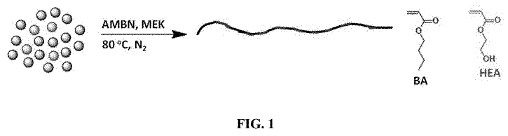

To find optimal condition of polymerization, many modeling synthesis of random copolymers of poly(butyl acrylate)-co-poly(2-hydroxy ethyl acrylate) (PBA-co-PHEA) were conducted via free radical polymerization using different reaction time, ratio and quantity of BA and HEA monomer, and quantity of a radical initiator of AMBN in organic solvent of MEK under N₂ purge at 80° C. as shown in FIG. 1. The monomer mixtures of butyl acrylate and 2-hydroxy ethyl acrylate were added drop-wise to the solution of AMBN in MEK slowly for around 30 mins to avoid very vigorous exothermic reactions. During the polymerization, the mixture solution became viscous and was transparent in MEK. All modeling polymerizations were summarized in Table 1. The hydroxyl functional units in PBA-r-PHEA were employed by introducing the monomers of 2-hydroxy ethyl acrylate during polymerization so that these units could react with isocyanate units in side chains in order to produce resulting grafting polymers.

TABLE 1
Free radical polymerizations of butyl acrylate and 2-hydroxy ethyl
acrylate with AMBN in MEK under N₂ purge at 80° C.

| | Raw materials | | | | | Molecular | | | |
|---|---|---|---|---|---|---|---|---|---|
| Run | BA | HEA | AMBN | MEK | Time | weight (g/mol) | | PDI | Yield |
| No. | (g) | (g) | (g) | (g) | (h) | M_{N} | M_{w} | M_{w}/M_{N} | (%) |
| NK73-17 | 33.32 | 4.64 | 1.15 | 90.06 | 6.5 | 6,500 | 39,200 | 6.02 | 99 |
| NK74-17 | 44.4 | 4.8 | 1.2 | 69.6 | 7.0 | 5,500 | 20,200 | 3.70 | 99 |
| NK75-17 | 0 | 49.2 | 1.2 | 69.6 | 3.0 | — | — | — | <30 |
| NK76-17 | 25.2 | 0 | 1.2 | 93.6 | 7.0 | 3,800 | 13,700 | 3.56 | 99 |
| NK77-17 | 44.7 | 5.1 | 0.6 | 69.6 | 6.5 | 6,000 | 21,800 | 3.63 | 99 |
| NK79-17 | 45.06 | 5.1 | 0.24 | 69.6 | 7.0 | 10,200 | 44,500 | 4.35 | 99 |
| NK80-17 | 45.24 | 5.1 | 0.06 | 69.6 | 6.5 | 12,300 | 53,900 | 4.38 | 97 |
| NK81-17 | 45.24 | 5.1 | 0.01 | 81.6 | 6.5 | 16,400 | 52,600 | 3.20 | 95 |

BA: n-Butyl acrylate,
HEA: 2-Hydroxy ethyl acrylate,
AMBN: 2,2′-Azobis (2-methylbutyronitrile),
MEK: Methyl ethyl ketone,
Mₙ: number average molecular weight,
M_{w}: weight average molecular weight,
PDI (M_{w}/Mₙ): polydispersity index (or molecular weight distribution)

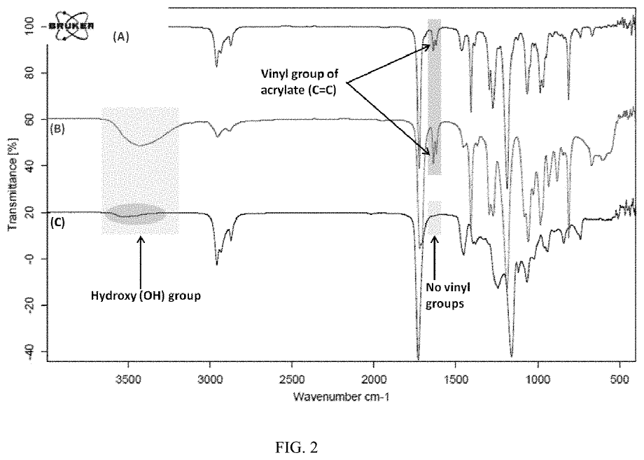

Referring to Table 1, in the first batch of NK73-17, the monomer mixtures of BA and HEA were added rapidly to the solution of AMBN in MEK within 5 min approx. This fast addition of monomers caused very violent exothermic reaction with light fume in the condenser and the reaction temperature reached to around 89° C. Therefore, it is required that monomer mixtures should be added drop-wise slowly around 30 min. From the next batch of NK74-17, all batches were run by adding monomer mixtures dropwise around 30 min slowly. NK74-17 was performed to synthesize random copolymers of PBA-r-PHEA with less chemical components of HEA (BA/HEA=9.25/1.0 wt/wt) than that in NK73-17 (BA/HEA=7.18/1.0 wt/wt) via free radical polymerization with higher concentration (42.0 wt %) than NK73 batch. The monomer mixtures were added completely to the solution of AMBN in MEK for 32 min and the polymeric mixture solution in MEK was getting viscous during the polymerization. To terminate the reaction, conversion of each BA and HEA monomer was monitored through ATR-FTIR as shown in FIG. 2. Vinyl group (C═C) of butyl acrylate at 1637 and 1621 cm⁻¹, vinyl group (C═C) of 2-hydroxy ethyl acrylate at 1637 and 1619 cm⁻¹, and hydroxy group (OH) of 2-hydroxy ethyl acrylate at broad peaks of 3560-1620 cm-1 appeared clearly at the beginning but, after finishing polymerization with complete conversion, all vinyl peaks disappeared totally. The resulting polymeric solution of NK74-17 was translucent and colorless.

The homopolymers of poly(2-hydroxyethyl acrylate) (PHEA) and polybutylacrylate (PBA) were prepared via free radical polymerization to use as a control polymer. The NK75-17 batch demonstrates the synthesis of PHEA homopolymer in MEK at 80° C. under a N₂ purge. During addition of HEA monomers drop-wise into solution, insoluble white solid was precipitated abruptly and the reaction mixture became milky. Only a small quantity of HEA monomers was polymerized because insoluble materials were formed by hydrogen bonding between hydroxyl groups and between hydroxyl groups and carboxylic groups. After polymerization and stripping off the MEK, very viscous transparent polymers were obtained with a 30% conversion yield. ATR-FTIR spectra demonstrated that the viscous polymers are the PHEA because the vinyl peaks disappeared totally after termination. This resulting PHEA polymer had good solubility in water, MeOH, DMF, and DMSO, but poor solubility in organic solvents such as THF, MEK, acetone, Hexane, etc. The molecular weight (M_{N}) could not be measured because of a low solubility of PHEA polymer into THF. On the other hand, the homopolymer of poly(butyl acrylate) (PBA) was synthesized quickly and efficiently via free radical polymerization with almost 100% conversion yield through the batch of NK76-17. After polymerization and pulling out MEK, very viscous transparent polymers were obtained like PHEA polymers. FT-IR spectra demonstrated that viscous polymers are the PBA because the vinyl peaks disappeared totally after complete polymerization.

To manipulate the molecular weight of the random copolymer PBA-r-PHEA, four batches from NK77-17 to NK81-17 were conducted using different quantities of AMBN initiators as shown in Table 1. As the quantity of AMBN was reduced from 0.6 gram to 0.01 gram, molecular weight (M_{N}) increased from 6,000 to 16,400 g/mol but there was no huge difference between the lowest and highest M_{N}. Yield was also slightly changed from 99 to 95%. However, it was verified that PBA-r-PHEA with higher and higher molecular weight could be synthesized by controlling the ratio of monomer mixtures and AMBN initiator concentration in total reaction mixture.

Synthesis of Grafting Methacrylic/Acrylic Random Copolymers.

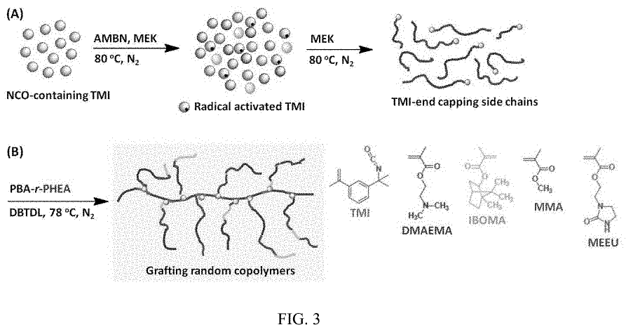

Methacrylic random copolymers of side chains with functional groups of isocyanate (NCO), consisting of up to five different monomers of 3-isopropenyl-α,α′-dimethylbenzyl isocyanate (TMI), ureidomethacrylate (MEEU), methyl methacrylate (MMA), dimethyl aminoethyl methacrylate (DMAEMA), and isobornyl methacrylate (IBOMA) were synthesized in MEK solvent at 80° C. under N₂ via free radical polymerization as shown in FIG. 3A. In particular, TMI monomers were introduced to each polymer chains to functionalize each side chain with isocyanate. The various other methacrylic monomers of MEEU, MMA, DMAEMA, and IBOMA were composed randomly in side chains, by adding a mixture of the monomers. Also, DMAEMA monomers gave cationic properties to the resulting grafting copolymers after neutralization with acids such as glacial acetic acid, lactic acid, etc. Other monomers were able to improve physical properties such as hardness, adhesions, coatings, strain, stress, etc. These methacrylic random copolymers containing NCO groups at the chain ends were reacted with the prepared acrylic random copolymers containing hydroxyl groups in polymer chains by using DBTDL T-12 of a tin catalyst at 78° C. for 6 hours under N₂ purging as shown in FIG. 3B. A solution of random grafting copolymers in MEK were produced completely with high yield over 95%, consisting to flexible acrylic polymers of main chains with low glass transition temperature (T_{g}) and methacrylic polymers of side chains with various functional groups including amines.

To demonstrate the synthesis of side chains to five different monomers containing NCO groups at the chain end, the batch of NK03-18, as a modeling reaction, was conducted using main chain polymers prepared from the NK81-17 batch. The batch of NK03-18 confirmed the successful synthesis of grafting methacrylic/acrylic random copolymers and Table 2 shows a sort and quantity of raw materials. The random copolymers of 3-isopropenyl-α,α′-dimethylbenzyl isocyanate end-capped poly(dimethyl aminoethyl methacrylate)-random-poly(isobornyl methacrylate)-random-poly(methyl methacrylate)-random-poly(ureido methacrylate) (TMI end-capped PDMAEMA-r-PIBOMA-r-PMMA-r-PMEEU) were translucent in MEK (step 01-07 of Table 2). The previous random copolymers of PBA-r-PHEA prepared from the batch of NK81-17 were employed for this reaction and used as a main chain for grafting random copolymers. The mixture of the PBA-r-PHEA and TMI end-capped PDMAEMA-r-PIBOMA-r-PMMA-r-PMEEU was also a clear, colorless solution (step 08-09 of Table 2). The isocyanate-hydroxyl reaction began after introduction of DBTDL (T-12) into the mixture solution of the side/main chain random copolymers in MEK and this mixture solution became slightly yellowish (or light yellow) (step 10-17 of Table 2).

TABLE 2
Synthesis of grafting methacrylic/acrylic random copolymers
via free radical polymerization at 80° C. and reaction
of NCO with hydroxyl groups at 78° C. under N₂ purging.

| | Raw Materials | CAS# | Quantity (g) | Aliquot |
|---|---|---|---|---|
| 01 | MEK | 78-93-3 | 70.08 | |
| 02 | TMI | 2094-99-7 | 1.31 | |
| 03 | MEK | 78-93-3 | 5.02 | |
| 04 | AMBN | 13472-08-7 | 2.50 | Aliquot-1 |
| | MEK | 78-93-3 | 4.00 | |
| 05 | MEK | 78-93-3 | 1.02 | |
| 06 | MEEU | 86261-90-7 | 2.62 | |
| | MMA | 80-62-6 | 7.60 | |
| | DMAEMA | 2867-47-2 | 20.00 | |
| | IBoMA | 7534-94-3 | 8.40 | |
| 07 | MEK | 78-93-3 | 5.01 | Aliquot -2 |
| 08 | MEK | 78-93-3 | 70.01 | |
| | NK81-17 | — | 17.5 | |
| 09 | MEK | 78-93-3 | 15.04 | Aliquot-3 |
| 10 | DBTDL (T-12) | 77-58-7 | 0.12 | |
| 11 | MEK | 78-93-3 | 2.46 | Aliquot-4 |
| 12 | AMBN | 13472-08-7 | 1.00 | Aliquot-5 |
| | MEK | 78-93-3 | 4.00 | |
| 13 | MEK | 78-93-3 | 1.02 | |
| 14 | DBTDL (T-12) | 77-58-7 | 0.07 | |
| 15 | MEK | 78-93-3 | 1.32 | |
| 16 | AMBN | 13472-08-7 | 1.00 | |
| | MEK | 78-93-3 | 4.00 | |
| 17 | MEK | 78-93-3 | 1.02 | Aliquot-6, -7 and -8 |

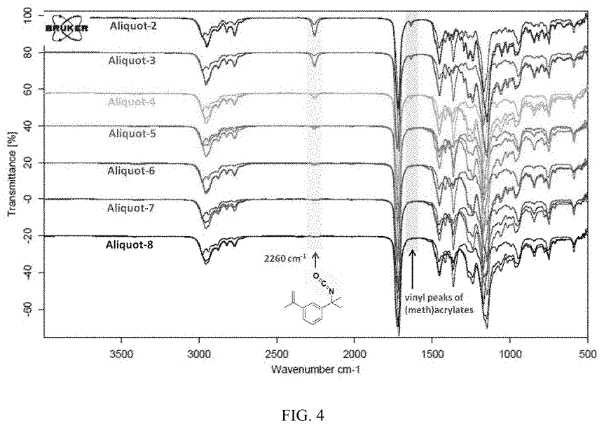

During the polymerizations of methacrylic monomers and grafting reactions of NCO with HO groups in the NK03-18 batch, ATR-FTIR spectra were measured at the end of each from Aliquot-2 to Aliquot-8, respectively. Aliquot-1 was not measured because it just contains the initiated TMI monomers so that only big and sharp peak could appear in ATR-FTIR spectra. ATR-FTIR spectra of FIG. 4 demonstrated a conversion of NCO—OH reaction by monitoring reduction of intensity of isocyanate (NCO) peak at 2260 cm⁻¹ as well as monomer conversion. As the reaction was running with DBTDL catalyst, the intensity of the NCO peak was reduced and the reaction of NCO with OH to produce grafting random copolymers was complete with over 99% yield over 6 h.

Residual monomers of each aliquot were measured by gas chromatography/mass (GC/Mass) spectroscopy and quantity of them obtained from GC/Mass spectra exhibited a conversion of monomers by calculating residue of monomer based on a correlation plot of each monomer, as shown in Table 3. Normally, over 90% of conversion yield of monomers was obtained after polymerization for 3 h and over 99% conversion yield after 7-9 h, based on results of GC/Mass spectra.

TABLE 3
Residual monomers of each aliquot measured by GC/Mass spectroscopy from
Aliquot-2 to Aliquot-8.

| Raw | Retention | Aliquot- | Aliquot- | Aliquot- | Aliquot- | Aliquot- | Aliquot- | Aliquot- |
|---|---|---|---|---|---|---|---|---|
| Materials | (min) | 2 (ppm) | 3 (ppm) | 4 (ppm) | 5 (ppm) | 6 (ppm) | 7 (ppm) | 8 (ppm) |
| MMA | 1.86 | 15850 | 10275 | 4739 | 1361 | 381 | 241 | 234 |
| DMAEMA | 4.49 | 49597 | 31549 | 14473 | 4164 | 1527 | 1002 | 837 |
| IBOMA | 7.21 | 3726 | 5544 | 3027 | 1165 | 566 | 438 | 479 |
| MEEU | 8.86 | 62 | 54 | 47 | 45 | 47 | 42 | 63 |

MMA: methyl methacrylate;
DMAEMA: dimethyl aminoethyl methacrylate;
IBOMA: Isobornyl methmethacrylate;
MEEU: Ureidomethacrylate

Neutralization and Phase Inversion of Resulting Grafting Random Copolymers.

Neutralization and phase inversion of a solution of the resulting grafting random copolymers in MEK were accomplished completely following three steps of 1) addition of acetic and/or lactic acid with different ratios, 2) addition of large amount of deionized water, and 3) stripping out organic solvent of MEK. Consequently, the product of aqueous cationic acrylic resins with grafting architectures was produced entirely of main chains of poly(butyl acrylate)-ramdom-poly(2-hydroxyethyl acrylate) (PBA-r-PHEA and side chains of 3-isopropenyl-α,α′-dimethylbenzyl isocyanate end-capped poly(dimethyl aminoethyl methacrylate)-random-poly(isobornyl methmethacrylate)-random-poly(methyl methacrylate)-random-poly(ureidomethacrylate) (TMI end-capped PDMAEMA-r-PIBOMA-r-PMMA-r-MEEU). Solutions of all-acrylic grafting polymers in MEK were translucent and very light yellow in color. After added acetic/lactic acid, it turned milky and viscosity was increased slightly. By addition of large amount water, the opaque solution was changed to a transparent solution again. The neutralizing cationic (meth)acrylic resins were produced from the batch of NK03-18. The resulting aqueous cationic acrylic resins from NK03-18 had an average particle size of 37.4 nm, 31% of solid content, 5.17 of potential hydrogen (pH), 196 cps of viscosity, and 0.03% of residual MEK. All these physical properties of this product met the range of specification including solid content (29-32%), potential hydrogen (pH, 5.0-6.0), viscosity (<500 cps), particle size (<100 nm), and residue MEK (<0.1%).

Sequential Process for Preparation of All (Meth)Acrylic Cationic Resins (NK05-18).

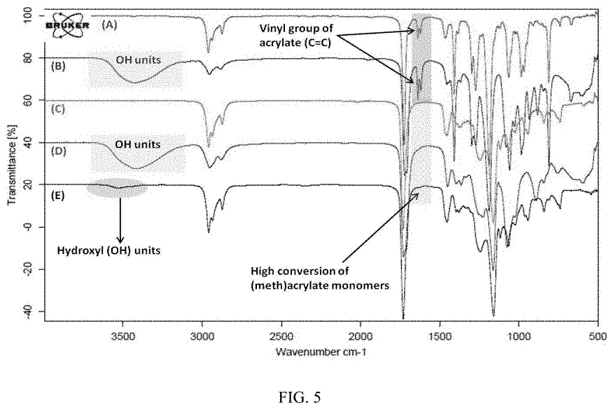

PBA-co-PHEA was introduced to the first batch of NK03-18 for synthesis of grafting random copolymers and preparation of aqueous cationic resins via neutralization and phase inversion. Batch the batch of NK05-18 was performed to investigate the effect of sequential reaction including synthesis of polymer backbone, the synthesis of side chain polymers containing different groups, and the synthesis of grafting random copolymers. At first, the polymer backbone of PBA-co-PHEA was prepared with over 96% yield as shown in FIG. 5 and Table 4. Vinyl group (C═C) of butyl acrylate at 1637 and 1621 cm⁻¹, vinyl group (C═C) of 2-hydroxy ethyl acrylate at 1637 and 1619 cm⁻¹, and hydroxyl group (OH) of 2-hydroxy ethyl acrylate at broad peaks of 3560-1620 cm⁻¹. Even though 3.5% of

BA and 0.036% of HEA monomers were still remained, the resulting random copolymers of PBA-r-PHEA were used for synthesis of grafting copolymers via NCO—HO reaction.

TABLE 4
Residual monomers of each
aliquot measured by GC/Mass spectroscopy.

| Raw | Retention time | Aliquot-1 | Aliquot-2 | Aliquot-3 |
|---|---|---|---|---|
| Materials | (min) | (ppm) | (ppm) | (ppm) |
| BA | 2.85 | 51338 | 40846 | 35060 |
| HEA | 3.4 | 2092 | 561 | 364 |

BA: Butyl acrylate, HEA: 2-hydroxy ethyl acrylate

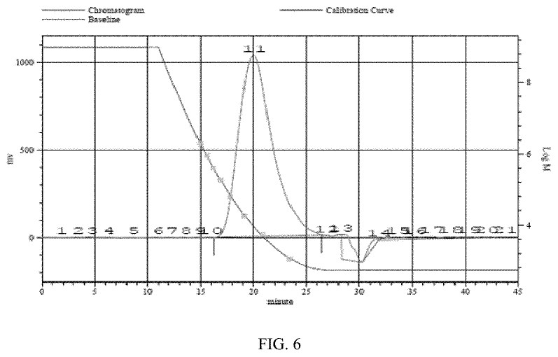

The resulting polymer backbone of PBA-co-PHEA demonstrated a number average molecular weight (M_{N}) of 4200 g/mol, weight average molecular weight (M_{W}) of 13700 g/mol, and polydispersity index (PDI) of 3.29 as shown in FIG. 6 and this molecular weight is four times smaller than that of NK81-17 (M of 16400 g/mol and M_{W} of 52600 g/mol) which is the synthesis of polymer backbone for the synthesis of NK03-18.

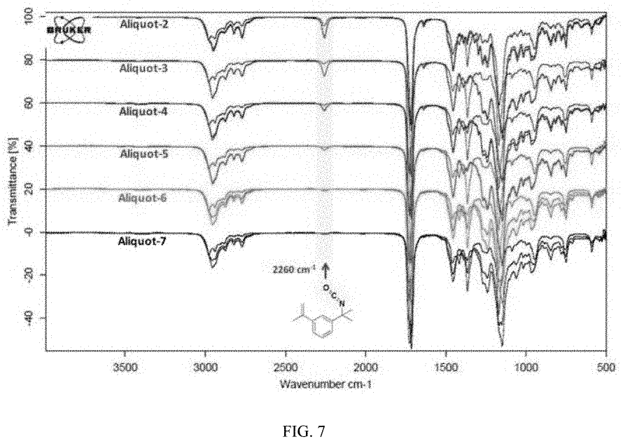

All synthesis and characterization techniques were followed exactly as described above in the batch of NK03-18. After complete preparation of PBA-co-PHEA polymer backbone, synthesis of side chain polymers was conducted based on MEEU, MMA, DMAEMA, and IBOMA monomers with a weight % ratio of MEEU/MMA/DMAEMA/IBOMA=6.7/19.5/52.0/21.8 and side chain polymers were used as grafts to next step of synthesis of grafting random copolymers. DMAEMA monomers are very important and effective to neutralize grafting copolymers with acids and to stabilize polymeric particles in aqueous media so that they are charged over 50% quantity among total quantity of monomers. However, the quantity of DMAEMA is not limited because the quantity of DMAEMA controls the physical properties of the final aqueous cationic resin. After 95% conversion of polymerization, the resulting solution of PBA-co-PHEA in MEK was charged into the solution of the side chain polymeric mixtures in MEK and then the NCO—OH reaction started with the addition of DBTDL T-12 catalyst in MEK solvent for the grafting of random copolymers consisting to PBA-co-PHEA main chains of backbones and PMEEU-co-PMMA-co-PDMAEMA-co-PIBOMA side chains of grafts. The resulting grafting random copolymers were produced after reaction was carried out for 6 h. FIG. 7 shows spectra of ATR-FTIR of each aliquot taken during synthesis of side chain polymers and grafting copolymers. Spectra of Aliquot-2 and -3 demonstrated Isocyanate groups were living before starting NCO—OH reaction. Spectra of each aliquot from Aliquot-4 to Aliquot-7 indicated the conversion of NCO—OH reaction and this reaction were terminated after it was confirmed that conversion of NCO at 2260 cm-1 reached to almost 100%.

Table 5 shows residual monomers of each aliquot measured by gas chromatography/mass (GC/Mass) spectroscopy and a conversion of monomers was calculated based on a correlation plot of residual monomer. After terminating NCO—OH reaction, over 99% conversion was obtained.

TABLE 5
Residual monomers of each aliquot measured by GC/Mass spectroscopy from
Aliquot-2 to Aliquot-8.

| Raw | Retention | Aliquot-2 | Aliquot-3 | Aliquot-4 | Aliquot-5 | Aliquot-6 | Aliquot-7 |
|---|---|---|---|---|---|---|---|
| Materials | time (mm) | (ppm) | (ppm) | (ppm) | (ppm) | (ppm) | (ppm) |
| MMA | 1.86 | 12557 | 8149 | 6609 | 2848 | 1776 | 1491 |
| DMAEMA | 4.49 | 47116 | 28471 | 22724 | 12103 | 6882 | 5742 |
| IBOMA | 7.21 | 4236 | 4741 | 5048 | 3187 | 1924 | 1532 |
| MEEU | 8.86 | 74 | 55 | 63 | 58 | 66 | 76 |

MMA: methyl methacrylate,
DMAEMA: dimethyl aminoethyl methacrylate,
IBOMA: Isobornyl methmethacrylate,
MEEU: Ureidomethacrylate

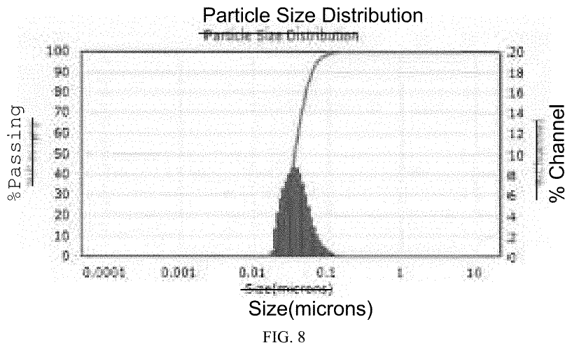

Neutralization and phase inversion of a solution of the resulting grafting random copolymers in MEK were achieved successfully through the three steps of 1) addition of mixture of acetic and lactic acid, 2) addition of large amount of deionized water, and 3) stripping out organic solvent of MEK. Finally, the aqueous cationic acrylic resins were produced. The resulting aqueous cationic acrylic resins from the batch of NK05-18 demonstrated no tailing of particle size distribution (FIG. 8), 35.4 nm of particle size, 30.2% of solid content, 5.57 of potential hydrogen (pH), 270 cps of viscosity, and 0.1% of residual MEK. All these physical properties of this product met the range of specification including solid content (30-32%), potential hydrogen (pH, 5.0-6.0), viscosity (<500 cps), particle size (<100 nm), and residue MEK (<0.1%).

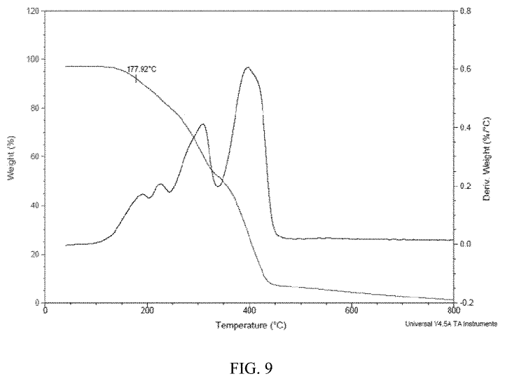

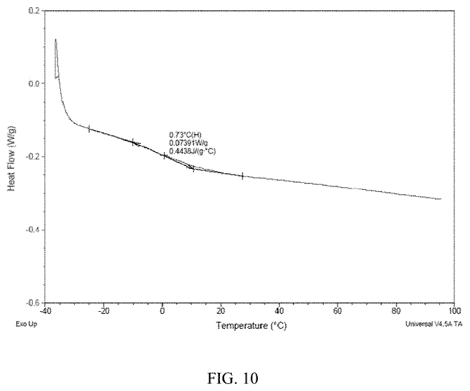

The thermal behaviors of cationic resin produced by NK05-18 batch were measured by thermogravimetric analysis (TGA) as shown in FIG. 9 and by differential scanning calorimetry (DSC) as shown in FIG. 10. To measure decomposition temperature by TGA, a drying film of cationic acrylic resin was prepared at first by drying a solution of the cationic acrylic resins in DIO water at 25° C. under reduced pressure (10-1 mmHg) for 24 h and preheated to 120° C. for 15 min in the TGA furnace. Then, the dynamic TGA experiments were carried out from 40 to 800° C. at a heating rate of 10° C./min under nitrogen. The decomposition temperature (T_{d}, 5% weight loss temperature) was 178° C. because the major monomers of butyl acrylate consists to polymer backbone. Glass transition temperature (T_{g}) of polymers also was investigated using differential scanning calorimeter (DSC) by heat-cool-heat cycles from −40 to 100° C. at a rate of 10° C./min under nitrogen. Before starting DSC, polymer samples were also dried with same way of TGA samples. The Tg of this random grafting copolymer was 0.73° C. almost zero because this grafting polymer backbone is based on butyl acrylate polymers which demonstrate −56° C. of Tg when they are homopolymers. These kind of polymers with low Tg are able to make phase separation easily at room temperature.

Effect of Moisture on Synthesis of Grafting Random Copolymers and their Physical Properties (NK04-18 and NK06-18).

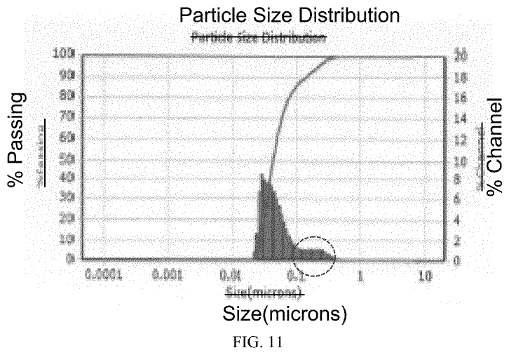

To investigate the effect of moisture, NK04-18 batch was prepared using moisture-containing polymers of PBA-co-PHEA (NK79-18 in Table 1). All synthesis and characterization techniques were followed as described above in the batch of NK03-18. During synthesis of grafting random copolymers, the NCO—OH reaction was interrupted by side reaction of NCO with H₂O of moisture so that the number of grafting was not efficient and then insufficiently reacting main chain remained with a lack of grafts. Therefore, a tailing appeared in particle size distribution as shown in FIG. 11. A lack of grafting to polymer backbone by insufficient NCO—OH reaction due to moisture contamination of polymers made unstable large polymer particles and increase viscosity highly with 1350 cps that is five times higher than that of NK03-18 product.

It was verified that moisture contaminating raw materials including PBA-co-PHEA affected the synthesis and properties of the polymer. So, PBA-co-PHEA (NK77-17 in Table 1) was dried completely by azeotropic distillation using toluene and a solution of dried NK77-17 in MEK by first stripping off the toluene and then adding the MEK. Using the solution of PBA-co-PHEA in MEK, the NK06-18 batch was carried out following the same procedures as for NK05-18 except only the polymer backbone was prepared. ATR-FTIR and GC/Mass spectra obtained during synthesis demonstrated similar or same results with those of the NK05-18 batch. Also, the NK06-18 batch produced good cationic acrylic resins with no tailing of particle size distribution, 30% of solid contents, 5.77 of pH, 162 cps of viscosity, 46.7 nm of particle size, and 0.03% of residual MEK. As a result, in the case of introducing moisture-containing PBA-r-PHEA backbone for the synthesis of the resulting cationic resins, a drying process such as azeotropic distillation using toluene is required. Otherwise, side reaction by moisture-containing PBA-r-PHEA will take place and will change properties such as increase of viscosity.

Additional Batches for Synthesis of Aqueous Cationic Methacrylic/Acrylic Resins.

As described above in detail, the typical procedure for synthesis of grafting random copolymers and aqueous cationic resins followed the four steps based on the results of the NK03-18 and NK05-18 batches: 1) synthesis of acrylic backbones with functional groups comprising hydroxyl (—OH); 2) synthesis of methacrylic side chains containing functional groups of isocyanate (NCO); 3) synthesis of grafting random copolymers by reaction of NCO with OH using tin catalyst of T-12 DBTDL; and 4) neutralization with acetic acid and lactic acid in DIO water via stripping out MEK. Based on the optimized procedure of the NK05-18 batch, other batches were prepared and the results are summarized as shown in Table 6. Two batches of NK15-18 and NK17-18 in Table 6 were carried out to confirm reproducibility with the same reaction volume of NK05-18 and demonstrated similar properties consequently. Next, the NK07-18 batch witch was three times larger than the NK05-18 batch was carried out for the first scale-up test successfully without any issues and produced cationic acrylic resins with very similar physical properties. Also, the seven times scale-up batches were performed such as NK30-18, NK33-18, NK34-18, NK35-18, NK37-18, NK38-18, NK39-18, and NK41-18 and the cationic acrylic resin products were manufactured and exhibited excellent properties.

TABLE 6
Summary of other batches for synthesis of aqueous cationic acrylic resins.

| | Batch | Solid | | | Particle | | | | | |
|---|---|---|---|---|---|---|---|---|---|---|
| Batch | Size | Content | Acidity | Viscosity | size | Residuals (ppm) | | | | |
| # | (kg) | (%) | (pH) | (cps) | (nm) | MMA | IBOMA | DMAEMA | MEEU | MEK (%) |
| NK07-18 | 3.6 | 29.1 | 5.75 | 345 | 36.0 | 23 | 219 | 202 | 39 | 0.05 |
| NK15-18 | 1.2 | 29.7 | 5.20 | 338 | 37.6 | 19 | 205 | 410 | 43 | 0.06 |
| NK17-18 | 1.2 | 29.8 | 5.40 | 279 | 35.5 | 18 | 58 | 15 | 39 | 0.07 |
| NK30-18 | 8.4 | 30.9 | 5.83 | 159 | 42.1 | 18 | 66 | 44 | 36 | 0.07 |
| NK33-18 | 8.2 | 31.2 | 5.83 | 221 | 40.1 | 17 | 6 | 3 | 36 | 0.04 |
| NK34-18 | 8.2 | 30.8 | 5.85 | 246 | 44.3 | 18 | 4 | 5 | 41 | 0.02 |
| NK35-18 | 8.2 | 30.6 | 5.94 | 264 | 40.6 | 1 | 3 | 3 | 36 | 0.02 |
| NK37-18 | 8.4 | 30.5 | 5.73 | 172 | 44.3 | 38 | 53 | 84 | 76 | 0.08 |
| NK38-18 | 8.4 | 31,5 | 5.86 | 112 | 53.4 | 18 | 4 | 9 | 36 | 0.06 |
| NK39-18 | 8.4 | 31.6 | 5.86 | 103 | 60.1 | 20 | 33 | 81 | 41 | 0.04 |
| NK41-18 | 0.8 | 31.2 | 5.80 | 251 | 39.8 | 26 | 99 | 57 | 61 | 0.02 |

Preparation of Cationic Methacrylic/Acrylic Resins by Neutralization Using Lactic Acid Without Glacial Acetic Acid.

To improve open time by slow evaporation, the random methacrylic/acrylic grafting copolymers were synthesized following the same procedure as detailed above and then the resulting grafting copolymer solution in MEK was neutralized with only lactic acid which has high boiling temperature of 122° C./15 mmHg. After phase inversion by stripping off the MEK, aqueous cationic acrylic random grafting copolymers in DI water were obtained and the polymers demonstrated good physical properties. Interestingly, these resulting cationic resins had much lower viscosity of 71 and 76 cps, respectively. For preparation of this cationic resins neutralized with only lactic acid, two batches of NK36-18 and NK48-18 were prepared and the results are summarized in Table 7.

TABLE 7
Preparation of aqueous cationic acrylic resins neutralized with only lactic acid.

| | | Solid | | | Particle | | | | | |
|---|---|---|---|---|---|---|---|---|---|---|
| Batch | Quantity | Cont. | Acidity | Viscosity | size | Residuals (ppm) | | | | |
| # | (kg) | (%) | (pH) | (cps) | (nm) | MMA | IBOMA | DMAEMA | MEEU | MEK |
| NK36-18 | 8.2 | 31.4 | 6.2 | 71 | 45.9 | 17 | 5 | 10 | 36 | 0.06 |
| NK48-18 | 8.2 | 31.2 | 6.1 | 76 | 42.3 | 18 | 30 | 31 | 41 | 0.01 |

Synthesis of Random Grafting Copolymers with High Viscosity.

Generally, cationic acrylic resins produced from previous batches demonstrated a viscosity from over about 100 cps up to about 350 cps. To increase the viscosity of cationic acrylic resins, two batches of NK47-18 and NK49-18 were prepared by adding two times as much 2-hydroxy ethyl acrylate (HEA) monomers (6.3 wt %) than the previous batches using 3.2 wt % among the total monomers. Random grafting acrylic resins were synthesized without side reactions and the prepared aqueous cationic acrylic resins showed much higher viscosity with over 884 cps. Table 8 summarizes the results for batches NK47-18 and NK49-18.

TABLE 8
Synthesis of highly viscous random grafting copolymers using higher quantity of
HEA monomers.

| | | Solid | | | Particle | | | | | |
|---|---|---|---|---|---|---|---|---|---|---|
| Batch | Quantity | Cont. | Acidity | Viscosity | size | Residuals (ppm) | | | | |
| # | (kg) | (%) | (pH) | (cps) | (nm) | MMA | IBOMA | DMAEMA | MEEU | MEK |
| NK47-18 | 1.3 | 29.6 | 5.81 | >1000 | 28.2 | 119 | 64 | 48 | 38 | 0.02 |
| NK49-18 | 1.0 | 29.3 | 5.68 | 884 | 29.9 | 52 | 76 | 37 | 37 | 0.04 |

Synthesis of a Variety of New Grafting Copolymers by Replacing Polymer Backbone and Their Aqueous Cationic Resins.

As described above, this new approach is an excellent technique for the synthesis of (meth)acrylic grafting random copolymers. Using this technique, a variety of grafting random copolymers can be synthesized by employing various hydroxyl-containing polymer backbones as well as isocyanate-containing side chain polymers of grafts. Accordingly, instead of hydroxyl-containing n-butyl acrylic polymers as a polymer backbone, other kinds of hydroxyl-containing polymers were introduced as an alternative and a variety of new aqueous cationic resins were prepared after synthesis of their grafting random copolymers depending on a different polymer backbone, such as hydroxy-containing polyvinylchlorides (PVCs), polyurethanes (PUs), polyvinyl butyrals (PVBs), polymethyl methacrylates (PMMAs), polybutyl methacrylates (PBMAs), polycarbonates (PCs), and other hydroxy-containing polymer resins.

Preparation of Aqueous Cationic Resins Using Hydroxy-Containing Polyvinylchlorides.

The synthetic approach of GRAFTING FROM described in U.S. patent application Publication No. 2014/0051798 A1 has, under certain circumstances, the potential complication of gelation due to the combination of dual functional groups of TMI, high viscosity by different length of side chains, slow initiation by stable tertiary radicals activated from isopropenyl units of TMI, and poor conversion of monomer mixtures becoming grafts. Therefore, to demonstrate successful synthesis of this grafting random copolymers consisting polyvinylchloride of polymer backbone via the grafting “GRAFTING TO” approach without potential side reactions as mentioned above, several batches were carried out and the results are summarized as shown in Table 9. Initially, three small batches of NK54-17, NK68-17, and NK70-17 were prepared with 800 g total volume of reaction and each physical property met the range of specification. Batches 10 times larger of NK56-17, NK58-17, and NK61-17 were prepared and also demonstrated excellent results.

TABLE 9
Synthesis of random grafting copolymers based on polyvinylchloride as a
polymer backbone.

| | | Solid | | | Particle | | | | | |
|---|---|---|---|---|---|---|---|---|---|---|
| Batch | Quantity | Cont. | Acidity | Viscosity | size | Residuals (ppm) | | | | |
| # | (kg) | (%) | (pH) | (cps) | (nm) | MMA | IBOMA | DMAEMA | MEEU | MEK |
| Spec | — | 30-32 | 5.0-6.0 | <300 | <100 | <1000 | <1000 | <500 | <500 | <0.1% |
| NK54-17 | 0.8 | 32.4 | 5.45 | 74 | 62.8 | <10 | 121 | <1 | 152 | 0.06 |
| NK68-17 | 0.8 | 31.5 | 5.25 | 78 | 52.6 | 20 | 43 | 68 | 43 | 0.09 |
| NK70-17 | 0.8 | 30.7 | 5.53 | 30 | 58.3 | 33 | 159 | 227 | 54 | 0.02 |
| NK56-17 | 8.0 | 31.9 | 5.65 | 54 | 68.7 | <10 | 320 | <1 | 179 | 0.07 |
| NK58-17 | 8.0 | 31.4 | 5.67 | 32 | 66.9 | <10 | 229 | 21 | 195 | 0.04 |
| NK61-17 | 8.0 | 30.85 | 5.54 | 50.9 | 60.3 | 13 | 8 | 299 | 118 | 0.05 |

The detailed synthesis procedure and characterizations of random grafting copolymers and their aqueous cationic resins were described using the NK58-17 batch among six batches in Table 9. In general, to synthesize the cationic acrylic resins, polymer backbones of PBA-co-PHEA random copolymer were synthesize via solution random radical polymerization and progressed to the synthesis of the side chain polymers, coupling reaction of the side chain polymers and polymer backbones between isocyanate and hydroxyl groups, neutralization with acids, and finally phase inversion. However, in this case, the synthesis of polymer backbone was not necessary because poly(vinyl chloride-co-vinyl acetate-co-vinyl alcohol) terpolymers (UMOH) with molecular weight of 27,000 g/mol and weight % ratio of vinyl chloride/vinyl acetate/vinyl alcohol=90/4/6 used as a hydroxy-containing polyvinylchloride (commercially available). Also, a kind and quantity of other raw materials used in this batch were showed in Table 10. At first, the NCO functional monomer of TMI generated radicals by AMBN initiators. Side chain random copolymers of PMEEU-co-PMMA-co-PDMAEMA-co-PIBOMA containing TMI at the chain end were synthesized completely via free radical polymerization in MEK using radical activated TMI as an initiator. To boost polymerization and remove remaining monomers mixture, AMBN initiators were charged twice more. After compete synthesis of the side chain polymers, UMOH terpolymers were introduced as a solid powder directly into mixture solution and the reaction was hold until UMOH terpolymer dissolved completely. To start NCO—OH reaction, the first DBTDL T-12 catalyst was added and the second after three hours. The polymer mixture solution became deep yellow gradually during this reaction.

TABLE 10
Synthesis of grafting random copolymers based on UMOH
terpolymers via free radical polymerization based on “GRAFTING
TO” approach at 80° C. and reaction of NCO
with hydroxyl groups at 78° C. under N₂ purging.

| | Raw Materials | CAS# | Quantity (g) | Aliquot |
|---|---|---|---|---|
| 01 | MEK | 73-93-3 | 1401.60 | |
| 02 | TMI | 2094-99-7 | 47.98 | |
| 03 | MEK | 78-93-3 | 100.32 | |
| 04 | AMBN | 13472-08-7 | 50 | Aliquot-1 |
| | MEK | 78-93-3 | 80/20.32 | |
| 05 | MEEU | 86261-90-7 | 50.24 | |
| | MMA | 80-62-6 | 146.08 | |
| | DMAEMA | 2867-47-2 | 390.48 | |
| | IBoMA | 7534-94-3 | 163.60 | |
| 06 | MEK | 78-93-3 | 100.16 | Aliquot-2 |
| 07 | AMBN | 13472-08-7 | 19.99 | Aliquot-3 |
| | MEK | 78-93-3 | 80/20.32 | |
| 08 | AMBN | 13472-08-7 | 19.99 | |
| | MEK | 78-93-3 | 80/20.32 | |
| 09 | MEK | 78-93-3 | 1374.80 | Aliquot-4 |
| 10 | UMOH | 25086-48-0 | 350.24 | |
| 11 | MEK | 78-93-3 | 300.88 | Aliquot-5 |
| 12 | DBTDL (T-12) | 77-58-7 | 1.48 | |
| 13 | MEK | 78-93-3 | 50.15 | Aliquot-6, Aliquot-7 |
| 14 | DBTDL (T-12) | 77-58-7 | 1.0 | |
| 15 | MEK | 78-93-3 | 26.75 | Aliquot-8, Aliquot-9 |

After complete synthesis of the grafting random copolymers, the solution of resulting grafting random copolymers in MEK was neutralized by addition of acetic and lactic acids. For phase inversion from organic solvent of MEK to DI water, a large amount of deionized water was charged and MEK of organic solvent was stripping out. The resulting aqueous cationic resins based on UMOH terpolymers was produced efficiently.

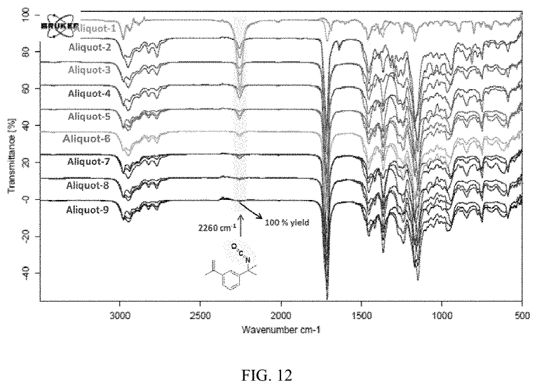

To determine to terminate reactions and to follow synthesis procedure, an aliquot was collected at the end of each step and ATR-FTIR spectra were distributed as shown in FIG. 12. Peak of NCO isocyanate functional units appears at 2260 cm-1 and is very significant to determine the termination time of the reaction. Before addition of DBTDL T-12 catalyst, spectra of NCO peak are sharp and strong from Aliquot-1 to Aliquot-5 but getting smaller since the NCO—HO reaction took place. Finally, these peaks disappeared like Aliquot-9 with 100% conversion yield of monomers. Additionally, the vinyl group of monomers at 1620-1640 cm-1 was reduced as it was polymerized gradually.

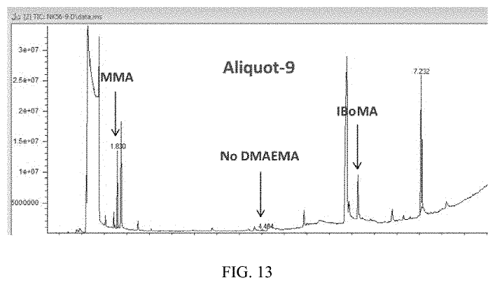

FIG. 13 shows GC/Mass Spectra of each aliquot to measure concentration of residual monomers. The spectra from each aliquot demonstrated conversion of each monomers including DMAEMA, IBOMA, and MMA. Depending on the concentration of residual monomers, the polymerization could be terminated. The results of concentration of residual monomers obtained from GC/Mass was shown in Table 11.

TABLE 11
Residual monomers of each aliquot measured
by GC/Mass spectroscopy from Aliquot-2 to Aliquot-9.

| Raw Materials | Retention time (min) | Aliquot-2 (ppm) | Aliquot-3 (ppm) | Aliquot-4 (ppm) | Aliquot-5 (ppm) |
|---|---|---|---|---|---|
| DMAEMA | 1.858 | 67683 | 27620 | 11176 | 8620 |
| IBoMA | 4.49 | 16845 | 5761 | 4701 | 1418 |
| MMA | 7.2 | 19447 | 8359 | 3123 | 2400 |
| Raw Materials | Retention time (min) | Aliquot-6 (ppm) | Aliquot-7 (ppm) | Aliquot-8 (ppm) | Aliquot-9 (ppm) |
| DMAEMA | 1.858 | 6072 | 0 | 0 | 0 |
| IBoMA | 4.49 | 1565 | 1749 | 1709 | 1320 |
| MMA | 7.2 | 1552 | 1489 | 1573 | 1229 |

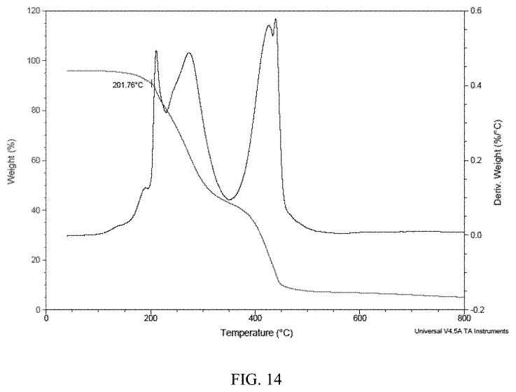

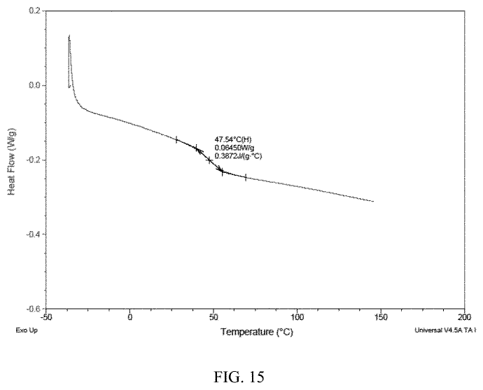

The thermal behaviors of cationic resins produced by batch NK58-18 were measured by thermogravimetric analysis (TGA) as shown in FIG. 14 and by differential scanning calorimetry (DSC) as shown in FIG. 15. To measure decomposition temperature by TGA, a drying film of cationic acrylic resin was prepared at first by drying a solution of the cationic resins in DIO water at 25° C. under reduced pressure (10-1 mmHg) for 24 h and preheated to 120° C. for 15 min in the TGA furnace. Then, the dynamic TGA experiments were carried out from 40 to 800° C. at a heating rate of 10° C./min under nitrogen. The decomposition temperature (T_{d}, 5% weight loss temperature) was 202° C. because the major monomers of vinyl chloride consists to polymer backbone. Glass transition temperature (T_{g}) of polymers also was investigated using differential scanning calorimeter (DSC) by heat-cool-heat cycles from −40 to 100° C. at a rate of 10° C./min under nitrogen. Before the DSC measurement, polymer samples were also dried with same way of TGA samples. The Tg of this random grafting copolymer was 48° C. because this grafting polymer backbone is based on vinyl chloride polymers.

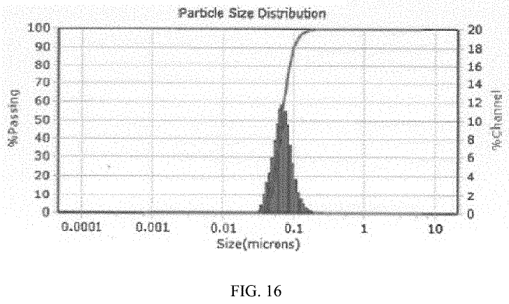

As a result, batch NK56-18 produced excellent aqueous cationic resins based on polyvinylchloride (PVC) completely and the resulting cationic resins exhibited no tailing of particle size distribution (FIG. 16), 31.9% of solid contents, 5.65 of pH, 54 cps of viscosity, 68.7 nm of particle size, and 0.07% of residual MEK. These PVC-based aqueous cationic resins exhibit a higher Tg polymer backbone of UMOH terpolymers so that their viscosity much lower than acrylic based aqueous cationic resins.

Preparation of Aqueous Cationic Resins Based on UMOH Terpolymers Neutralized with Only Acetic Acid.

Four batches—NK42-17, NK45-17, NK48-17, and NK49—were prepared based on UMOH terpolymers at quantities ranging from 0.7 to 6.0 kg. The synthesis of grafting random copolymers was the same as detailed above and the resulting polymers were neutralized with acetic acid only. Next, the phase inversion step and the step of stripping off the MEK were performed. As compared to the aqueous cationic resins neutralized with acetic acid/lactic acid mixture, the viscosity was slightly increased. All batches are summarized in Table 12.

TABLE 12
Preparation of aqueous cationic resin based on
polyvinylchloride as a polymer backbone.

| | | | | | Particle | | | | | |
|---|---|---|---|---|---|---|---|---|---|---|
| Batch | Quantity | NVM | Acidity | Viscosity | size | Residuals (ppm) | | | | |
| # | (kg) | (%) | (pH) | (cps) | (nm) | MMA | IBOMA | DMAEMA | MEEU | MEK |
| Spec | — | 30-32 | 5.0-6.0 | <300 | <100 | <1000 | <1000 | <500 | <500 | <0.1% |
| NK42-17 | 0.7 | 31.4 | 5.36 | 99 | 63.6 | <10 | 229 | 69 | 235 | 0.58 |
| NK45-17 | 3.0 | 33.9 | 5.71 | 86 | 66.3 | <10 | 154 | 3 | 117 | 0.28 |
| NK48-17 | 3.0 | 33.4 | 5.74 | 98 | 65.1 | <10 | 125 | 17 | 117 | 0.52 |
| NK49-17 | 6.0 | 33.3 | 5.89 | 81 | 69.4 | <10 | 213 | 6 | 136 | 0.25 |

Improvement of Producibility by Modifying Reaction Times.

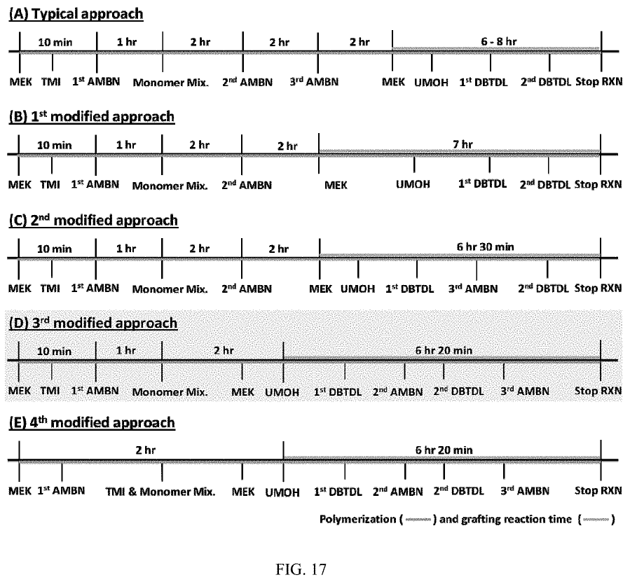

The synthetic approach utilized above for synthesis of grafting random copolymers consisting of UMOH terpolymer polymer backbone and methacrylic polymers as grafts takes from about 13 to about 16 hours of total reaction time depending on the total volume of a batch. Therefore, to improve processability by reducing the total reaction time, four different batches -NK63-17, NK64-17, NK65-17, and NK69-17—were prepared using different approaches. In general, the synthesis of methacrylic polymers as grafts was almost complete before adding the 2^{nd} and 3^{rd} AMBN to eliminate remaining monomers and then the isocyanate-hydroxyl reaction was initiated after the addition of the 3^{rd} AMBN initiator. It was discovered that the best way to reduce the total reaction time was to manipulate the addition order of the 2^{nd} AMBN, 3^{rd} AMBN, and UMOH terpolymers with the DBTDL T-12 catalyst. The different approaches were illustrated briefly as shown in FIG. 17 and the results of each reaction were summarized in Table 13.

TABLE 13
Physical properties of aqueous cationic resins prepared by new approaches for
improvement of processability.

| | | | | | Particle | | | | | |
|---|---|---|---|---|---|---|---|---|---|---|
| Batch# | Quantity | NVM | Acidity | Viscosity | size | Residuals (ppm) | | | | |
| or Lot# | (kg) | (%) | (pH) | (cps) | (nm) | MMA | IBOMA | DMAEMA | MEEU | MEK |
| Spec | — | 30.0 | 5.0-6.0 | <300 | <100 | <1000 | <1000 | <500 | <500 | <0.1% |
| NK63-17 | 0.8 | 31.9 | 5.21 | 81 | 55.5 | 17 | 14 | 233 | 56 | 0.08 |
| NK64-17 | 0.8 | 30.4 | 5.37 | 54 | 53.1 | 15 | 164 | 352 | 43 | 0.03 |
| NK65-17 | 0.8 | 30.2 | 5.53 | 29 | 54.5 | 14 | 233 | 365 | 50 | 0.01 |
| NK66-17 | 0.8 | 30.1 | 5.48 | 27 | 53.6 | 8 | 142 | 381 | 45 | 0.01 |
| NK72-17 | 3.0 | 31.4 | 5.61 | 89 | 60 | 24 | 217 | 354 | 46 | 0.02 |
| NK78-17 | 8.0 | 30.6 | 5.83 | 54 | 68.6 | 35 | 199 | 214 | 41 | 0.7 |
| NK69-17 | 0.8 | 29.6 | 5.18 | 42 | 44.6 | 18 | 89 | 54 | 39 | 0.03 |
| NK71-17 | 0.8 | 28.7 | 5.58 | 34 | 45.7 | 27 | 987 | 416 | 56 | 0.19 |

The first approach to reduce total reaction time as well as manufacturing cost was exemplified via batch NK63-17. The synthetic procedure of FIG. 17B is fairly similar to the prior art procedure exemplified by FIG. 17A, the only difference being that the 3rd addition of AMBN was eliminated and the quantity of AMBN of 2nd addition was increased 1.5 times in this batch. The total reaction time of this method was 12 hours 10 minutes, which is 1-4 hours shorter than the prior art approach. However, the conversion of NCO—OH reaction was 96% obtained from ATR-FTIR spectra area.

The second modified approach employed for batch NK64-17 is depicted in FIG. 17C. In this experiment, the NCO—OH reaction started earlier by addition of UMOH and DBTDL T-12 catalyst before the 3^{rd} addition of AMBN initiator. Generally, this NCO—OH reaction began after almost complete polymerization of the methacrylic monomer mixture by adding the 2^{nd} and 3^{rd} AMBN initiators. This reaction was completed in 11 hours, 40 minutes and the yield was 97% from the ATR-FTIR spectra area. The residuals DMAEMA was 1238 ppm just after complete polymerization (before neutralization) but it became 352 ppm after neutralization and striping out the MEK because some residuals of DMAEMA were likely stripped out with MEK and water. The preparation of aqueous cationic resin was successfully complete using the second modified approach and all properties are within specification as shown in Table 13.

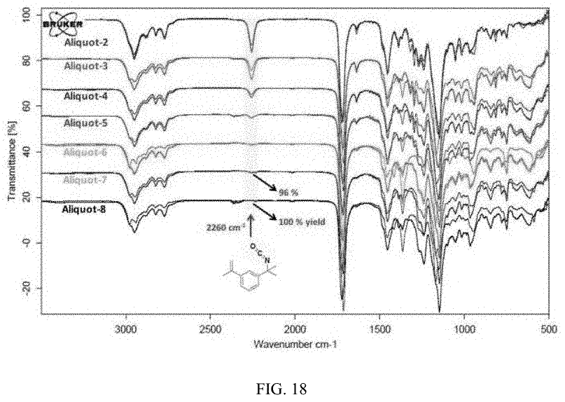

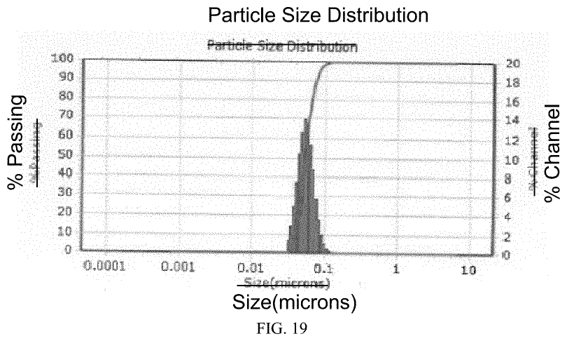

NK65-17 batch via the 3^{rd} modified approach in FIG. 17D was performed to save cost and reaction time by starting the coupling reaction of NCO and OH earlier with addition of UMOH and DBTDL before the addition of the 2^{nd} AMBN initiator, based on the formula in Table 14. The NK65-17 batch was completed with a total reaction time of 9 hours, 15 min, which was much shorter than the typical 13-16 hours of the prior art approach because the reaction of NCO and OH started earlier—i.e., just after the monomer mixture reacted for 2 hours and before the addition of the 2^{nd} AMBN. The residual DMAEMA monomer was 2532 ppm just after complete polymerization (before neutralization) but was 365 ppm after neutralization and phase inversion. The yield of the NCO—OH reaction was 100% from the ATR-FTIR spectra area in FIG. 18 and the particle size distribution was very narrow as shown in FIG. 19.

TABLE 14
Synthesis of grafting random copolymers based on UMOH
terpolymers via free radical polymerization at 80° C. and
reaction of NCO with hydroxyl groups at 78° C. under
N₂ purging via 3^{rd} modified approach.

| | Raw Materials | CAS# | Quantity (g) | Aliquot |
|---|---|---|---|---|
| 01 | MEK | 78-93-3 | 140.16 | |
| 02 | TMI | 2094-99-7 | 4.8 | |
| 03 | MEK | 78-93-3 | 10.3 | |
| 04 | AMBN | 13472-08-7 | 5.0 | |
| | MEK | 78-93-3 | 8.0 | |
| 05 | MEK | 78-93-3 | 2.03 | Aliquot-1 |
| 06 | MEEU | 86261-90-7 | 5.02 | |
| | MMA | 80-62-6 | 14.64 | |
| | DMAEMA | 2867-47-2 | 39.05 | |
| | IBoMA | 7534-94-3 | 16.36 | |
| 07 | MEK | 78-93-3 | 10.02 | Aliquot-2 |
| 08 | MEK | 78-93-3 | 140.02 | |
| 09 | UMOH | 25086-48-0 | 35.02 | |
| 10 | MEK | 78-93-3 | 30.09 | Aliquot-3 |
| 11 | DBTDL (T-12) | 77-58-7 | 0.25 | |
| 12 | MEK | 78-93-3 | 4.91 | Aliquot-4 |
| 13 | AMBN | 13472-08-7 | 2.0 | |
| | MEK | 78-93-3 | 8.0 | |
| 14 | MEK | 78-93-3 | 2.03 | Aliquot-5 |
| 15 | DBTDL (T-12) | 77-58-7 | 0.13 | |
| 16 | MEK | 78-93-3 | 2.68 | Rinse with MEK. |
| 17 | AMBN | 13472-08-7 | 2.0 | |
| | MEK | 78-93-3 | 8.0 | |
| 18 | MEK | 78-93-3 | 2.03 | Aliquot-6, Aliquot-7 |
| | | | | Aliquot-8 |

Batch NK66-17 was prepared to verify the reproducibility of the NK65-17 batch and it was reproduced with 100% conversion yield of NCO—OH reaction and narrow particle size distribution. Also, all physical properties of solid content of 30.0 wt %, pH of 5.48, viscosity of 27 cps, particle size of 53.6 nm, and residue MEK of 0.01% met the desired specification. To scale up these batches of NK65-17 and NK66-17 and to check reproducibility again, NK72-17 batch with 3000 grams of total reaction quantity and more scaling-up batch of NK78-17 with 8000 grams of total reaction quantity were performed respectively. Both aqueous cationic resins produced by scaling-up the NK72-17 and NK78-17 batches demonstrated very similar characteristics and properties relative to those of the smaller batches of NK65-17 and NK66-17.

The 4^{th} modified approach in FIG. 17E was applied to batch NK69-17. For this approach, monomer mixtures and TMI were charged all together into AMBN solution in MEK initially so the NCO—OH reaction started first. The NK69-17 batch was completed with total reaction time of 8 hours and 40 minutes, which is much shorter than the prior art approach and approximately 1 hour reduced total reaction time compared with the NK65-17 batch. Therefore, this approach was the best in terms of minimizing total reaction time. However, product yield of the neutralized aqueous cationic resin was below 30% (29.6% for NK69-17 and 28.7% for NK71-17, respectively). The two batches of NK69-17 and NK71-17 also produced approximately 10-20 nm smaller particle size of 44.6 and 45.7 nm.

Preparation of Aqueous Cationic Resins Based on PVC Polymers Using Different Acids for Neutralization.

As described above, PVC-based aqueous cationic resins were produced basically by neutralization of resulting grafting random copolymers using mixture of glacial acid and lactic acid (14/1 mol/mol). To control the open time of an inkjet ink, several batches were run by manipulating the rate of evaporation of acids and aqueous media using different ratios of acetic acid and lactic acid (15/0, 11/1, 1/14, and 0/15 mol:mol). The NK02-18 batch produced cationic resins by neutralization using acetic acid only of 15/0 mol/mol and these aqueous cationic resins were able to show fast open time by evaporation of water and acetic acid. Cationic resins produced from the NK29-18 batch using acetic acid:lactic acid of 14:3 mol/mol for neutralization could have slightly slower open times than that of the NK02-18 batch. The NK23-18 batch was performed to prepare aqueous cation resins by neutralization with acetic acid:lactic acid of 1:14 mol/mol and it demonstrated highly slower open time than those of the NK02-18 and NK29-18 batches because of the larger quantity of lactic acid. However, the aqueous cationic resins prepared from the NK32-18 batch by neutralization using only lactic acid of 0:15 mol/mol exhibited similar open times to that of NK23-18 because the quantity of lactic acid was slightly higher. Interestingly, as the concentration of lactic acid increased, the viscosity decreased and the pH increased but other physical properties such as solid content, particle size, and residual MEK were similar. Results of characterization were summarized in Table 15.

TABLE 15
Properties of aqueous cationic resins prepared by different conditions of
neutralization.

| | | | | | Particle | | | | | |
|---|---|---|---|---|---|---|---|---|---|---|
| Batch# | Quantity | NVM | Acidity | Viscosity | size | Residuals (ppm) | | | | |
| or Lot# | (kg) | (%) | (pH) | (cps) | (nm) | MMA | IBOMA | DMAEMA | MEEU | MEK |
| Spec | — | 30-32 | 5.0-6.0 | <300 | <100 | <1000 | <1000 | <500 | <500 | <0.1% |
| NK02-18 | 8.0 | 31.0 | 5.7 | 34 | 65 | 9 | 141 | 184 | 35 | 0.05 |
| NK29-18 | 10.0 | 31 | 5.6 | 25 | 67.5 | 21 | 45 | 12 | 49 | 0.06 |
| NK23-18 | 8.0 | 31.3 | 5.5 | 27 | 54.8 | 19 | 156 | 224 | 43 | 0.08 |
| NK32-18 | 8.4 | 31.1 | 5.8 | 17 | 63.7 | 21 | 110 | 117 | 56 | 0.03 |

As the quantity of lactic acid increased, open time is improved appropriately because lactic acid has high boiling point and less volatility so that this acid could make slow drying of aqueous cationic resins. Based on this results, other different types of acids with high boiling point (bp) such as gluconic acid with bp of 417° C., caprylic acid with bp of 239.7° C., and diacid 1550 that is a liquid dicarboxylic acid derived from fatty acids were used for neutralization and good open time. Especially, diacid 1550 used for neutralization produced very high viscous cationic resin solution in water and cationic resins on any substrates were cured through closslinking process by difunctionality of diacid 1550. Therefore, diacid 1550 is able to improve open time by slow drying and cure cationic resins by difunctionality of this acid.

Preparation of Aqueous Cationic Resins Based on Poly(n-butyl methacrylate)-co-poly(2-hydroxyethyl methacrylate) (PBMA-co-PHEMA).

The grafting random copolymers consisting of polybutylacylate-co-poly(2-hydroxyethyl acrylate) (PBA-co-PHEA) of backbones and all methacrylic polymers of grafts are used for preparation of dispersion of transparent yellowish aqueous cationic resin solution in DI water and demonstrated better adhesion properties and elongation than UMOH terpolymer-based prior art copolymers of polyvinylchloride-co-polyvinylacetate-co-polyvinylalcohol at 90/4/6 weight %. In addition, this cationic resin showed water-resistant properties after formation of films by drying aqueous cationic acrylic resin in water and dissolved into organic solvent such as methyl ethyl ketone, tetrahydrofuran, acetone, etc again. However, due to the low glass transition temperature (T_{g}, −56° C.) of PBA polymers in PBA-co-PEHA, these (meth)acrylic grafting random copolymers have 0.7° C. of T_{g} and the formed film with the grafting copolymers, after coating and adhesion, could change morphologies and then make phase separations. This means that the properties of the resulting films can be varied. So, to improve these characteristics, new polymer backbones of poly(n-butyl methacrylate)-co-poly(2-hydroxyethyl methacrylate) (PBMA-co-PHEMA) using PBMA homopolymers with T_{g} of 20° C. instead of PBA polymers were synthesized following typical synthetic formula and procedure as described above. The all (meth)acylate polymer-based aqueous cationic resins containing PBMA-co-PHEMA of polymer backbones with a higher T_{g} of 41.7° C. than that containing PBA-co-PHEA with 0.7° C. of T_{g} demonstrated similar properties of solid contents of 30.42%, pH of 5.4, particle size of 37.2, and residual MEK of 0.09% as shown in Table 16. However, the viscosity of 128 cps in Table 16 was slightly less and/or similar as compared with the viscosity of film formed from aqueous cationic resins based on PBA-co-PHEA. All batches in Table 16 were carried out following same procedures as described in NK05-18 by replacing polymer backbone of PBA-co-PHEA to PBMA-co-PHEMA and by using different quantity of radical initiators AMBN.

The all (meth)acylate polymer-based aqueous cationic resins containing PBMA-co-PHEMA of polymer backbones have over 20° C. higher T_{g} than those of PBA-co-PHEA based cationic resins and other physical properties are demonstrated as shown in Table 16. Especially, the viscosity is much higher as compared with the viscosity of film formed from aqueous cationic resins based on PBA-co-PHEA.

TABLE 16
Results of properties of aqueous cationic resins based on PBMA-co-PHEMA of
polymer backbones.

| | | Solid | | | Particle | | | | | | |
|---|---|---|---|---|---|---|---|---|---|---|---|
| Batch | Quantity | cont. | Acidity | Viscosity | size | T_{g} | Residuals (ppm) | | | | |
| # | (kg) | (%) | (pH) | (cps) | (nm) | (° C.) | MMA | DMAEMA | IBOMA | MEEU | MEK |
| NK82-18 | 1.0 | 30.0 | 5.43 | 591 | 249.4 & | 25.6 | 15 | 22 | 36 | 42 | 0.01 |
| | | | | | 33.9 | | | | | | |
| NK84-18 | 1.0 | 30.2 | 5.66 | 964 | 37.3 | 29.6 | 16 | 26 | 28 | 41 | 0.02 |
| NK02-19 | 1.0 | 30.6 | 5.72 | 902 | 38.7 | 30.7 | 17 | 21 | 33 | 51 | 0.04 |

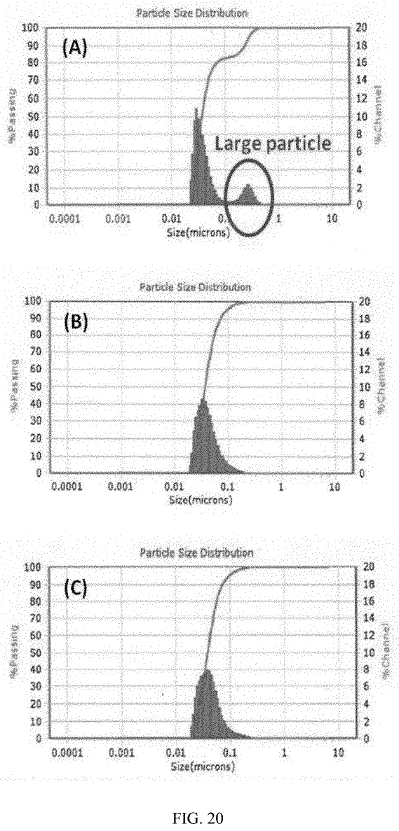

Depending on the quantity of a radical initiator of 2,2′-Azobis (2-methylbutyronitrile) for the synthesis of PBMA-co-PHEMA polymer backbones, the particle sizes and particle size distributions were changed as shown in Table 16 and FIG. 20. The batch of NK82-18 having a weight ratio of monomer to initiator 29.7/1.0 wt %/wt % exhibited bimodal particle size distributions with 33.9 nm (82%) and 249.4 nm (18%). However, the batch of NK84-18 having a monomer to initiator weight ratio of 115.0/1.0 wt %/wt % produced 37.3 nm of small particles and unimodal particle size distributions without large particles over 100 nm. Also, the batch of NK02-19 using monomers to initiator weight ratio of 213.6/1.0 wt %/wt % showed small particle size of 38.7 nm and unimodal particle distributions similarly to those of NK84-18 batch.

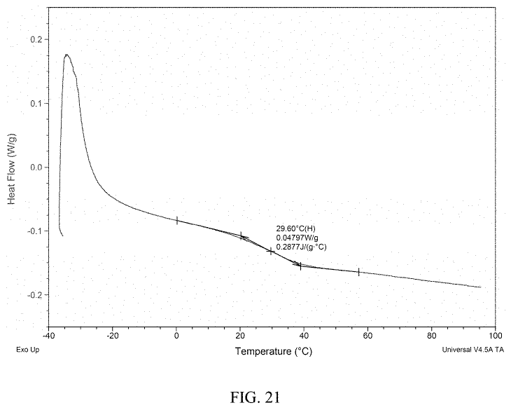

The two batches of NK84-18 and NK02-19 deomonstrated very similar physical properties as shown in Table 16. Particularly, the glass transition temperatures (T_{g}) of two cationic resins produced via the NK84-18 and NK02-19 batches were almost the same with 29.6 and 30.7° C. as shown in FIG. 21. The glass transition temperatures are between those of UMOH PVC based (47.5° C.) and PBA-co-PHEA based cationic resin (T_{g} 0.7° C.).

However, another product prepared by the batch of NK82-18 showed 25.6° C., a slightly lower T_{g} than those of other two batches due to the bimodal particle distribution including 18% large particles.

Preparation of Aqueous Cationic Resins Based on Poly(methyl methacrylate)-co-poly(2-hydroxyethyl methacrylate) (PMMA-co-PHEMA).

To introduce cationic acrylic resins to new applications requiring high thermal properties of high glass transition temperature, a new type of cationic resin with higher T_{g} is needed and was synthesized successfully by adding a high T_{g} monomer of methyl methacrylate as a polymer backbone into formula of all acrylic cationic resin. The complete NCO—OH reaction of TMI-containing polymer backbones of PMMA-co-PHEMA and hydroxyl-containing methacrylic polymer mixtures of the side chains took 1-2 hours faster than the reaction of other cationic acrylic resins. Depending on particle size, the resulting aqueous cationic methacrylic resins with polymer backbones of PMMA-co-PHEMA in deionized water showed transparent or opaque solution.

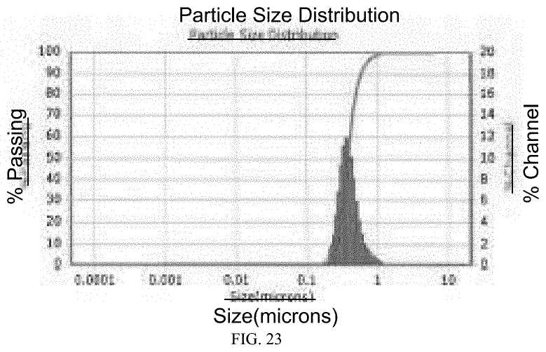

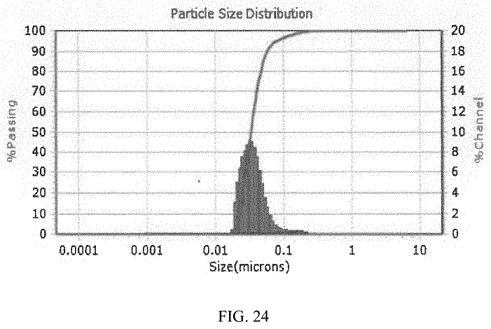

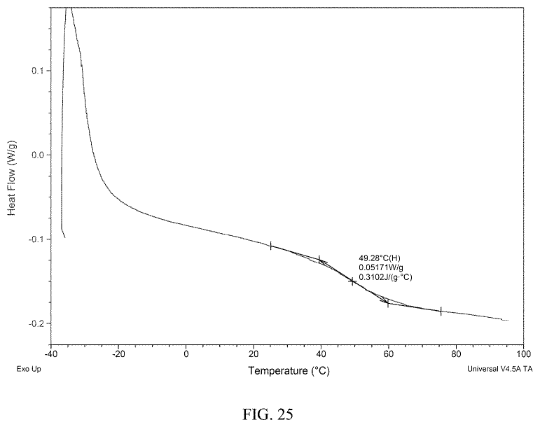

The first batch of NK59-18 using PMMA-co-PHEMA polymer backbone produced very large particles with 376 nm were formed by neutralization with acetic acid and lactic acid (mol ratio of 14 mol/1 mol) followed by phase inversion. This particle size was 5-9 times larger than those of other aqueous cationic resins but particle size distribution was narrow unimodal as shown in FIG. 23. To reduce particle size, the second batch of NK03-19 was performed using 9 times less radical initiator than the quantity used in NK59-18. This batch of NK03-19 also produced much smaller particle size of 33.6 nm in FIG. 24 as the results of cationic resins based on PBMA-co-PHEMA backbone. However, as the particle size gets smaller from 376 (NK59-18) to 33.6 nm (NK03-19), viscosity of aqueous cationic resins becomes two times higher from 279 nm to 584 nm. It was verified that small particles increase viscosity and large particles decrease it. To study same effect of quantity of radical initiator on particle size and its distribution of cationic resins as investigated above with batches based on PBMA-co-PHEMA backbone (Table 16), the third batch of NK04-19 using 1.7 times larger quantity of initiators (0.35 g) for the synthesis of PMMA-co-PHEMA backbone than that of NK03-19 (0.25 g) was conducted. This batch of NK04-19 also produced two particle sizes of 30.5 nm (90 vol %) and 186 nm (10 vol %) and showed bimodal particle size distribution. The viscosity of this batch is 471 cps between 279 (NK59-18) and 584 cps (NK03-18). With the three batches, it was proved obviously that particle size affect viscosity. Especially, the glass transition temperature (T_{g}) of cationic resin film prepared from NK03-19 batch is 49.3° C. and highest among all cationic resins as shown in FIG. 25.

With particle size and viscosity, other physical properties including solid content, potential of hydrogen (pH), viscosity, glass transition temperature (T_{g}), residual monomers, and residual MEK solvent was summarized and shown in Table 17.

TABLE 17
Results of properties of aqueous cationic resins based on PMMA-co-PHEMA of polymer
backbones.

| | | Solid | | | Particle | | | | | | |
|---|---|---|---|---|---|---|---|---|---|---|---|
| Batch | Quantity | cont. | Acidity | Viscosity | size | T_{g} | Residuals (ppm) | | | | |
| # | (kg) | (%) | (pH) | (cps) | (nm) | (° C.) | MMA | DMAEMA | IBOMA | MEEU | MEK |
| Spec | — | 29-31 | 5.0-6.0 | <1000 | <100 | >30 | <1000 | <500 | <1000 | <500 | <0.1% |
| NK59-18 | 1.5 | 30.6 | 5.94 | 279 | 376 | 40.2 | 54 | 81 | 294 | 42 | 0.07 |
| NK03-19 | 1.0 | 31.1 | 5.86 | 584 | 33.8 | 49.3 | 24 | 113 | 27 | 35 | 0.04 |
| NK04-19 | 1.0 | 30.8 | 6.16 | 471 | 30.5, | 38.3 | 28 | 167 | 38 | 39 | 0.02 |
| | | | | | 186.1 | | | | | | |

Preparation of Aqueous Cationic Resins Based on Polyvinyl Butyral.

To synthesize grafting random copolymers based on polyvinyl butyral polymer backbones, the MOWITAL B 30HH of polyvinyl butyral-co-polyvinyl acetate-co-polyvinyl alcohol (PVB-co-PVAC-co-PVA) terpolymers from Kuraray company were used with weight ratio (%) of PVB:PVAC:PVA of 84.9:13.5:1.6, molecular weight of 29000-39000 g/mol, and T_{g} of 63° C. Considering solubility of this terpolymer, tetrahydrofuran (THF) was used as an organic solvent. Except replacement of the organic solvent, all other raw materials were used and the reactions proceeded as described above. Following the same typical synthetic procedure as described above, aqueous cationic resins based on terpolymers of PVB-co-PVAC-co-PVA as backbone polymers and methacrylic polymer grafts were prepared in DI water. The T_{g} of this MOWITAL B 30HH terpolymer (63° C.) is around 20° C. lower than the T_{g} of UMOH terpolymers (81° C.) so that the T_{g} of 37.9° C. of aqueous cationic resins was slightly lower. Other properties observed are summarized in Table 18.

TABLE 18
Results of properties of aqueous cationic resins based on polyvinyl butyral of
polymer backbones.

| | | | | | Particle | | | | | |
|---|---|---|---|---|---|---|---|---|---|---|
| | Quantity | NVM | Acidity | Viscosity | size | Residuals (ppm) | | | | |
| Batch# | (kg) | (%) | (pH) | (cps) | (nm) | MMA | 1BOMA | DMAEMA | MEEU | THF |
| NK08-18 | 0.8 | 30.11 | 5.62 | 171 | 48.6 | 78 | 226 | 372 | 62 | 0.03 |
| NK09-18 | 0.8 | 30.46 | 5.72 | 186 | 46.1 | 86 | 192 | 102 | 53 | 0.06 |
| NK16-18 | 2.0 | 30.92 | 5.65 | 174 | 49.8 | 61 | 204 | 166 | 57 | 0.03 |

Preparation of Aqueous Cationic Resins Based on Polyurethane.

For preparation of grafting random copolymers based on hydroxy-containing polyurethane of polymer backbones, the commercial hydroxyl-containing polyurethane of Alberdingk Aliphatic polyurethane dispersions U6150 was used. Before introducing this polyurethane, dispersion of hydroxy-containing polyurethane was freeze-dried under reduced pressure of 10-1 mmHg after freezing the dispersion. These freeze-dried hydroxy-containing polyurethanes dissolved in THF well so that THF was used as an organic solvent. Except polymer backbones of hydroxy-functionalized polyurethane and a solvent of THF, all other same raw materials used for other batches above containing other monomers, catalysts, acids, and initiators were introduced to polymerization, NCO-TMI reactions, and neutralization. Following the same typical synthetic procedure as described in Table 19, aqueous cationic resins based on polyurethane as backbone polymers and methacrylic polymers of grafts were prepared in DI water nicely. Other properties were summarized in Table 20.

TABLE 19
Synthesis of grafting random copolymers based on commercial
hydroxyl-containing polyurethane (Alberdingk Aliphatic,
U6150) via free radical polymerization at 80° C. and reaction
of NCO with hydroxyl groups at 70° C. under N₂ purging.

| | Raw Materials | CAS# | Quantity (g) |
|---|---|---|---|
| 01 | THF | 109-99-9 | 70.8 |
| 02 | TMI | 2094-99-7 | 2.4 |
| 03 | THF | 109-99-9 | 5.15 |
| 04 | AMBN | 13472-08-7 | 2.5 |
| | THF | 109-99-9 | 4.0 |
| 05 | THF | 109-99-9 | 1.02 |
| 06 | MEEU | 86261-90-7 | 2.51 |
| | MMA | 80-62-5 | 7.32 |
| | DMAEMA | 2867-47-2 | 19.53 |
| | IBoMA | 7534-94-3 | 8.18 |
| 07 | THF | 109-99-9 | 5.01 |
| 08 | THF | 109-99-9 | 70.01 |
| 09 | U6150 | 108-01-0 | 17.51 |
| 10 | THF | 109-99-9 | 15.05 |
| 11 | DBTDL (T-12) | 77-58-7 | 0.13 |
| 12 | THF | 109-99-9 | 2.46 |
| 13 | AMBN | 13472-08-7 | 1.0 |
| | THF | 109-99-9 | 4.0 |
| 14 | THF | 109-99-9 | 1.02 |
| 15 | DBTDL (T-12) | 77-58-7 | 0.07 |
| 16 | THF | 109-99-9 | 1.34 |
| 17 | AMBN | 13472-08-7 | 1.0 |
| | THF | 109-99-9 | 4.0 |
| 18 | THF | 109-99-9 | 1.02 |

TABLE 20
Results of properties of aqueous cationic resins based on polyurethane of
polymer backbones.

| | | | | | Particle | | | | | |
|---|---|---|---|---|---|---|---|---|---|---|
| Batch | Quantity | NVM | Acidity | Viscosity | size | Residuals (ppm) | | | | |
| # | (kg) | (%) | (pH) | (cps) | (nm) | MMA | IBROMA | DMAEMA | MEEU | THF |
| NK42-18 | 1.0 | 31.3 | 5.91 | 513 | 88.6 | 19 | 221 | 316 | 47 | 0.05 |

Synthesis of Grafting Random Copolymers Based on other Hydroxyl Functionalized Polymers and Their Aqueous Cationic Resins.

As it is addressed in detail that the above hydroxy-containing polymers could be used for synthesis of grafting polymers and preparation of aqueous cationic resins including PBA-co-PHEA, UMOH terpolymer, PBMA-co-PHEMA, PMMA-co-PHEMA, hydroxy-containing polyurethane, MOWITAL B 30HH of PVB-co-PVAC-co-PVA terpolymers, all polymers containing hydroxy units in the polymer chains as well as at end of chains can be used as polymer backbone for synthesis of grafting random copolymers and preparation of aqueous cationic resins. These kinds of polymers include polyphenol, polyvinyl alcohol, hydroxyl silicone polymers and their copolymers with other polymers such as polyphenol-co-polystyrene, polyphenol-co-polyacrylonitril, polyethylene-co-polyvinyl alcohol, poly hydroxy-siloxane-co-polymethacrylate, etc.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

1. A graft copolymer comprising:
(a) a hydrophobic functional polymeric backbone, wherein the backbone comprises (i) an acrylate polymer, an alkylacrylate polymer, or both an acrylate polymer and an alkylacrylate polymer, wherein the backbone has an average molecular weight (M_{N}) of from about 3,000 to about 100,000; and
(b) a plurality of hydrophilic polymeric side chains attached to the hydrophobic functional polymeric backbone, wherein the hydrophilic polymeric side chains comprise a polymerization product of at least one polymerizable unsaturated monomer and a polymerizable amine-containing unsaturated monomer.

2. The graft copolymer of claim 1 wherein the hydrophobic functional polymeric backbone comprises the acrylate polymer.

3. The graft copolymer of claim 1 wherein the hydrophobic functional polymeric backbone comprises the alkylacrylate polymer.

4. The graft copolymer of claim 1 wherein the hydrophobic functional polymeric backbone comprises the acrylate polymer and the alkylacrylate polymer.

5. The graft copolymer of claim 3, wherein the alkylacrylate polymer is a polymethacrylate.

6. The graft copolymer of claim 3, wherein the alkylacrylate polymer is selected from the group consisting of polybutyl acrylate, polyethyl hexyl acrylate, polyethyl acrylate, polymethyl methacrylate, and combinations of two or more thereof.

7. The graft copolymer of claim 1, wherein the polymerizable unsaturated monomer has a structure represented by Formula I:
CH₂═C(R²)—X—Y—R¹ (Formula 1)
wherein
—R² is H, halogen, or C₁ to C₃ alkyl group;
—X— is a bond, —CO—O—, or —O—CO—;
—Y— is a bond, or a C₁ to C₂₂ bridging alkyl group optionally substituted with one or more C₁ to C₆ alkyl groups; and
—R¹ is
(1) H, halide, —OH, or —CN;
(2) a C₃ to C₈ cycloalkyl group that is optionally substituted with one or more linear or branched C₁ to C₆ alkyl group;
(3) a C₃ to C₈ heterocycloalkyl group comprising one or more heteroatoms, wherein the heteroatom is a chalcogen;
(4) a C₇ to C₁₅ bicycloalkyl group that is optionally substituted with one or more halogens, or linear or branched C₁ to C₆ alkanes;
(5) a C₆ to C₁₄ aryl group that is optionally substituted with one or more groups selected from the group consisting of a halogen, a linear or branched C₁ to C₆ alkane, and C₁ to C₃ alkyloxy;
(6) SiR³₃, wherein R³ is C₁ to C₃ alkyl group;
(7) polyethylene glycol, polypropylene glycol, or a copolymer thereof, terminated with —OH or —OMe;
(8) —CZ═CH₂, wherein Z is H or halogen; and
—CO—OH.

8. The graft copolymer of claim 7, wherein
—R² is H;
—X— is —CO—O—;
—Y— is a bond, or a C₁ to C₂₂ bridging alkyl group optionally substituted with one or more C₁ to C₆ alkyl groups; and
—R¹ is
(7) H or —OH;
(8) a C₃ to C₈ cycloalkyl group that is optionally substituted with one or more linear or branched C₁ to C₆ alkyl group;
(9) a C₃ to C₈ heterocycloalkyl group comprising one or more heteroatoms, wherein the heteroatom is a chalcogen;
(10) a C₇ to C₁₅ bicycloalkyl group that is optionally substituted with one or more halogens, or linear or branched C₁ to C₆ alkanes;
(11) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

9. The graft copolymer of claim 7, wherein —Y— is a bond, or a C₁ to C₂₂ bridging alkyl group optionally substituted with one or more C₁ to C₆ alkyl groups; and
—R¹ is
(7) H or —OH;
(8) a C₃ to C₈ cycloalkyl group that is optionally substituted with one or more linear or branched C₁ to C₆ alkyl group;
(9) a C₃ to C₈ heterocycloalkyl group comprising one or more heteroatoms, wherein the heteroatom is a chalcogen;
(10) a C₇ to C₁₅ bicycloalkyl group that is optionally substituted with one or more halogens, or linear or branched C₁ to C₆ alkanes;
(11) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

10. The graft copolymer of claim 7, wherein the polymerizable unsaturated monomer represented by Formula I is selected from the group consisting of 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof.

11. The graft copolymer of claim 1, wherein the polymerizable unsaturated monomer is an alkyl acrylate monomer, CH₂═C(R²)—X—Y—R¹, wherein
—R² is C₁ to C₃ alkyl;
—X— is —CO—O—;
—Y— is a bond, or a C₁ to C₂₂ bridging alkyl group optionally substituted with one or more C₁ to C₆ alkyl groups; and
—R¹ is
(9) H;
(10) a C₃ to C₈ cycloalkyl group that is optionally substituted with one or more linear or branched C₁ to C₆ alkyl group;
(11) a C₃ to C₈ heterocycloalkyl group comprising one or more heteroatoms, wherein the heteroatom is a chalcogen;
(12) a C₇ to C₁₅ bicycloalkyl group that is optionally substituted with one or more halogens, or linear or branched C₁ to C₆ alkanes;
(13) a C₆ to C₁₄ aryl group that is optionally substituted with one or more groups selected from the group consisting of a halogen, a linear or branched C₁ to C₆ alkane, and C₁ to C₃ alkyloxy;
(14) SiR³₃, wherein R³ is C₁ to C₃ alkyl group;
(15) polyethylene glycol, polypropylene glycol, or a copolymer thereof, terminated with OH or OMe; or
(16) —CZ═CH₂, wherein Z is H or halogen.

12. The graft copolymer of claim 11, wherein
—R² is C₁ alkyl;
—X— is —CO—O—;
—Y— is a bond, or a C₁ to C₂₂ bridging alkyl group optionally substituted with one or more C₁ to C₆ alkyl groups; and
—R¹ is
(9) H;
(10) a C₃ to C₈ cycloalkyl group that is optionally substituted with one or more linear or branched C₁ to C₆ alkyl group;
(11) a C₃ to C₈ heterocycloalkyl group comprising one or more heteroatoms, wherein the heteroatom is a chalcogen;
(12) a C₇ to C₁₅ bicycloalkyl group that is optionally substituted with one or more halogens, or linear or branched C₁ to C₆ alkanes;
(13) a C₆ to C₁₄ aryl group that is optionally substituted with one or more groups selected from the group consisting of a halogen, a linear or branched C₁ to C₆ alkane, and C₁ to C₃ alkyloxy;
(14) SiR³₃, wherein R³ is C₁ to C₃ alkyl group;
(15) polyethylene glycol, polypropylene glycol, or a copolymer thereof, terminated with OH or OMe; or
—CZ═CH₂, wherein Z is H or halogen.

13. The graft copolymer of claim 7, wherein the polymerizable unsaturated monomer represented by Formula I is selected from the group consisting of methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof.

14. The graft copolymer of claim 1, wherein the polymerizable unsaturated monomer is at least one aromatic vinyl monomer represented by the formula CH₂═C(R²)—R¹,
wherein
—R² is H or C₁ to C₃ alkyl group;
—R¹ is a C₆ to C₁₄ aryl group that is optionally substituted with one or more groups selected from the group consisting of a halogen, a linear or branched C₁ to C₆ alkane, and C₁ to C₃ alkyloxy.

15. The graft copolymer of claim 14, wherein the at least one aromatic vinyl monomer is selected from the group consisting of styrene, alpha-methylstyrene, vinyl toluene, 4-t-butylstyrene, chlorostyrene, vinylanisole, vinyl naphthalene, and mixtures thereof.

16. The graft copolymer of claim 1, wherein the polymerizable unsaturated monomer is at least one vinyl ester monomer represented by the formula
CH₂═CH—O—CO—Y—R¹,
wherein
—Y— is a bond, or a C₁ to C₂₂ bridging alkyl group optionally substituted with one or more C₁ to C₆ alkyl groups; and
—R¹ is
(9) H, halide, —OH, or —CN;
(10) a C₃ to C₈ cycloalkyl group that is optionally substituted with one or more linear or branched C₁ to C₆ alkyl group;
(11) a C₃ to C₈ heterocycloalkyl group comprising one or more heteroatoms, wherein the heteroatom is a chalcogen;
(12) a C₇ to C₁₅ bicycloalkyl group that is optionally substituted with one or more halogens, or linear or branched C₁ to C₆ alkanes;
(13) a C₆ to C₁₄ aryl group that is optionally substituted with one or more groups selected from the group consisting of a halogen, a linear or branched C₁ to C₆ alkane, and C₁ to C₃ alkyloxy;
(14) SiR³₃, wherein R³ is C₁ to C₃ alkyl group;
(15) polyethylene glycol, polypropylene glycol, or a copolymer thereof, terminated with —OH or —OMe; or
—CZ═CH₂, wherein Z is H or halogen.

17. The graft copolymer of claim 16, wherein the at least one vinyl ester monomer is vinyl acetate.

18. The graft copolymer of claim 1, wherein the polymerizable unsaturated monomer is at least one olefin monomer represented by the formula
CH₂═C(R²)—Y—R¹,
wherein
—R² is H, or C₁ to C₃ alkyl group;
—Y— is a bond, or a C₁ to C₂₂ bridging alkyl group optionally substituted with one or more C₁ to C₆ alkyl groups; and
—R is H.

19. The graft copolymer of claim 18, wherein the at least one olefin monomer is selected from the group consisting of ethylene, propylene, and mixtures thereof.

20. The graft copolymer of claim 1, wherein the polymerizable unsaturated monomer is at least one diene monomer(s) is represented by the formula
CH₂═CH—Y—R¹,
wherein
—Y— is a bond, or a C₁ to C₂₂ bridging alkyl group optionally substituted with one or more C₁ to C₆ alkyl groups; and
—R¹ is —CZ═CH₂, wherein Z is H or halogen.

21. The graft copolymer of claim 1, wherein the polymerizable amine-containing unsaturated monomer is selected from the group consisting of an amine-containing acrylate, an amine-containing methacrylate, an acrylamide, a methacrylamide, an amine-containing vinyl monomer, and mixtures thereof.

22. The graft copolymer of claim 1, wherein the polymerizable amine-containing unsaturated monomer has a structure represented by Formula 2:
CH₂═C(Rⁿ²)—Xⁿ—Yⁿ—Rⁿ¹ (Formula 2)
wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and
—Rⁿ¹ is
(8) H;
(9) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(10) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(11) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(12) a C₆ to C₁₄ aryl group further substituted with an amine-containing group;
(13) a C₁ to C₈ alkyl group substituted with a plurality of aryl groups; or
(14) polyethylene glycol, polypropylene glycol, or a copolymer thereof, terminated with —OH or —OMe; and
wherein —Xⁿ— or —Rⁿ¹ or both comprise nitrogen.

23. The graft copolymer of claim 1, wherein the polymerizable amine-containing unsaturated monomer is an amine-containing acrylate monomer having a structure represented by the formula
CH₂═CH—CO—O—Yⁿ—Rⁿ¹
wherein
—Yⁿ— is a bond, or a C₁ to C₁₈ bridging alkyl group optionally substituted with one or more C₁ to C₆ alkyl groups; and
—Rⁿ¹ is
(9) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(10) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(11) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
a C₆ to C₁₄ aryl group further substituted with an amine-containing group.

24. The graft copolymer of claim 23, wherein the polymerizable amine-containing acrylate is selected from the group consisting of t-butylaminoethyl acrylate, dimethylaminomethyl acrylate, diethylaminoethyl acrylate, oxazolidinyl ethyl acrylate, aminoethyl acrylate, 4-(beta-acryloxyethyl)-pyridine, 2-(4-pyridyl)-ethyl acrylate, and mixtures thereof.

25. The graft copolymer of claim 1, wherein the polymerizable amine-containing unsaturated monomer is an amine-containing methacrylate monomer having a structure represented by the formula
CH₂═C(CH₃)—CO—O—Yⁿ—Rⁿ¹,
wherein
—Yⁿ— is a bond, or a C₁ to C₁₈ bridging alkyl group optionally substituted with one or more C₁ to C₆ alkyl groups; and
—Rⁿ¹ is
(12) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(13) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(14) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; or
a C₆ to C₁₄ aryl group further substituted with an amine-containing group.

26. The graft copolymer of claim 25, wherein the amine-containing methacrylate monomer is selected from the group consisting of 2-aminoethyl methacrylate, t-butylaminoethyl methacrylate, 2-(diethylamino)ethyl methacrylate, dimethylaminomethyl methacrylate, diethylaminoethyl methacrylate, 2-dimethylaminoethyl methacrylate, DMAEMA, oxazolidinyl ethylmethacrylate, aminoethyl methacrylate, diethylaminohexyl methacrylate, 3-dimethylamino-2,2-dimethyl-propyl methacrylate, methacrylate of N-hydroxyethyl-2,4,4-trimethylpyrrolidine, 1-dimethylamino-2-propyl methacrylate, beta-morpholinoethyl methacrylate, 3-(4-pyridyl)-propyl methacrylate, 1-(4-pyridyl)-ethyl methacrylate, 1-(2-methacryloyloxyethyl)-2-imidazolidinone, Norsocryl 102, 3-(beta-methacryloxyethyl)-pyridine, 3-methacryloxypyridine, oxazolidinyl ethyl methacrylate, and mixtures thereof.

27. The graft copolymer of claim 26, wherein the amine-containing methacrylate monomer is selected from the group consisting of t-butylaminoethyl methacrylate, 2-dimethylaminoethyl methacrylate, DMAEMA, and 1-(2-methacryloyloxyethyl)-2-imidazolidinone.

28. The graft copolymer of claim 1, wherein the polymerizable amine-containing unsaturated monomer is an acrylamide having a structure represented by the formula
CH₂═CH—Xⁿ—Yⁿ—Rⁿ¹,
wherein
—Xⁿ— is —CO—NH—, or —CO—;
—Yⁿ— is a bond, or a C₁ to C₁₈ bridging alkyl group optionally substituted with one or more C₁ to C₆ alkyl groups; and
—R¹ is
(8) H;
(9) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(10) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(11) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(12) a C₆ to C₁₄ aryl group further substituted with an amine-containing group;
(13) a C₁ to C₈ alkyl group substituted with a plurality of aryl groups; or
(14) polyethylene glycol, polypropylene glycol, or a copolymer thereof, terminated with —OH or —OMe; and
provided that when —Xⁿ— is —CO—, then —X— is a bond and —Rⁿ is NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups.

29. The graft copolymer of claim 28, wherein the acrylamide is selected from the group consisting of N,N-dimethylacrylamide, NNDMA, N-acryloylamido-ethoxyethanol, N-t-butylacrylamide, N-diphenylmethyl acrylamide, and N-(beta-dimethylamino)ethyl acrylamide.

30. The graft copolymer of claim 29, wherein the acrylamide is selected from the group consisting of N,N-dimethylacrylamide, NNDMA, and N-(beta-dimethylamino)ethyl acrylamide.

31. The graft copolymer of claim 30, wherein the acrylamide is selected from the group consisting of N,N-dimethylacrylamide and NNDMA.

32. The graft copolymer of claim 1, wherein the polymerizable amine-containing unsaturated monomer is a methacrylamide having a structure represented by the formula
CH₂═C(CH₃)—Xⁿ—Yⁿ—Rⁿ¹
wherein
Xⁿ— is —CO—NH—, or —CO—;
—Yⁿ— is a bond, or a C₁ to C₁₈ bridging alkyl group optionally substituted with one or more C₁ to C₆ alkyl groups; and
—Rⁿ¹ is
(8) H;
(9) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(10) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(11) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(12) a C₆ to C₁₄ aryl group further substituted with an amine-containing group;
(13) a C₁ to C₈ alkyl group substituted with a plurality of aryl groups; or
(14) polyethylene glycol, polypropylene glycol, or a copolymer thereof, terminated with —OH or —OMe; and
provided that when —Xⁿ— is —CO—, then —X— is a bond and —Rⁿ¹ is (2).

33. The graft copolymer of claim 32, wherein the methacrylamide is selected from the group consisting of N-(3-dimethylaminopropyl) methacrylamide, and N-(beta-dimethylamino)ethyl methacrylamide.

34. The graft copolymer of claim 1, wherein the polymerizable amine-containing unsaturated monomer is an amine-containing vinyl monomer having a structure represented by the formula
CH₂═CH—Xⁿ—Yⁿ—Rⁿ¹,
wherein
—Xⁿ— is a bond, —O—, or —S—;
—Yⁿ— is a bond, or a C₁ to C₁₈ bridging alkyl group optionally substituted with one or more C₁ to C₆ alkyl groups; and
—R¹ is
(5) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(6) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(7) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group; and
a C₆ to C₁₄ aryl group further substituted with an amine-containing group.

35. An aqueous mixture of graft copolymer of claim 1.

36. The aqueous mixture of claim 35, wherein the aqueous mixture comprises a colloidal dispersion suitable for use in preparation of a water based jet ink vehicle, wherein the particle size of more than 60% of particles of said dispersion is less than 1000 nanometers.

37. The aqueous mixture of claim 36, wherein the particle size of more than 80% of particles in said dispersion is less than 750 nanometers.

38. The aqueous mixture of claim 37, wherein the particle size of more than 90% of particles in said dispersion is less than 500 nanometers.

39. The aqueous mixture of claim 36, wherein the dispersion is prepared without the use of a surfactant.

40. A liquid ink comprising more than 50 weight percent of water, the graft copolymer of claim 1, and a pigment or a dye.

41. The liquid ink of claim 40, wherein the ink further comprises a co-solvent.

42. The liquid ink of claim 41, wherein the co-solvent is water-miscible.

43. The liquid ink of claim 42, wherein the water-miscible co-solvent is selected from the group consisting of propylene glycol, 2-propanol, 1,2-hexanediol, propylene glycol methyl ether, dipropylene glycol methyl ether, diethylene glycol, diethylene dimethyl ether, diethylene glycol diethyl ether, and methyl pyrrolidone.

44. The liquid ink of claim 42, wherein the liquid ink further comprises additives selected from the group consisting of a wetting agent, a surfactant, a UV absorber, a defoamer, and a biocide.

45. The liquid ink of claim 41 wherein the co-solvent is not water miscible and may be absorbed into a hydrophobic portion of the copolymer.

46. The liquid ink of claim 40 wherein the liquid ink is a jet ink.

47. A process for making a graft cationic copolymer, the process comprising:
a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups;
b) separately reacting in the presence of a solvent (i) at least one unsaturated monomer having a structure represented by Formula I:
CH₂═C(R²)—X—Y—R¹ (Formula 1)
wherein
—R² is H, halogen, or C₁ to C₃ alkyl group;
—X— is a bond, —CO—O—, or —O—CO—;
—Y— is a bond, or a C₁ to C₂₂ bridging alkyl group optionally substituted with one or more C₁ to C₆ alkyl groups; and
—R¹ is
(19) H, halide, —OH, or —CN;
(20) a C₃ to C₈ cycloalkyl group that is optionally substituted with one or more linear or branched C₁ to C₆ alkyl group;
(21) a C₃ to C₈ heterocycloalkyl group comprising one or more heteroatoms, wherein the heteroatom is a chalcogen;
(22) a C₇ to C₁₅ bicycloalkyl group that is optionally substituted with one or more halogens, or linear or branched C₁ to C₆ alkanes;
(23) a C₆ to C₁₄ aryl group that is optionally substituted with one or more groups selected from the group consisting of a halogen, a linear or branched C₁ to C₆ alkane, and C₁ to C₃ alkyloxy;
(24) SiR³₃, wherein R³ is C₁ to C₃ alkyl group;
(25) polyethylene glycol, polypropylene glycol, or a copolymer thereof, terminated with —OH or —OMe;
(26) —CZ═CH₂, wherein Z is H or halogen; and
(27) —CO—OH,
with (ii) a polymerizable amine-containing unsaturated monomer having a structure represented by Formula 2:
CH₂═C(Rⁿ²)—Xⁿ—Yⁿ—Rⁿ¹ (Formula 2)
wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and
—Rⁿ¹ is
(13) H;
(14) NRⁿ³Rⁿ, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(15) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(16) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(17) a C₆ to C₁₄ aryl group further substituted with an amine-containing group;
(18) a C₁ to C₈ alkyl group substituted with a plurality of aryl groups; or
(19) polyethylene glycol, polypropylene glycol, or a copolymer thereof, terminated with —OH or —OMe; and
wherein —Xⁿ— or —Rⁿ¹ or both comprise nitrogen,
wherein the at least one unsaturated monomer having a structure represented by Formula I and the polymerizable amine-containing unsaturated monomer having a structure represented by Formula 2 are reacted in the presence of a hybridizing compound to form a second polymer composition, wherein the hybridizing compound comprises a functional group selected from the group consisting of an isocyanate group, an amino group, an epoxy group, a carboxylic acid group, and an acyl halide group;
c) reacting the first polymer composition and the second polymer composition in the presence of a solvent such that the functional group of the second polymer composition reacts with the hydroxyl groups of the first polymer composition to form randomly graft side chains on the first polymer composition to form a graft coploymer; and
d) adding an acid to the graft coploymer in the presence of water to form a cationic graft coploymer.

48. The process of claim 47 wherein the acrylate monomer is reacted in step a) and the acrylate monomer is represented by Formula (A)
CH₂═C(R²)—X—Y—R¹ (A)
wherein
—R² is H;
—X— is —CO—O—;
—Y— is a bond, or a C₁ to C₂₂ bridging alkyl group optionally substituted with one or more C₁ to C₆ alkyl groups; and
—R¹ is
(7) H or —OH;
(8) a C₃ to C₈ cycloalkyl group that is optionally substituted with one or more linear or branched C₁ to C₆ alkyl group;
(9) a C₃ to C₈ heterocycloalkyl group comprising one or more heteroatoms, wherein the heteroatom is a chalcogen;
(10) a C₇ to C₁₅ bicycloalkyl group that is optionally substituted with one or more halogens, or linear or branched C₁ to C₆ alkanes;
(11) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

49. The process of claim 47 wherein the acrylate monomer is reacted in step a) and the acrylate monomer is represented by Formula (B):
CH₂═CH—CO—O—Y—R¹ (B)
wherein
—Y— is a bond, or a C₁ to C₂₂ bridging alkyl group optionally substituted with one or more C₁ to C₆ alkyl groups; and
—R¹ is
(7) H or —OH;
(8) a C₃ to C₈ cycloalkyl group that is optionally substituted with one or more linear or branched C₁ to C₆ alkyl group;
(9) a C₃ to C₈ heterocycloalkyl group comprising one or more heteroatoms, wherein the heteroatom is a chalcogen;
(10) a C₇ to C₁₅ bicycloalkyl group that is optionally substituted with one or more halogens, or linear or branched C₁ to C₆ alkanes;
(11) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

50. The process of claim 47 wherein the acrylate monomer is reacted in step a) and the acrylate monomer is selected from the group consisting of 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof.

51. The process of claim 50 wherein the acrylate monomer is selected from the group consisting of 2-hydroxylethyl acrylate, ethyl acrylate, and a mixture thereof.

52. The process of claim 47 wherein the alkyl acrylate monomer is reacted in step a) and the alkyl acrylate monomer is represented by the structure of Formula (C):
CH₂═C(R²)—X—Y—R¹ (C)
wherein
—R² is C₁ to C₃ alkyl;
—X— is —CO—O—;
—Y— is a bond, or a C₁ to C₂₂ bridging alkyl group optionally substituted with one or more C₁ to C₆ alkyl groups; and
—R¹ is
(9) H;
(10) a C₃ to C₈ cycloalkyl group that is optionally substituted with one or more linear or branched C₁ to C₆ alkyl group;
(11) a C₃ to C₈ heterocycloalkyl group comprising one or more heteroatoms, wherein the heteroatom is a chalcogen;
(12) a C₇ to C₁₅ bicycloalkyl group that is optionally substituted with one or more halogens, or linear or branched C₁ to C₆ alkanes;
(13) a C₆ to C₁₄ aryl group that is optionally substituted with one or more groups selected from the group consisting of a halogen, a linear or branched C₁ to C₆ alkane, and C₁ to C₃ alkyloxy;
(14) SiR³₃, wherein R³ is C₁ to C₃ alkyl group;
(15) polyethylene glycol, polypropylene glycol, or a copolymer thereof, terminated with OH or OMe; or
—CZ═CH₂, wherein Z is H or halogen.

53. The process of claim 47 wherein the methacrylate monomer is reacted in step a) and the methacrylate monomer is represented by the structure of Formula (D):
CH₂═C(R²)—X—Y—R¹ (D)
wherein
—R² is C₁ alkyl;
—X— is —CO—O—;
—Y— is a bond, or a C₁ to C₂₂ bridging alkyl group optionally substituted with one or more C₁ to C₆ alkyl groups; and
—R¹ is
(9) H;
(10) a C₃ to C₈ cycloalkyl group that is optionally substituted with one or more linear or branched C₁ to C₆ alkyl group;
(11) a C₃ to C₈ heterocycloalkyl group comprising one or more heteroatoms, wherein the heteroatom is a chalcogen;
(12) a C₇ to C₁₅ bicycloalkyl group that is optionally substituted with one or more halogens, or linear or branched C₁ to C₆ alkanes;
(13) a C₆ to C₁₄ aryl group that is optionally substituted with one or more groups selected from the group consisting of a halogen, a linear or branched C₁ to C₆ alkane, and C₁ to C₃ alkyloxy;
(14) SiR³₃, wherein R³ is C₁ to C₃ alkyl group;
(15) polyethylene glycol, polypropylene glycol, or a copolymer thereof, terminated with OH or OMe; or
(16) —CZ═CH₂, wherein Z is H or halogen.

54. The process of claim 53 wherein the methacrylate monomer is selected from the group consisting of methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof.

55. The process of claim 54 wherein the methacrylate monomer is selected from the group consisting of methyl 2-methacrylate, behenyl methacrylate, and a mixture thereof.

56. The process of claim 53 wherein the methacrylate monomer comprises a co-polymer of polybutylacrylate and poly(2-hydroxyethyl acrylate).

57. A graft cationic copolymer prepared by a process comprising:
a) reacting at least one unsaturated monomer selected from the group consisting of an acrylate monomer, an alkyl acrylate monomer, and a mixture thereof in the presence of a solvent to form a first polymer composition, wherein at least one of the unsaturated monomers comprises hydroxyl groups;
b) separately reacting in the presence of a solvent (i) at least one unsaturated monomer having a structure represented by Formula I:
CH₂═C(R²)—X—Y—R¹ (Formula 1)
wherein
—R² is H, halogen, or C₁ to C₃ alkyl group;
—X— is a bond, —CO—O—, or —O—CO—;
—Y— is a bond, or a C₁ to C₂₂ bridging alkyl group optionally substituted with one or more C₁ to C₆ alkyl groups; and
—R is
(28) H, halide, —OH, or —CN;
(29) a C₃ to C₈ cycloalkyl group that is optionally substituted with one or more linear or branched C₁ to C₆ alkyl group;
(30) a C₃ to C₈ heterocycloalkyl group comprising one or more heteroatoms, wherein the heteroatom is a chalcogen;
(31) a C₇ to C₁₅ bicycloalkyl group that is optionally substituted with one or more halogens, or linear or branched C₁ to C₆ alkanes;
(32) a C₆ to C₁₄ aryl group that is optionally substituted with one or more groups selected from the group consisting of a halogen, a linear or branched C₁ to C₆ alkane, and C₁ to C₃ alkyloxy;
(33) SiR³₃, wherein R³ is C₁ to C₃ alkyl group;
(34) polyethylene glycol, polypropylene glycol, or a copolymer thereof, terminated with —OH or —OMe;
(35) —CZ═CH₂, wherein Z is H or halogen; and
(36) —CO—OH,
with (ii) a polymerizable amine-containing unsaturated monomer having a structure represented by Formula 2:
CH₂═C(Rⁿ²)—Xⁿ—Yⁿ—Rⁿ¹ (Formula 2)
wherein
—Rⁿ² is H, halogen, or C₁ to C₃ alkyl group;
—Xⁿ— is a bond, —CO—O—, —CO—NH—, —CO—, —O—, or —S—;
—Yⁿ— is a bond, or a C₁ to C₁₈ bridging alkyl group optionally substituted with one or more C₁ to C₆ alkyl groups; and
—Rⁿ¹ is
(20) H;
(21) NRⁿ³Rⁿ⁴, wherein Rⁿ³ and Rⁿ⁴ are each independently selected from the group consisting of H, a C₁ to C₁₂ linear or branched alkyl group, a C₁ to C₁₂ linear or branched alkylene group, a C₃ to C₈ cycloalkyl group, and C₁ to C₁₂ linear or branched alkyl group substituted with one or more hydroxyl groups;
(22) a C₃ to C₈ heterocycloalkyl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₁₂ alkane, halogen, C₁ to C₃ alkoxy group, and an oxo group;
(23) a C₆ to C₁₄ heteroaryl group comprising a nitrogen atom, optionally further comprising one or more heteroatoms, wherein the heteroatom is a pnicogen or a chalcogen, optionally further substituted with one or more groups selected from the group consisting of a linear or branched C₁ to C₆ alkane, halogen, C₁ to C₃ alkyl ether, and an oxo group;
(24) a C₆ to C₁₄ aryl group further substituted with an amine-containing group;
(25) a C₁ to C₈ alkyl group substituted with a plurality of aryl groups; or
(26) polyethylene glycol, polypropylene glycol, or a copolymer thereof, terminated with —OH or —OMe; and
wherein —Xⁿ— or —Rⁿ¹ or both comprise nitrogen,
wherein the at least one unsaturated monomer having a structure represented by Formula I and the polymerizable amine-containing unsaturated monomer having a structure represented by Formula 2 are reacted in the presence of a hybridizing compound to form a second polymer composition, wherein the hybridizing compound comprises a functional group selected from the group consisting of an isocyanate group, an amino group, an epoxy group, a carboxylic acid group, and an acyl halide group;
c) reacting the first polymer composition and the second polymer composition in the presence of a solvent such that the functional group of the second polymer composition reacts with the hydroxyl groups of the first polymer composition to form randomly graft side chains on the first polymer composition to form a graft coploymer; and
d) adding an acid to the graft coploymer in the presence of water to form a cationic graft coploymer.

58. The graft cationic copolymer of claim 57 wherein the acrylate monomer is reacted in step a) and the acrylate monomer is represented by Formula (A)
CH₂═C(R²)—X—Y—R¹ (A)
wherein
—R² is H;
—X— is —CO—O—;
—Y— is a bond, or a C₁ to C₂₂ bridging alkyl group optionally substituted with one or more C₁ to C₆ alkyl groups; and
—R¹ is
(12) H or —OH;
(13) a C₃ to C₈ cycloalkyl group that is optionally substituted with one or more linear or branched C₁ to C₆ alkyl group;
(14) a C₃ to C₈ heterocycloalkyl group comprising one or more heteroatoms, wherein the heteroatom is a chalcogen;
(15) a C₇ to C₁₅ bicycloalkyl group that is optionally substituted with one or more halogens, or linear or branched C₁ to C₆ alkanes;
(16) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

59. The graft cationic copolymer of claim 57 wherein the acrylate monomer is reacted in step a) and the acrylate monomer is represented by Formula (B):
CH₂═CH—CO—O—Y—R¹ (B)
wherein
—Y— is a bond, or a C₁ to C₂₂ bridging alkyl group optionally substituted with one or more C₁ to C₆ alkyl groups; and
—R¹ is
(12) H or —OH;
(13) a C₃ to C₈ cycloalkyl group that is optionally substituted with one or more linear or branched C₁ to C₆ alkyl group;
(14) a C₃ to C₈ heterocycloalkyl group comprising one or more heteroatoms, wherein the heteroatom is a chalcogen;
(15) a C₇ to C₁₅ bicycloalkyl group that is optionally substituted with one or more halogens, or linear or branched C₁ to C₆ alkanes;
(16) a C₆ to C₁₄ aryl group that is optionally substituted with one or more groups selected from the group consisting of a halogen, a linear or branched C₁ to C₆ alkane, and C₁ to C₃ alkyloxy; or
polyethylene glycol, polypropylene glycol, or a copolymer thereof, terminated with —OH or —OMe.

60. The graft cationic copolymer of claim 47 wherein the acrylate monomer is reacted in step a) and the acrylate monomer is selected from the group consisting of 2-hydroxyethyl acrylate, HEA, ethyl acrylate, methyl acrylate, n-propyl acrylate, i-propyl acrylate, n-butyl acrylate, i-butyl acrylate, t-butyl acrylate, n-pentyl acrylate, n-amyl acrylate, i-pentyl acrylate, isoamyl acrylate, n-hexyl acrylate, cyclohexyl acrylate, 2-ethylhexyl acrylate, octyl acrylate, i-octyl acrylate, decyl acrylate, isodecyl acrylate, dodecyl acrylate, lauryl acrylate, octadecyl acrylate, isobornyl acrylate, phenyl acrylate, benzyl acrylate, ethylene glycol methyl ether acrylate, glycidyl acrylate, and mixtures thereof.

61. The graft cationic copolymer of claim 60 wherein the acrylate monomer is selected from the group consisting of 2-hydroxylethyl acrylate, ethyl acrylate, and a mixture thereof.

62. The graft cationic copolymer of claim 57 wherein the alkyl acrylate monomer is reacted in step a) and the alkyl acrylate monomer is represented by the structure of Formula (C):
CH₂═C(R²)—X—Y—R¹ (C)
wherein
—R² is C₁ to C₃ alkyl;
—X— is —CO—O—;
—Y— is a bond, or a C₁ to C₂₂ bridging alkyl group optionally substituted with one or more C₁ to C₆ alkyl groups; and
—R¹ is
(16) H;
(17) a C₃ to C₈ cycloalkyl group that is optionally substituted with one or more linear or branched C₁ to C₆ alkyl group;
(18) a C₃ to C₈ heterocycloalkyl group comprising one or more heteroatoms, wherein the heteroatom is a chalcogen;
(19) a C₇ to C₁₅ bicycloalkyl group that is optionally substituted with one or more halogens, or linear or branched C₁ to C₆ alkanes;
(20) a C₆ to C₁₄ aryl group that is optionally substituted with one or more groups selected from the group consisting of a halogen, a linear or branched C₁ to C₆ alkane, and C₁ to C₃ alkyloxy;
(21) SiR³₃, wherein R³ is C₁ to C₃ alkyl group;
(22) polyethylene glycol, polypropylene glycol, or a copolymer thereof, terminated with OH or OMe; or
—CZ═CH₂, wherein Z is H or halogen.

63. The graft cationic copolymer of claim 57 wherein the methacrylate monomer is reacted in step a) and the methacrylate monomer is represented by the structure of Formula (D):
CH₂═C(R²)—X—Y—R¹ (D)
wherein
—R² is C₁ alkyl;
—X— is —CO—O—;
—Y— is a bond, or a C₁ to C₂₂ bridging alkyl group optionally substituted with one or more C₁ to C₆ alkyl groups; and
—R¹ is
(17) H;
(18) a C₃ to C₈ cycloalkyl group that is optionally substituted with one or more linear or branched C₁ to C₆ alkyl group;
(19) a C₃ to C₈ heterocycloalkyl group comprising one or more heteroatoms, wherein the heteroatom is a chalcogen;
(20) a C₇ to C₁₅ bicycloalkyl group that is optionally substituted with one or more halogens, or linear or branched C₁ to C₆ alkanes;
(21) a C₆ to C₁₄ aryl group that is optionally substituted with one or more groups selected from the group consisting of a halogen, a linear or branched C₁ to C₆ alkane, and C₁ to C₃ alkyloxy;
(22) SiR³₃, wherein R³ is C₁ to C₃ alkyl group;
(23) polyethylene glycol, polypropylene glycol, or a copolymer thereof, terminated with OH or OMe; or
(24) —CZ═CH₂, wherein Z is H or halogen.

64. The graft cationic copolymer of claim 63 wherein the methacrylate monomer is selected from the group consisting of methyl methyacrylate, MMA, ethyl methacrylate, propyl methacrylate, isopropyl methacrylate, n-butyl methacrylate, i-butyl methacrylate, s-butyl methacrylate, t-butyl methacrylate, n-amyl methacrylate, isoamyl methacrylate, n-hexyl methacrylate, cyclohexyl methacrylate, 2-ethylhexyl methacrylate, octyl methacrylate, decyl methacrylate, dodecyl methacrylate, octadecyl methacrylate, behenyl methacrylate, lauryl methacrylate, isobornyl methacrylate (IBOMA), phenyl methacrylate, benzyl methacrylate, 1-naphthyl methacrylate, (trimethylsilyl)methacrylate, 9-anthracenylmethyl methacrylate, glycidyl methacrylate, polyethylene glycol monomethacrylate, polypropylene glycol monomethacrylate, ethylene glycol propylene glycol monomethacrylate, and mixtures thereof.

65. The graft cationic copolymer of claim 65 wherein the methacrylate monomer is selected from the group consisting of methyl 2-methacrylate, behenyl methacrylate, and a mixture thereof.

66. The graft cationic copolymer of claim 63 wherein the methacrylate monomer comprises a co-polymer of polybutylacrylate and poly(2-hydroxyethyl acrylate).
